(19) United States
(12) Patent Application Publication
(10) Pub. No.: US 2016/0042154 A1
(43) Pub. Date: Feb. 11, 2016

(54) Integrated Modular Health Platforms and Methods of Use

(71) Applicants: Eli S. GOLDBERG, (US); Scott A. LUCHAU, (US)

(72) Inventors: Eli S. Goldberg, Marshfield, WI (US); Scott A. Luchau, Glen Allen, VA (US)

(21) Appl. No.: 14/777,046

(22) PCT Filed: Mar. 14, 2014
(86) PCT No.: PCT/US2014/028517

§ 371 Date: Sep. 15, 2015

Related U.S. Application Data
(60) Provisional application No. 61/789,438, filed on Mar. 15, 2013.
(60) Provisional application No. 61/875,339, filed on Sep. 9, 2013.

(51) Int. Cl. G06F 19/00

(52) U.S. Cl. CPC G06F 19/3481; G06F 19/3418

(57) ABSTRACT

Integrated modular health platforms and methods of their use are provided. The integrated modular health platform may include one or more sensors (120) configured to monitor a patient usage of a medical device (110); a communication unit (130) communicatively coupled to the one or more sensors (120); and a processing unit (200) configured to receive a first communication from the communication unit (120), the communication being indicative of the patient usage of the medical device (110), to compare the patient usage of the medical device (110) with an expected usage of the medical device (110); and to generate a second communication indicative of a difference between the patient usage and the prescribed usage.

### RELATED APPLICATIONS

This application claims the benefit and priority to U.S. Provisional Application No. 61/789,438, filed on Mar. 15, 2013, and U.S. Provisional Application No. 61/875,339, filed on Sep. 9, 2013, both of which are incorporated herein by reference in their entireties.

### FIELD

The present disclosure provides methods and systems for monitoring usage of medical equipment.

### BACKGROUND

Disease treatment programs that occur outside of a hospital setting are inherently open to a breakdown in communication between patient and physician. Patients are given the equipment necessary to treat their particular ailment and expected to use these devices according to the prescribed therapy. In cases of complex treatment regimens, of which cystic fibrosis is an example, patients may sacrifice treatment adherence due to a variety of reasons such as time or interactions with friends and family. Key research findings suggest that adherence to therapy drops significantly in the presence of barriers to treatment, of which forgetting to perform treatment and difficulty managing complex multi-component therapy regimens were the most influential barriers to adherence. In terms of physician management of chronic patients, increased patient monitoring is linked with better health. However, most physicians remain unaware of the actual usage of the treatment equipment until the patient returns for a routine checkup or is hospitalized for failure to follow treatment protocol.

### SUMMARY

Integrated modular health platforms and methods of use are provided. In some aspects, there is provided a method for monitoring a medical device that comprises receiving a first communication indicative of one or more parameters associated with a patient usage of a medical device; comparing the patient usage of the medical device with an expected usage of the medical device; and generating a second communication indicative of a difference between the patient usage and the expected usage.

In some aspects, there is provided a system for monitoring a medical device that comprises one or more sensors configured to monitor a patient usage of a medical device; a communication unit communicatively coupled to the one or more sensors; and a processing unit configured to receive a first communication from the communication unit, the communication being indicative of the patient usage of the medical device, to compare the patient usage of the medical device with an expected usage of the medical device; and to generate a second communication indicative of a difference between the patient usage and the prescribed usage.

In some aspects, there is provided an integrated health platform that comprises a chassis; one or more medical devices supported by the chassis; one or more sensors coupled to the one or more medical devices to monitor patient usage of the one or more medical devices; and a communication unit communicatively coupled to the one or more sensors to receive the patient usage information from the one sensors and to transmit the patient usage information to a processing unit.

### BRIEF DESCRIPTION OF THE DRAWINGS

The presently disclosed embodiments will be further explained with reference to the attached drawings, wherein like structures are referred to by like numerals throughout the several views. The drawings shown are not necessarily to scale, with emphasis instead generally being placed upon illustrating the principles of the presently disclosed embodiments.

FIG. 1 illustrates an example of a method for monitoring medical device usage.

FIG. 2 illustrates an example medical device monitoring system.

FIG. 3 illustrates an example method for processing monitored parameters to generate, log, communicate, and predict future values of patient adherence.

FIG. 4 illustrates example embodiments of the medical device sensors as attached to example medical devices.

FIG. 5 illustrates an example embodiment of a chassis wherein the medical devices, sensors, power module, and communication equipment may be mounted in a single platform.

FIG. 6 illustrates an example embodiment of the medical device monitoring system, wherein the medical devices, sensors, power module, and communication equipment are mounted onto the chassis shown in FIG. 5.

FIG. 7 displays the flow of data from a single sensor to the local gateway communication device, into a remote storage location, which is able to reach the patients, physicians, and payers.

FIG. 8A shows the top perspective view of an embodiment of the modular mounting platform of the present disclosure with mounting locations filled for the management of CF.

FIG. 8B shows the right side perspective view of an embodiment of the modular mounting platform of the present disclosure with mounting locations filled for the management of CF.

FIG. 8C shows the back perspective view of an embodiment of the modular mounting platform of the present disclosure with mounting locations filled for the management of CF.

FIG. 8D shows the left side perspective view of an embodiment of the modular mounting platform of the present disclosure with mounting locations filled for the management of CF.

FIG. 8E shows the front perspective view of an embodiment of the modular mounting platform of the present disclosure with mounting locations filled for the management of CF.

FIG. 9A displays an embodiment of an attachment of sensors and their communication modules to a pulmonary percussion system. Sensor power routing is also depicted.

FIG. 9B displays an embodiment of an attachment of sensors and their communication modules to a steam sterilizer. Sensor power routing is also depicted.

FIG. 9C displays an embodiment of an attachment of a sensor to a base of a medical device.

FIG. 10A shows the top perspective view of the modular mounting platform of the present disclosure.

FIG. 10B shows the right side perspective view of the modular mounting platform of the present disclosure.

FIG. 10C shows the back perspective view of the modular mounting platform of the present disclosure.

FIG. 10D shows the left side perspective view of the modular mounting platform of the present disclosure.

FIG. 10E shows the front perspective view of the modular mounting platform of the present disclosure.

FIG. 11A shows a compressor housing configuration for incorporation into the modular mounting platform of the present disclosure.

FIG. 11B shows an alternative compressor attachment mechanism and configuration for incorporation into the modular mounting platform of the present disclosure.

FIG. 12 shows a perspective view of an embodiment of the modular mounting platform of the present disclosure with mounting locations filled for the management of CF.

FIG. 13 shows perspective views of embodiments of the modular mounting platform of the present disclosure for the management of CF.

FIG. 14 shows the top, right side, left side, back and front perspective views of an embodiment of the modular mounting platform of the present disclosure.

FIG. 15 displays the interactions between the various medical devices, attached sensors, and data users for the treatment of CF.

FIG. 16 displays the interactions between the various medical devices, attached sensors, and data users for various embodiments of the present disclosure.

FIG. 17A shows the top perspective view of an embodiment of the modular mounting platform of the present disclosure.

FIG. 17B shows the right side perspective view of an embodiment of the modular mounting platform of the present disclosure.

FIG. 17C shows the back perspective view of an embodiment of the modular mounting platform of the present.

FIG. 17D shows the left side perspective view of an embodiment of the modular mounting platform of the present disclosure.

FIG. 17E shows the front perspective view of an embodiment of the modular mounting platform of the present disclosure.

FIG. 18A shows the top perspective view of an embodiment of the modular mounting platform of the present disclosure.

FIG. 18B shows the right side perspective view of an embodiment of the modular mounting platform of the present disclosure.

FIG. 18C shows the back perspective view of an embodiment of the modular mounting platform of the present disclosure.

FIG. 18D shows the left side perspective view of an embodiment of the modular mounting platform of the present disclosure.

FIG. 18E shows the front perspective view of an embodiment of the modular mounting platform of the present disclosure.

While the above-identified drawings set forth presently disclosed embodiments, other embodiments are also contemplated, as noted in the discussion. This disclosure presents illustrative embodiments by way of representation and not limitation. Numerous other modifications and embodiments can be devised by those skilled in the art which fall within the scope and spirit of the principles of the presently disclosed embodiments.

### DETAILED DESCRIPTION

The following detailed description refers to the accompanying drawings that illustrate exemplary embodiments; however, the scope of the present claims is not limited to these embodiments. Thus, embodiments beyond those shown in the accompanying drawings, such as modified versions of the illustrated embodiments, may nevertheless be encompassed by the present claims. References in the specification to “one embodiment,” “an embodiment,” “an example embodiment,” or the like, indicate that the embodiment described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of one skilled in the art to implement such feature, structure, or characteristic in connection with other embodiments whether or not explicitly described.

In some embodiments, the present disclosure provides both an array of sensors that can be attached to medical equipment and an automated method to track and manage patients' adherence to a prescribed medical device therapy regimen requiring the use of one or more devices. Further, the present disclosure provides a method to provide real-time and future adherence information to patients and physicians, as well as ensuring that one or more medical devices employed by said patients is operating within manufacturer operational constraints. The monitoring of medical equipment is performed non-invasively and without interfering with the operation or use of the equipment. Data from the sensors is collated and can be transmitted to a remote location. The present disclosure also includes a mounting apparatus for medical equipment and sensors specific to the management of cystic fibrosis (CF), but also for chronic bronchitis, asthma, chronic obstructive pulmonary disease (COPD), and other diseases and disorders.

Patients oftentimes may be required to use medical devices at home to maintain or improve their health. Suitable medical devices may be used to improve, maintain, or monitor the health of patients employing these devices. In addition, physicians, device manufacturers, government agencies, and insurance companies may have an interest in ensuring that such patients use these machines in accordance with prescribed therapy regimens. In some embodiments, a prescribed therapy regimen is a physician-established medical device or pharmaceutical usage schedule intended to provide medical care to a patient. Despite this interest, it is difficult to monitor usage of these medical devices.

In some embodiments, the usage of medical devices may be monitored by one or more sensors and a signal indicative of such usage may be transmitted to a processing unit. In some embodiments, the signal indicative of medical device usage may include a communication via wireless or wired means with data indicating au actual level of medical device usage or as a variable which may be used in the calculation of the level of medical device usage. Similarly, a signal or communication indicative of one or more parameters may include actual one or more parameters or a variable from which the one or more parameters may be determined.

In some embodiments, the present disclosure provides a method and system for monitoring one or more medical devices to ensure operation within manufacturer operational restrictions and determine patient adherence to a prescribed regimen are described herein. In some embodiments, patient adherence can be measured by extent to which the patient continues the agreed-upon mode of treatment. In some embodiments, patient adherence may be determined when the patient acts under limited supervision, when faced with conflicting demands, or both.

In some embodiments, an integrated health platform (IHP) is provided. The IHP may include a system for monitoring patient adherence to a prescribed treatment regimen involving one or more medical devices. The system may also monitor the operational performance of medical devices of the IHP. The system may also include a means of comparing monitored device usage to the prescribed usage pattern and operational parameters to manufacturer recommendations. In some embodiments, operational parameters are a data set generated by sensing a medical device's operation for the purpose of generating adherence performance data and predicting future adherence. The system may also include a means of transmitting the collected data to a remote location. The system may also include a modular medical device storage platform that can be tailored to an individual patient or disease. Taken together, the components of the IHP may allow for increased monitoring of patient adherence, improved communication between physicians and patients, and discrete storage and operation of medical devices. By performing these functions, the IHP directly addresses and alleviates issues that can lead to noncompliance, such as disease related embarrassment and work/life/treatment balance.

In some embodiments, such method includes monitoring one or more parameters associated with the operation of the medical device, comparing the monitored parameters with one or more manufacturer operational restrictions, and generating a signal that is indicative of how the use of the medical device(s) conforms to those restrictions. In some embodiments, manufacturer operational restrictions may include a set of physical and operative limitations imposed by manufacture to ensure safe operation.

The method may further include monitoring one or more parameters associated with patient adherence, comparing the monitored parameters with prescribed usage regimen(s), and generating a signal that is indicative of whether the medical device is being used by the patient in accordance with the prescribed therapy regimen. In some embodiments, monitored parameters may include one or more signals generated by a device sensor employed for the purpose of generating adherence data. In some embodiments, the method still further includes the ability to generate a signal indicative of predicted future adherence to the prescribed therapy regimen.

In some embodiments, the system of the present disclosure includes the ability to transmit the signals to a remote location. In one arrangement, the use of the medical device(s) by the patient requires voluntary actions on the part of the patient to conform to the prescribed therapy regimen. Through this monitoring, a patient and/or his/her physician can be apprised of the progress of his/her treatment, and improvements can be executed where needed.

In one embodiment, the system is comprised of a modular mounting platform that incorporates all prescribed medical devices, the sensor array, and the central hub in a single location. The central hub may be any device capable of storing data, altering the format of data, performing calculations and/or comparisons with available data, and transmitting the data to an alternate location. The platform includes discrete mounts for the medical devices and working space for the patient to utilize while performing treatments.

In some embodiments, the present disclosure provides a method and system for tracking and monitoring patient adherence to a prescribed therapy regimen requiring the use of one or more medical devices that overcomes the noted deficiencies of the prior art. In some embodiments, the present disclosure provides a monitoring method and system that compares medical device usage parameters against manufacturer operational restrictions. In some embodiments, the present disclosure provides a method and system of computationally predicting future patient adherence to the prescribed therapy regimen. In some embodiments, the present disclosure provides a method and system for remote data access and trending that encompasses all prescribed medical devices.

In general, the methods and systems of the present disclosure may be designed to 1) provide patients, parents, physicians, and other stakeholders a feedback mechanism to remind patients to perform their treatment, and provide a methodology and device to allow patients with CF, COPD, and other chronic diseases the to track their adherence, 2) forecast, or predict low-adherence events, which can prevent hospitalization and reduce patient re-admission, 3) provide the ability to compare medical device operational parameters to manufacturer provided operational constraints, and 4) in one embodiment, provide a platform that directly addresses disease-related sensitivity and work-social-therapy balance issues.

According to various embodiments of the present disclosure, a system for monitoring medical device usage outside of a hospital setting may include 1) a plurality of sensors for non-invasively gathering data related to: environmental conditions within sterilization and refrigeration equipment, flow rates of nebulization treatments, and adherence and frequency of use data for all required medical equipment (see detailed description for complete list of medical equipment); 2) a local gateway device communicating with the sensors; 3) an available data storage center at a remote location; 4) a means of transmitting from the local device to the storage center; and 5) in one embodiment, a modular platform for mounting medical devices, the sensor array, and the local gateway device. The local gateway device may be any device capable of storing data, altering the format of data, performing calculations and/or comparisons with available data, and transmitting the data to an alternate location.

In some embodiments, in the systems of the present disclosure sensors may be mounted to medical devices without interfering with the function of the device or its operation, maintenance, or performance. Data to be recorded from the medical equipment sensors may include, but is not limited to power consumption, air flow, pressure, temperature, frequency, frequency and duration of use and combinations thereof. The system may also transmit sensor data to a local storage device via wired or wireless connection; allow sensor data and user input to be stored locally and/or transmitted to a remote location; calculate differences between monitored parameters and manufacturer operational constraints for those parameters; calculate differences between patient usage of prescribed medical equipment and a treatment regimen; calculate an expected value for future patient adherence to a treatment regimen; present the user with an interface enabling display of and interaction with stored data.

In one embodiment, the present disclosure provides a modular platform that can be configured to meet the needs of various users treating various medical conditions and enables: Discrete mounting of medical equipment required for adherence with state-of-the-art treatment regimens into a single platform; Increased accessibility to treatment equipment by offering a convenient and comfortable platform where other work and activities can be done concurrently with treatment; and decreased embarrassment associated with treatment regimens and medical equipment due to the discrete storage and equipment concealment.

In some embodiments, the sensor array may be mounted directly to prescribed medical equipment, and may be used to record data from medical devices and transmit such data. The mounting preferably does not prevent required inputs (e.g., air, electric power) from reaching each medical device and does not alter the designed interaction between the medical device output (e.g., compressed air, nebulized medication) and the user (e.g., an additional piece of equipment, patient using the device for treatment). The array may include one or more sensors. In some embodiments, the array consists of more than 10 sensors.

Sensors may be equipped with the necessary technology to transmit acquired data from the sensor to a local storage platform, either through a wired or wireless connection. A local storage platform may be any device capable of storing data, altering the format of data, performing calculations and/or comparisons with available data, and transmitting the data to an alternate location. The local storage platform, also referred to variously as local gateway device or central hub, may contain a processing unit capable of data logging as well as various functions described above, such as, by way of a non-limiting example, allowing sensor data and user input to be stored locally and/or transmitted to a remote location; calculating differences between monitored parameters and manufacturer operational constraints for those parameters; calculating differences between patient usage of prescribed medical equipment and a treatment regimen; calculating an expected value for future patient adherence to a treatment regimen; presenting the user with an interface enabling display of and interaction with stored data. In some embodiments, a processing unit may include a series of components that executes a series of instructions. Calculated data may also be logged and capable of being transmitted to a remote location.

In one embodiment, the systems of the present disclosure may be presented as an integrated modular mounting platform on which medical equipment for the treatment of CF and other diseases can be mounted. This platform may be available in a plurality of configurations and may provide multiple mounting locations for medical equipment and associated sensors. In some embodiments, the mounting platform provides at least 5 mounting locations. In some embodiments, the mounting platform provides at least 10 mounting locations.

In some embodiments, the methods and systems of the present disclosure are designed to gather data on treatment regimen adherence and decrease non-adherence with prescribed medical therapy by monitoring medical device use, addressing work-social-therapy balance and disease-related sensitivity issues specific to CF and other equipment-intensive diseases.

In some embodiments, the methods and systems of the present disclosure may be configured for use by patients suffering from cystic fibrosis. Adherence with prescribed therapy is the key to maintaining and improving the lives of those with CF. Non-adherence with therapy can result in decreased quality of life, increased health care costs, and is associated with higher rates of mortality. In some embodiments, the systems of the present disclosure may include an array of sensors attached to medical devices commonly used by patients with cystic fibrosis, including, but not limited to, medical grade refrigerator (temperature sensor, power consumption sensor); medical grade air compressor, associated air-lines, and air barb (air pressure sensor, power consumption sensor); Medical grade particulate and allergen filter (air flow sensor); Medical grade steam sterilizer (pressure sensor, temperature sensor, power consumption sensor); Pulmonary percussion system (frequency sensor, power consumption sensor) and combinations thereof.

In some embodiments, the sensor array may incorporate at least one sensor for patient health factor input. In some embodiments, health factors include data points that give an indication of the state of a patient's physical well-being, mental well-being or both. This may include, but is not limited to heart rate, pulse-oximetry, blood pressure, or forced expiratory volume in 1 second (FEV1) measurements collected via sensors. For the embodiment specifically designed to incorporate the medical equipment for the treatment of CF, this sensor consists of a spirometer or a flow meter, which patients may use to measure lung function or other pulmonary metrics. In some embodiments, the present disclosure provides a modular panel incorporating the medical equipment for the treatment of CF. In such embodiments, the mounting platform may include, without limitations, medical grade refrigerator (may require 2 locations), Medical grade air compressor, associated air-lines, and air barb (may require 2 location); Medical grade particulate and allergen filter (may require 1 location); Medical grade steam sterilizer (may require 3 locations); Pulmonary percussion system (may require 1 location) and Power hub (may require 1 location).

Given the modularity of design and flexibility in the equipment that can be mounted to the integrated health platform, there is a wide range of diseases and disorders that can be treated. In some embodiments, the integrated modular health platform can be used to monitor any disease that requires the use of nebulized or inhaled medicine, chest compression, and pill management. This includes, but is not limited to, the following: cystic fibrosis (CF); chronic obstructive pulmonary disease (COPD); Asthma; Chronic Bronchitis; Pneumonia and similar diseases.

In some embodiments, the integrated modular health platform accommodates an expanded list of equipment to monitor additional diseases through the incorporation of additional medical equipment. For example, heart and blood pressure diseases can be accommodated through the incorporation of an Electro cardiogram machine, pulse oximetry monitors, and blood pressure monitoring equipment. Various cancers that require chemotherapy treatment administered intravenously (IV) can be accommodated through the incorporation of a syringe pump or pressurized IV fluid distribution system. In some embodiments, diabetes that is managed through insulin shots can be accommodated through the incorporation of a sharps disposal box and blood-glucose monitoring system. Kidney and failure that is managed using hemodialysis can be accommodated through the incorporation of a dialysis machine. Obesity that is managed through exercise can be accommodated through the incorporation of an exercise bike or other exercise machine. In addition, the platform could be used as an electric wheelchair charging station for users with impaired mobility by incorporated the necessary charging equipment.

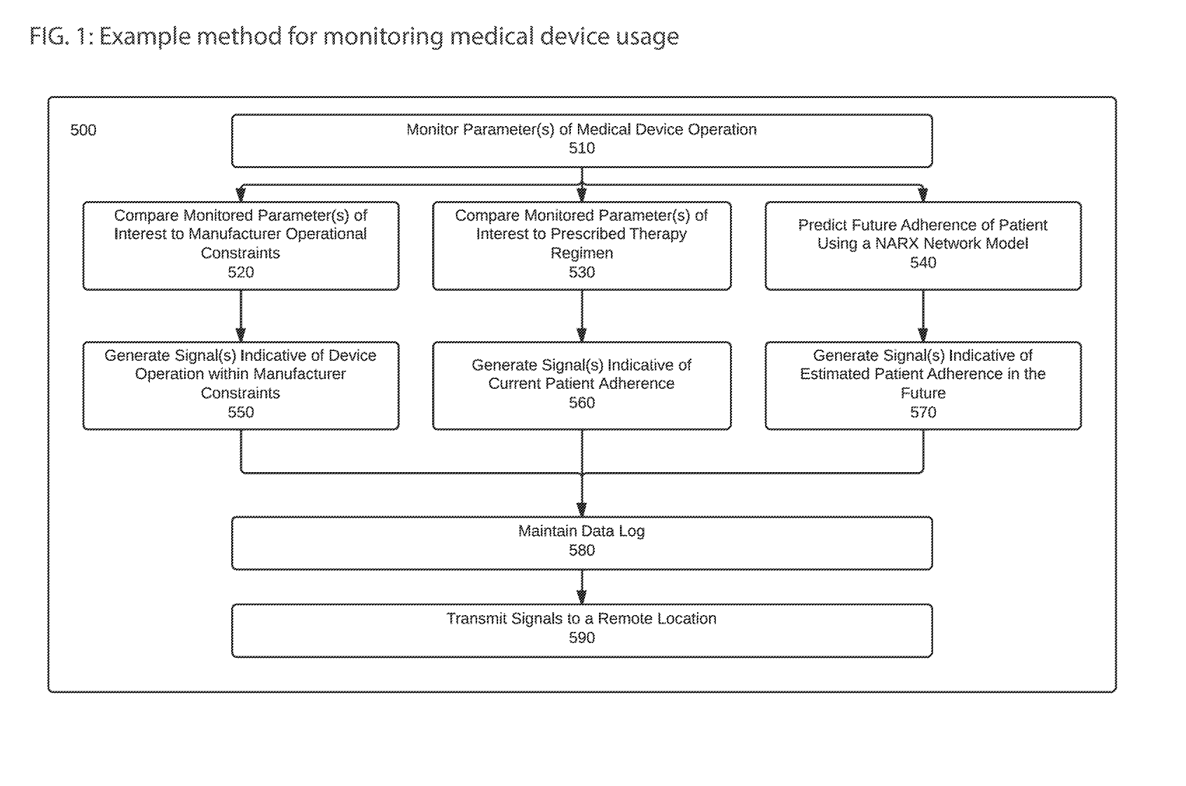

Referring to FIG. 1, a method 500 for monitoring one or more medical devices to ensure usage is within manufacturer operational constraints, to indicate patient adherence, and to predict future patient adherence is shown. In some embodiments, the manufacturer operational constraints include physical and operative limitations imposed by manufacture to ensure safe operation, such as: oscillatory or rotational frequency, operating temperatures, electrical power usage (as measured by amperage or voltage draw), influent and effluent pressures, operating time, and mechanical vibrations and equipment sound volume generated by medical equipment operation.

At step 510, one or more parameters associated with the operation of one or more medical devices can be monitored for one or more signals generated by a device sensor. At step 520, such monitored parameters can be compared with one or more manufacturer operational constraints. At step 530, the monitored parameters can be compared with one or more prescribed therapy regimens corresponding to a patient's medical device usage. At step 540, future patient adherence to one or more prescribed therapy regimens can be predicted, such as, for example, by use of a moving average or nonlinear autoregressive exogenous (NARX) neural network model. In some embodiments, the NARX adherence model may include a mathematical modeling technique that allows prediction of an estimated future value for device usage (i.e., adherence) based on previous device usage behaviors. At step 550, a signal can be generated that is indicative of whether the medical device usage conforms to manufacturer operational constraints. At step 560, a signal can be generated that is indicative of whether the medical device adherence by the patient conforms to the prescribed therapy regimen. At step 570, a signal can be generated that is indicative of future patient adherence to a prescribed therapy. The generated signals can then be logged as shown in step 580 and transmitted to a remote location, as shown in step 590.

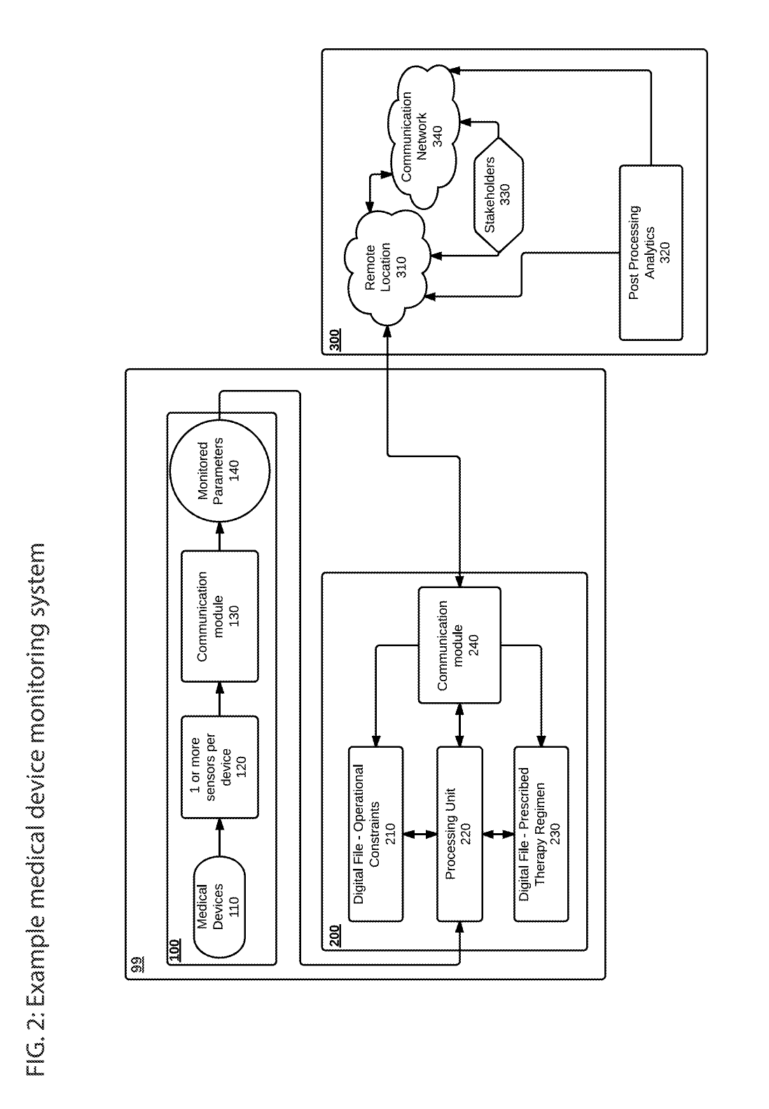

Referring to FIG. 2, an example of a medical device monitoring system 99 of the present disclosure is shown. In some embodiments, the system 99 can include a device module 100 including one or more medical devices 110 and one or more sensors per device 120. In some embodiments, the medical device sensor(s) 120 can be integral with the medical device or may be separate from the medical device 110, meaning that the sensor(s) 120 can be physically separated from the device(s) 110 or the device(s) 110 can operate without the use of the sensor(s) 120. The sensor(s) 120 are communicatively coupled to a communication module 130 that packages the monitored parameters 140 for transmission to a central hub 200. In some embodiments, a communication module can be a component or group of components that enables signals to be transmitted and/or received over a wired or wireless connection. In some embodiments, communicatively coupled is a state in which two or more components are connected such that signals may be exchanged between components in a unidirectional, bidirectional, or multidirectional manner.

The central hub 200 can include a processing unit 220, one or more digital files, such as a digital file of operational constraints 210 or a digital file of prescribed therapy regimen(s) 230, and a communication module 240 capable of transmitting generated signals to a remote location 310. The central hub 200 can be communicatively coupled to both the communication module 130, from which it receives the monitored parameters 140, and the remote location 310, where it can transmit the signals generated by the processing unit 220. Although shown as separate entities, any of the components described above can be integrated into a smaller number of units. For example, the sensor(s) 120 and/or the communication module 130 can be part of a single unit or the communication module 130 and the central hub 200 may be combined into the central hub 200.

In some embodiments, the remote location 310 allows for stakeholder access 330 and post processing analysis 320 by devices not unique to this patent. These access and analysis points are depicted as a single system 300 with the remote location 310, but are not constrained to be a single device or occur at a single remote location. Those skilled in the art will appreciate the ability to use existing equipment to access the data stored at the remote location and performing analyses on the data from a remote location.

The sensor(s) 120 can be configured to monitor one or more parameters associated with the operation of the medical device(s) 110. As will be explained later, the processing unit 220 can generate signals that provide information that is related to the operation of the medical device(s) 110. In addition, through the communication module 240, the medical device monitor system 99 can communicate such signals to a remote location 310, where stakeholders 330 can access the data or processing or analysis of these signals can be performed 320. A remote location in this context can refer to any location where suitable equipment may be kept to process or analyze the signals received from the central hub 200. The remote location 310 may be positioned at a location that is physically removed from an area housing the medical device(s) 110 and the medical device monitor 99, or alternatively, it may be in the same physical area of the device(s) 110 and monitor 99.

In some embodiments, the communication module 130 can be coupled to the medical device sensor(s) 120 and can be configured to transmit the monitored parameters 140 directly to the remote location 310. Regardless of whether the monitored parameters 140 are transmitted from communication module 130 or 240, numerous configurations for this connection can be achieved, such as through Wi-Fi, cellular, POTS, or Ethernet. The remote location 310 can further be communicatively coupled to a communication network 340, which can be any network or group of networks that can enable wide-ranging communications, such as the Internet. Stakeholders 330 can access the signals stored at the remote location through the communication network 340. Post processing analytics 320 can also be performed on the data stored at the remote location 310 through the communication network 340.

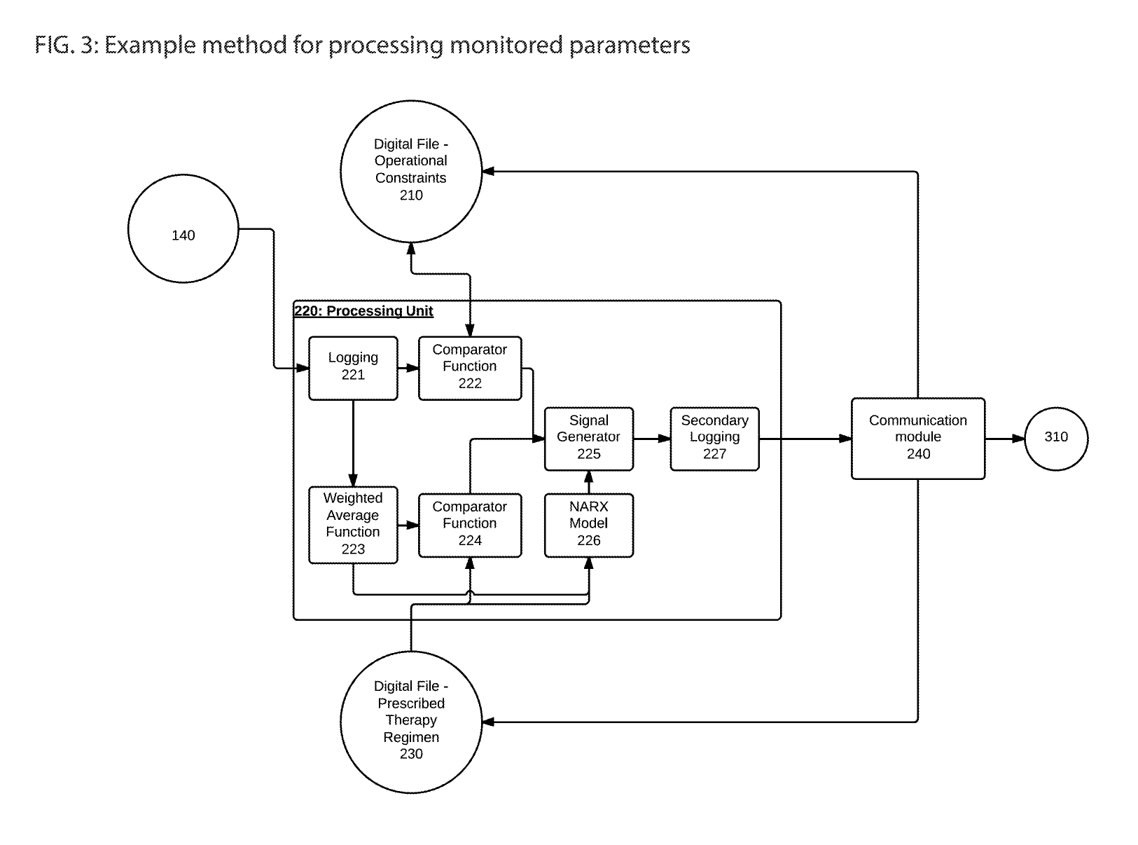

In reference to FIG. 3, the processing unit 220 may be capable of performing various functions. In one embodiment, the processing unit 220 creates a log 221 of the monitored parameters 140. In some embodiments, the log 221 may be accessed by two different computational blocks. A comparator function 222 compares the logged monitored parameters 221 to a digital file containing medical device operational constraints 210 in the central hub 200, which may be provided by the manufacturer or physician. In some embodiments, a comparator function may include a software program or hardware device that compares two or more inputs from different sources and determines the differences between the inputs. The digital file 210 can be altered by authorized commands from the remote location 310 that are received through the communication module 240. The difference between the monitored parameters from the data log 221 and the digital file 210 comprises input to a signal generator 225. In some embodiments, a signal generator may include a software program or hardware device that generates a signal suitable for transmission from input from a different process or device.

The log 221 can also be accessed by a weighted moving average function unit 223 that computes a weighted moving average of the logged parameters of interest for a range of temporal windows, e.g., daily, weekly, monthly, quarterly, yearly. In one embodiment, weighting factors employed in the calculation of the weighted moving average are assigned a larger weight to more recently obtained parameters in an exponential relationship. A physician can alter assigned weighting factors, as necessary. A separate average may be computed for each parameter of interest. The calculated weighted moving average 223 comprises an input to a comparator function 224 and a NARX neural network model 226. The comparator function 224 compares the weighted moving average to a digital file containing a prescribed therapy regimen 230. The digital file 230 can be altered by authorized commands from the remote location 310 that are received through the communication module 240. The difference between the weighted moving average 223 and the digital file 230 comprises input to a signal generator 225. The NARX neural network model 226 allows a value of future patient adherence to be predicted based on the previous behavior of the patient, which is known by the output of the weighted moving average function 223, and the prescribed therapy regimen 230, which constitutes an estimate of perfect adherence. The output of the NARX neural network model 226 is an estimate of patient adherence in the future. The output may comprise input to the signal generator 225.

In some embodiments, the present disclosure determines patient adherence based on aggregation of monitored parameters over time, rather than based on a measurement of when the device is on and when it is off. Instantaneous device usage is not necessarily indicative of overall patient health as chronic conditions are relatively non-responsive to short-term treatments. A moving average of device adherence provides a superior measure when compared to instantaneous measurements of compliance. A moving average can be used to predict future adherence. In some embodiments, the reliability of that prediction can further be enhanced by use of a NARX model or a similar mathematical model wherein the moving average is used as an input.

The signal generator 225 may be configured to package the data from the comparator function 222, the comparator function 224, and the NARX neural network model 226 for secondary logging 227 and transmission to a remote location 310 via the communication module 240. The signal generator can alter the format of the data from an initial format to a second format. A data log 227 of the signal generator output is created. The communication module 240 transmits the data generated by the processing unit 220 to a remote location 310. Although shown as separate entities, any of the components described above can be integrated into a smaller number of units. For example, the comparator function 222 and the comparator function 224 can be part of a single unit or the logging unit 221 and the secondary logging unit 227 may be combined into a single piece.

### Using the Integrated Modular Health Platform

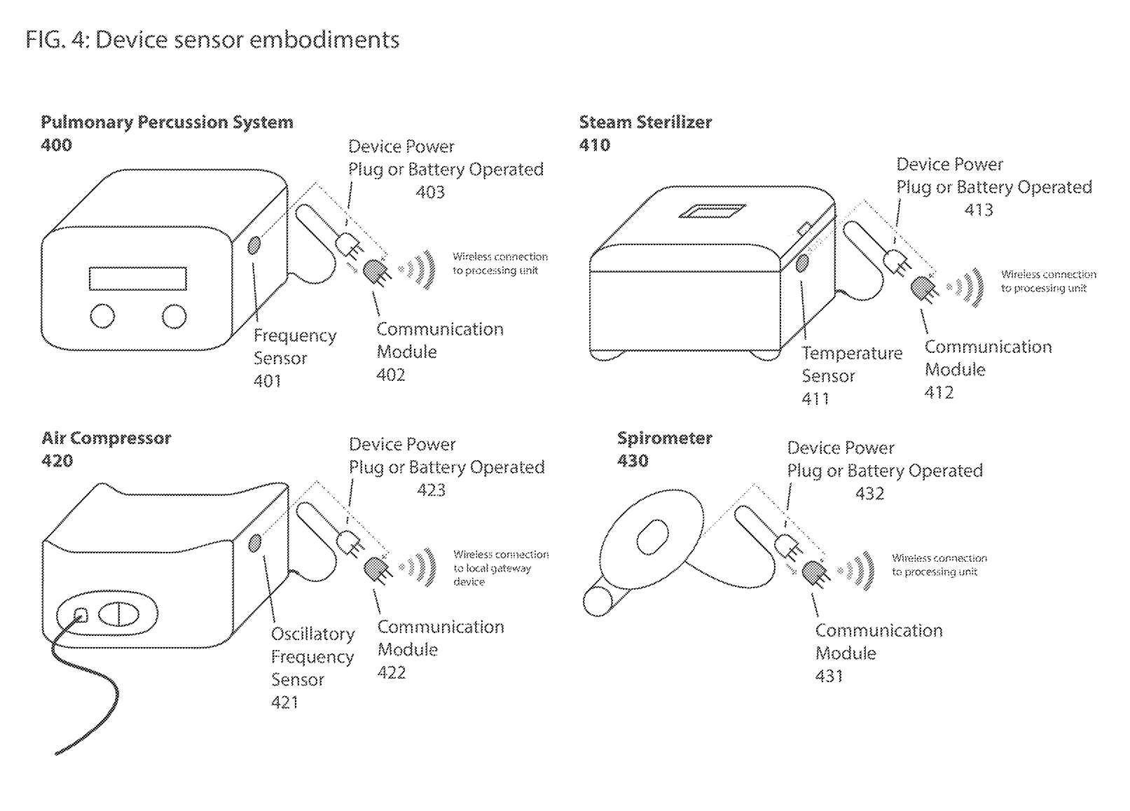

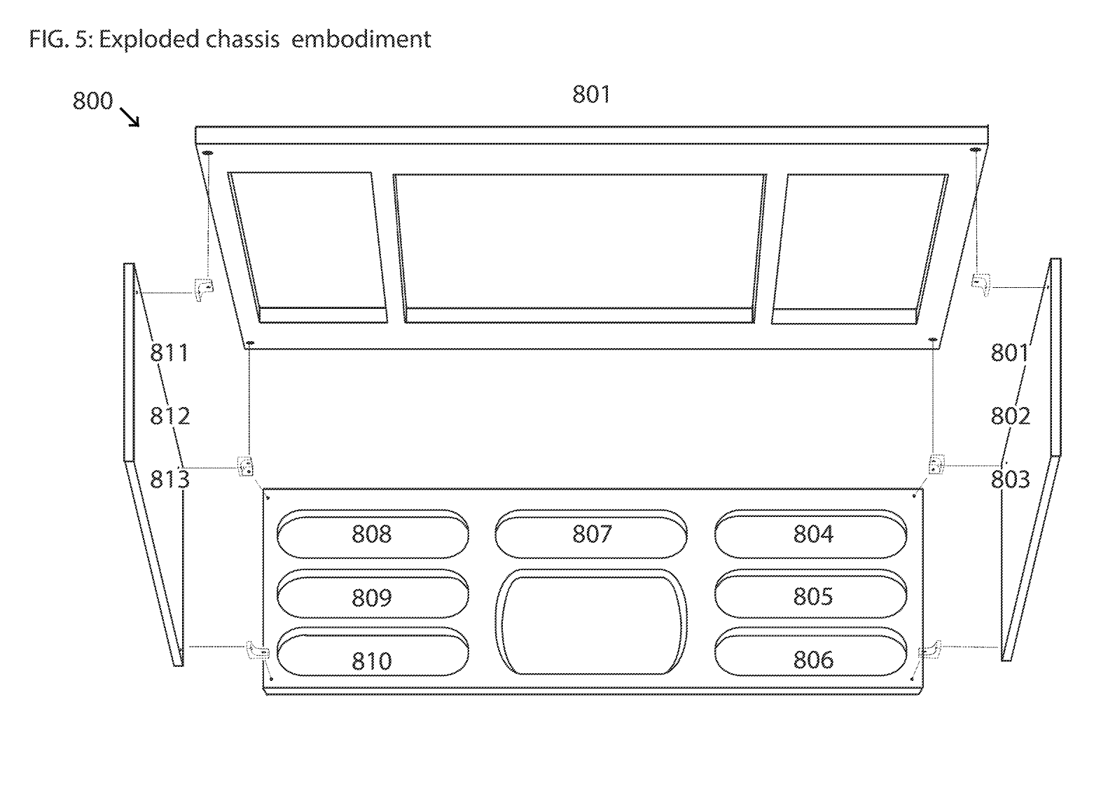

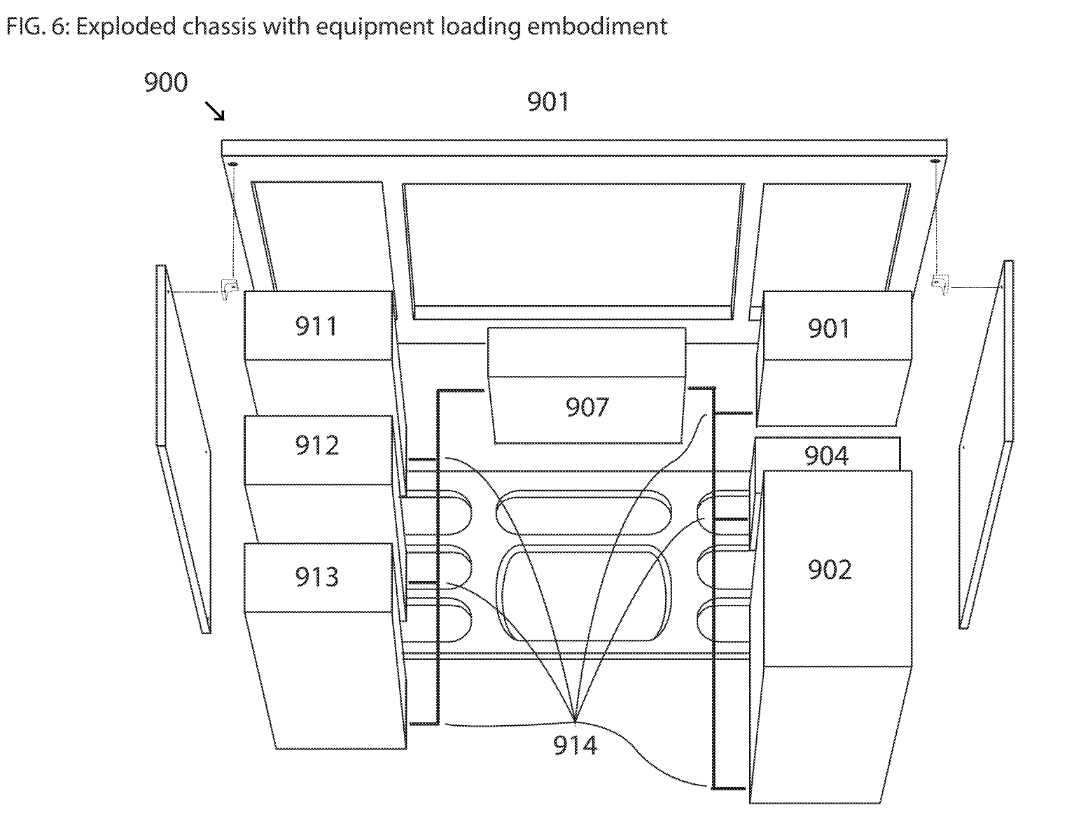

Referring to FIG. 2, the medical devices 110 may include separate or shared power modules (such as for example modules 403, 413, 423, 432 shown in FIG. 4), which can engage the communication module 130 coupled to the sensor(s) 120. In some embodiments, the medical device monitor may also include a power module (such as for example module 907 shown in FIG. 6). As such, the medical device(s) 110 can receive power through the medical device monitor 99. As shown in FIG. 6, in some embodiments, the power module 907 is further mounted in the same chassis (e.g. chassis 80 in FIG. 5) as the medical device(s) (such as for example medical devices 110 in FIG. 2), sensor(s) (such as for example sensors 210 in FIG. 2), communication equipment (such as for example equipment 130 in FIG. 2), and central hub (such as hub 200 in FIG. 2), and connected through 914.

In reference to FIG. 2, the sensor(s) 120, through interaction with the power module or separate method of employing electrical power for operation, can monitor one or more parameters associated with the operation of the medical device(s) 110. The monitoring of the medical device(s) 110 by the sensor(s) 120 may include observing, recording or detecting one or more values, including individual values or ranges of values. In some embodiments, the one or more monitored parameters can be related to the power consumption of the medical device 110. For example, the parameters can include an on/off state, amperes, or voltage. The monitoring process can occur continuously, periodically, randomly, or at times defined by the on/off state of the device, depending on the necessity of collecting information about the operation, or operational state, of the medical device(s) 110.

The sensor(s) 120 can be used to monitor other suitable parameters associated with the medical device(s) 110, including those that are not related to electrical consumption. For example, the parameters can include device generated sound volume, device generated sound frequency, temperature, time in the device on state at each use and accumulated total time in the device on state, frequency of device use as measured by changes in the defined parameters, and user defined inputs related to device usage or prescribed treatment. Sound volume and device generated sound frequencies may be monitored by use of microphone sensors. The microphone sensor(s) will pick up the volume and frequency of the generated noise. A low- and/or high-pass filter may be used to ensure operational noise is detected vice ambient noise in the area of the device usage. The processing unit 220 may also include filtering and determination algorithms for classification, delineation, and analysis of inputs from the microphone sensor(s). Temperature may be measured using a variety of thermometer sensors including, but not limited to: thermocouples, resistive temperature devices (rtd), thermistors, infrared, laser, fiber optic, and semiconductors. Time in the device ‘on state’ at each use, accumulated total time in the device ‘on state,’ and frequency of device usage may be monitored at the central hub 200 using summation and integrator algorithms based on the device electrical consumption input and/or sensor input data (i.e., microphone sensor, temperature sensor) obtained as described above. The algorithms detect changes in device use and sum the number of changes (for calculation of frequency of device usage), use a stopwatch-type function to determine time in the device ‘on state,’ or add the time in the device ‘on state’ to a running tally of accumulated total time in the device ‘on state.’ user defined inputs related to treatment would be captured as data (e.g., text, ascii, csv) in the central hub 200 or remote storage location 310. The inputs would be generated by the users entering input using a mobile or computer input device including, which include but not limited to: a phone (e.g., text message or website interaction), a computer keyboard, a mouse, or voice message. In any event, the communication module 130 can send the monitored parameters 140 to the central hub 200 and processing unit 220.

Once received, the one or more parameters may be communicated to the processing unit 220, which can compare these parameters with manufacturer operational constraints, which may be stored in digital file 210. The processing unit 220 can further compare monitored parameters 140 with a device- and patient-specific prescribed therapy regimen, which may be stored in digital file 230. The processing unit 220 can still further estimate future patient adherence to a prescribed therapy regimen using a NARX neural network model 226. A signal is generated 225 based on the output of the comparator function 222, comparator function 224 and NARX neural network model 226. A log 227 of the generated signals is created and sent via the communication module 240 to a remote location 310.

By way of a non-limiting example, the medical device(s) 110, as described earlier, may receive power through the power module 907 of the medical device monitor 99. The operational parameter of interest, in this example, may be the sound frequency generated by operation of the medical device(s) 110. Proper operation of the medical device(s) 110 by a patient may result in a generated operational frequency greater than zero and that changes based on the load experienced by the medical device. In the case of an air compressor 420, the device generates a lower frequency when a nebulizer (not shown) is attached versus the time when a nebulizer (not shown) is not attached. In addition, the frequency may be altered during the time period when medicine which is within a nebulizer attached to the effluent end of the compressor 420 with a plastic hose is being actively aerosolized and delivered to the patient.

The monitored frequency may be transmitted to the central hub 200 and processing unit 220. Signal filtering and processing, if desired, can be performed within the central hub 200. The sensed frequency of the air compressor 420 in this example can be compared against specified operating conditions in order to ensure optimal performance. If the frequency is outside the optimal manufacturer specified operating constraints, a signal may be sent from the central hub 200 to the remote storage location 310. From the remote storage location 310, a secure message or notification can be sent to inform the patient, payer, or physician via an automated communication method (i.e., email, text message, and telephone call). Patients may also capture their individual mucus resonant frequencies via interface with the central hub 200 or remote location 310 from monitoring parameters associated with the operation of pulmonary percussion system. The processing unit 220 may further change the state of the weighted moving average function 223 to account for the newest data. The altered weighted moving average function 223 is compared to the prescribed therapy regimen 230 and a signal is generated 225 based on the result of this comparison. The processing unit 220 still further computes an estimate of expected future patient adherence to a prescribed therapy regimen using a NARX neural network model 226. Generated signals 225 are then transmitted to a remote location 310 via a communication module 240.

Signals received from the communication module 240 can be further accessible by stakeholders 330, either directly at the remote location 310 or via a communication network 340. Based on the state of the signal transmitted to the remote location, a notification can be generated and transmitted to various stakeholders 330 via the communication network 340. The communication of the data in this example can occur instantaneously in real-time and continuously, or the communication module 240 can transmit the relevant information in accordance with a predetermined schedule or as defined by the operational state of the compressor 420. Once received at the remote location 310, the information can be further processed in any suitable manner at the remote location 310 or via the communication network 340.

Any suitable entity can analyze the received information. For example, physicians may review the information to determine whether the patient has been properly following his/her treatment program. If not, the patient may be contacted in an effort to improve the patient's adherence. In some embodiments, device manufacturers or pharmaceutical companies may wish to investigate the usage and performance of their medical devices. Generated signals may also be forwarded to other organizations, like insurance companies or government agencies, which may also take corrective action to improve the patient's treatment, and or conduct research.

### Using the Data Output of the Integrated Modular Health Platform

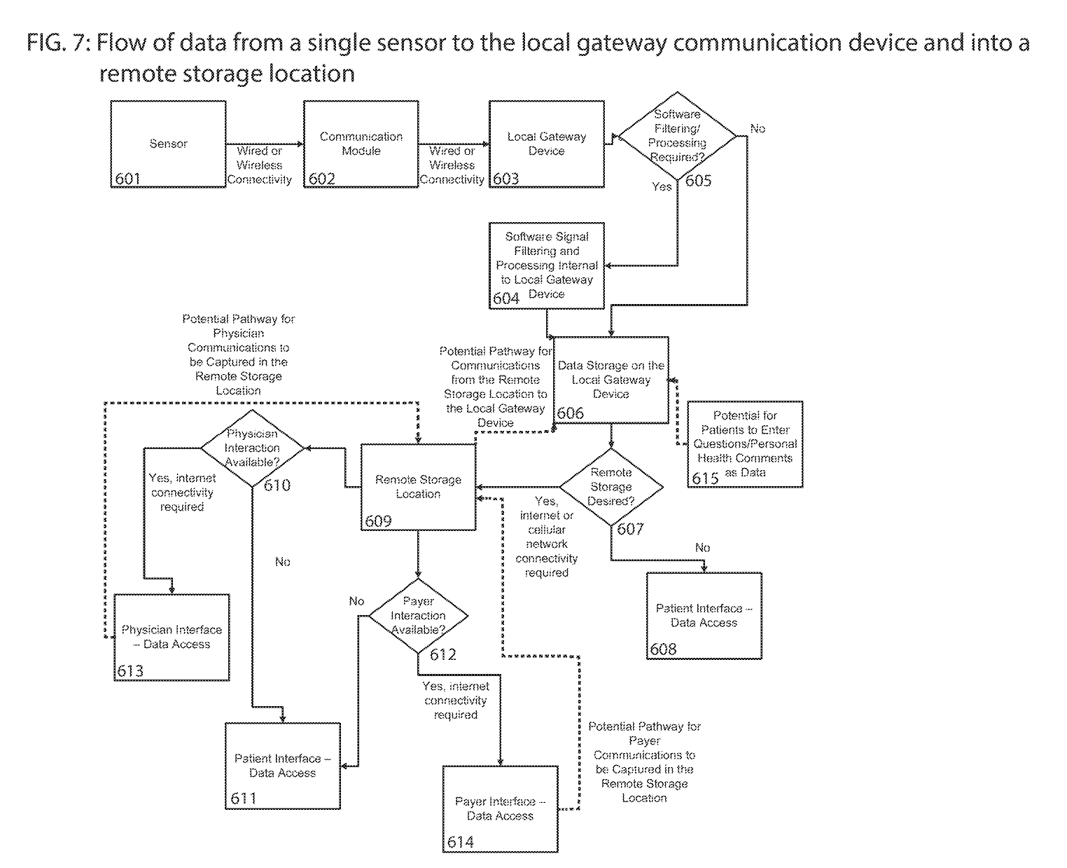

The data output from the integrated modular health platform (“IHP”) of the present disclosure may be used for a variety of purposes. For example, FIG. 7 provides a diagram of the flow of data from a single sensor 601 to the local gateway communication device 603 and into remote storage location 609. As shown in FIG. 7, sensor data flows from the sensor(s) 601 attached to the medical devices through a communication module 602 to a local gateway communication device 603 where it is stored. The collected data is filtered and processed by software 604 located in the communication module 602 or the local gateway communication device 603, if necessary 605. Data produced from the IHP may include, but is not limited to, refrigeration temperature, air compressor air pressure, filtered air flow, sterilization equipment pressure and temperatures, pulmonary compression frequency, medical device power consumption, device generated sound volume, device amperage, device generated sound volumes, and health factor data which may include, but is not limited to expiratory air volume, heart rate, and blood pressure.

Patients can choose 607 to transmit data to a remote storage location 609 via an encrypted internet or cellular connection appropriate for the transmission of private medical data. From the remote storage location 609, the data can be accessed from an existing internet enabled device by the patient 608, the treating physician 613 (if enabled 610), and the payer 614 (if enabled 612). The data can be used for differing purposes by each of these parties. Regardless of the storage option, the collected data is always available to the patient (i.e., IHP user) from the local gateway communication device 603.

Potential patient uses for the IHP generated data include, but are not limited to, medical treatment regimen compliance tracking, ensuring proper sterilization temperature and pressure, air filter effectiveness (using differential pressure across the filter as a stand-in for measuring the percentage of the filter which is blocked), and, in an overall sense, for establishing and testing theories relating treatment routines and changes in health factors. The patient also has the capability of entering personal comments on health, questions to the physician, and questions to their payer into the database 615 via the local communication gateway device 603. Alternatively, this data could also be entered after accessing the remote storage location 609 via an internet-enabled device.

Potential physician uses for the IHP generated data include, but are not limited to, medical treatment regimen compliance tracking, patient health monitoring, treatment effectiveness monitoring, and, in an overall sense, the ability to complete some types of clinical trials outside of a hospital setting. Potential payer uses for the IHP generated data include, but are not limited to, medical treatment regimen compliance tracking, comparison of treatments to long-term patient health, medical device effectiveness monitoring, and drug treatment effectiveness monitoring.

The IHP may also include the ability for communications from a treating physician and a payer representative to be entered into the remote storage location 609 for access by the patient. The treating physician may access patient data, if enabled 610. The physician may then enter treatment notifications, reminders, updates, or answers to patient questions that were provided 615. Notifications and reminders may include items such as stating a need to replace one or more medical devices or confirmation that a device is no longer operating within manufacturer recommendations and should be serviced. Updates include changes to a prescribed treatment regimen for use in the local gateway device 603, filtering software 604 version updates, software drivers for associated sensors 601. Communication pathways include, but are not limited to internet enabled devices, cellular devices, pots, text messages, emails, and voice messages. When physician communications have been entered into the remote storage location 609, the user is notified by a visual and/or audible signal from the local gateway device 603. A payer representative may access patient data anonymously or otherwise, if enabled 612. The payer representative may then enter notifications, reminders, aggregate and/or query patient device medical equipment use, or provide answers to patient questions that were provided 615. Notifications and reminders may include items such as billing statements, prescription refill communications, recommendations for physical device updates, changes to reimbursement plans, medical equipment or prescription drug recalls, availability of prescribed medicine, and availability of equipment replacements. Communication pathways include, but are not limited to internet enabled devices, cellular devices, pots, text messages, emails, and voice messages. When payer communications have been entered into the remote storage location 609, the user is notified by a visual and/or audible signal from the local gateway device 603. Additional communication pathways, which are not depicted in FIG. 7, may also be established to allow for direct linkage to device manufacturer, pharmaceutical representatives, or other stakeholders. All communications will be conducted in a manner compliant with health care encryption requirements (i.e., Health Insurance Portability and Accountabibility Act [HIPAA]; International Organization for Standardization [ISO] standards relating to medical devices, insurance, and patient data; and pertinent European Medical Device Directives [EUMDDs]).

Data from the remote storage location 609 has the potential to update the local gateway device 603. This provides a method for direct physician, payer, and patient interaction through the IHP. These potential interactions are shown via dashed connecting lines in FIG. 7.

### Sensor Array Attachment Equipment List

The array may be designed to mount sensors directly to prescribed medical devices in a manner that does not interfere with the input to or output from the device. The sensors may be designed to mount onto many different types of medical equipment having varying sizes, shapes, and uses. Exemplary medical equipment to which sensors for collecting data may be coupled include, but are not limited to, medical grade refrigerator; medical grade air compressor and associated air-line plumbing; medical grade steam sterilizer; pulmonary percussion system; blood glucose monitoring equipment; blood pressure monitoring equipment; blood oxygen concentration monitoring equipment; dialysis machine; iv fluid delivery system; home oxygen generation equipment; electro cardiogram equipment; electric wheelchair charging station; spirometers, flow meters, and other pulmonary performance tracking equipment and similar medical equipment. As mentioned above, in some embodiments, medical equipment performance is unaffected by the presence of the sensors so integration of the sensors allows the users to perform treatments without consideration for the data gathering ability of the sensor array.

### Sensor Array Embodiments to Monitor the Treatment of Cystic Fibrosis (CF)

In some embodiments, sensors arrays of the present disclosure may be selected specifically for patients suffering from CF.

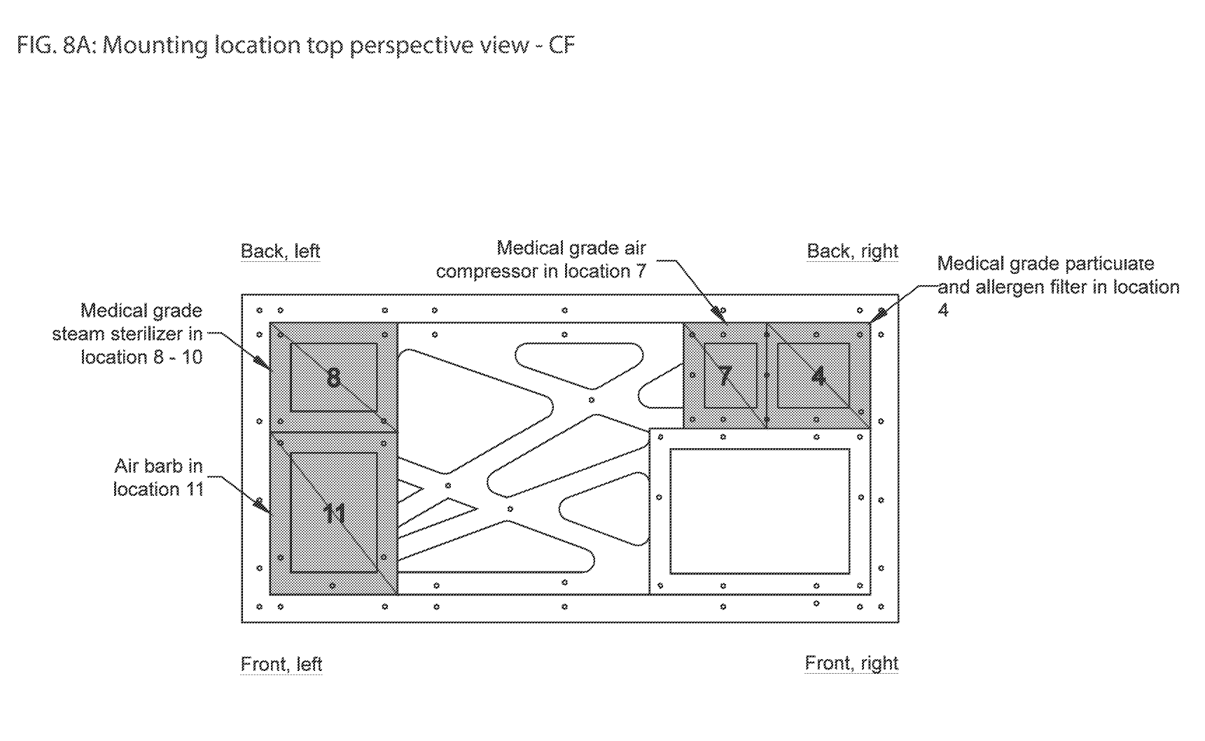

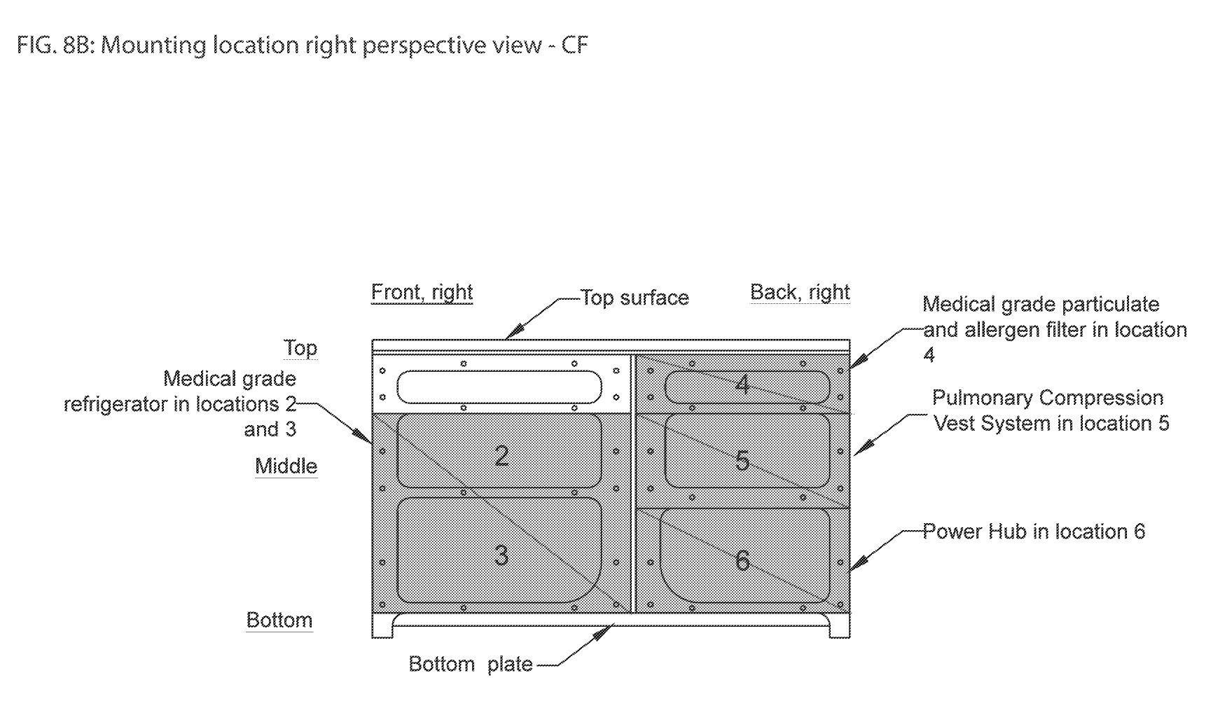

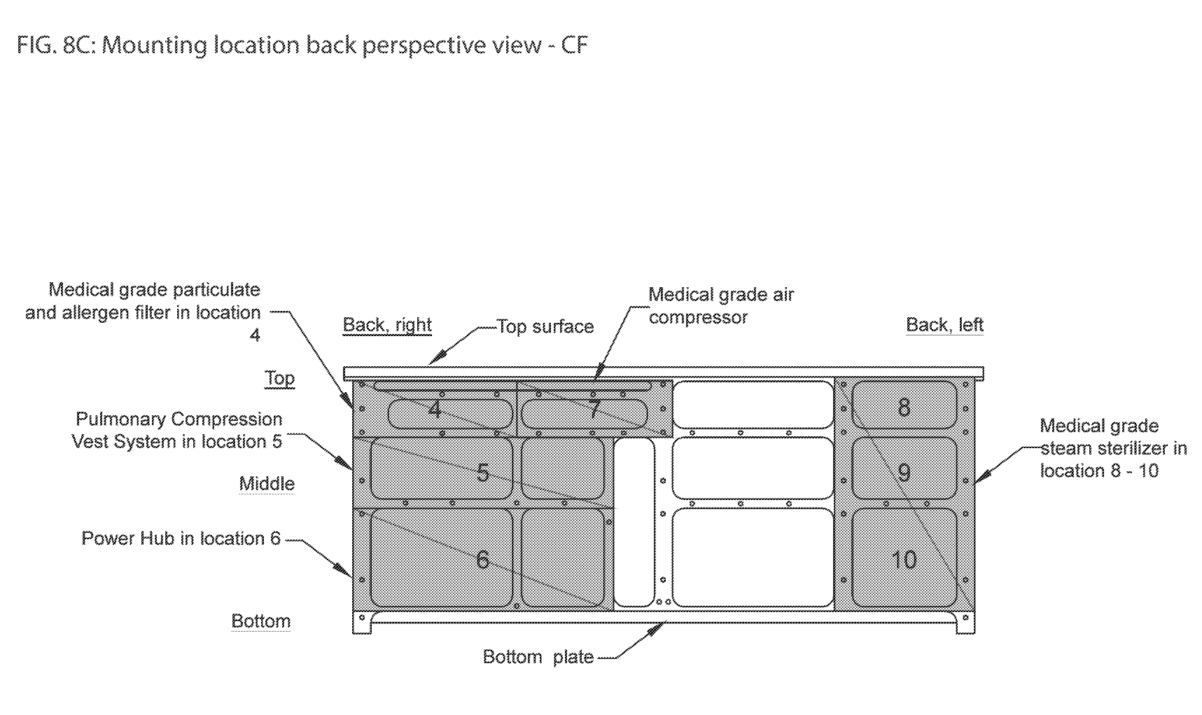

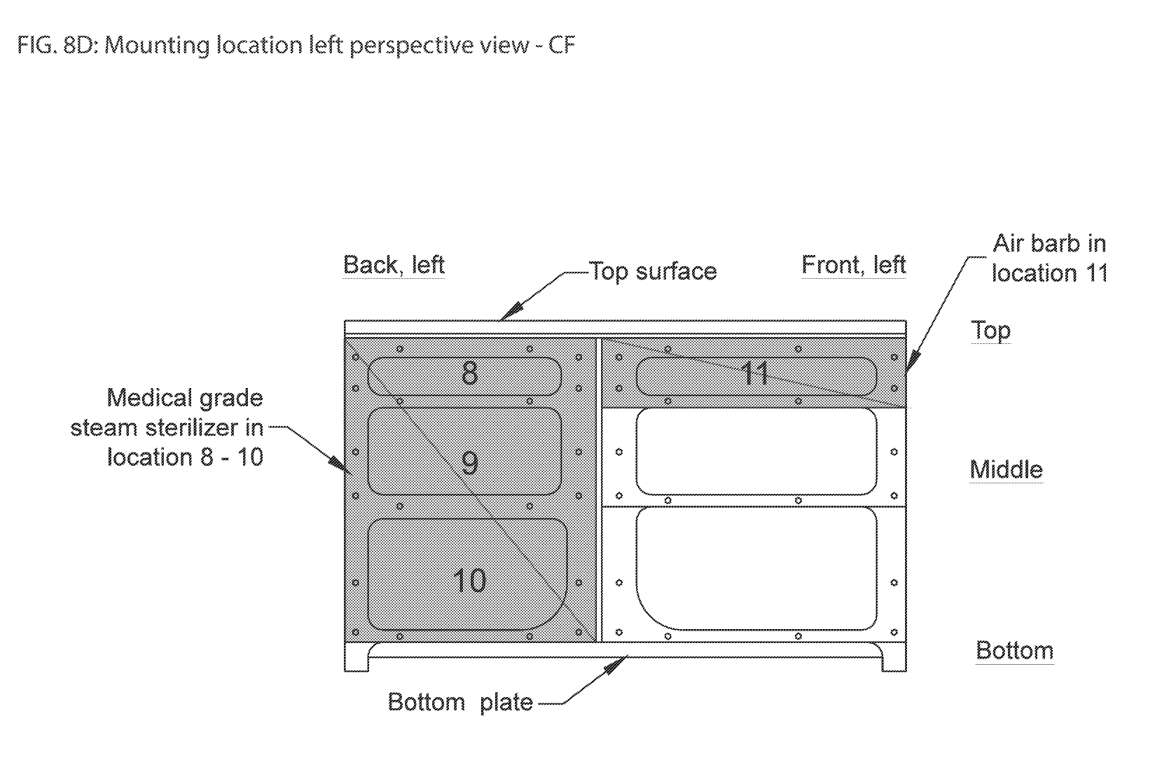

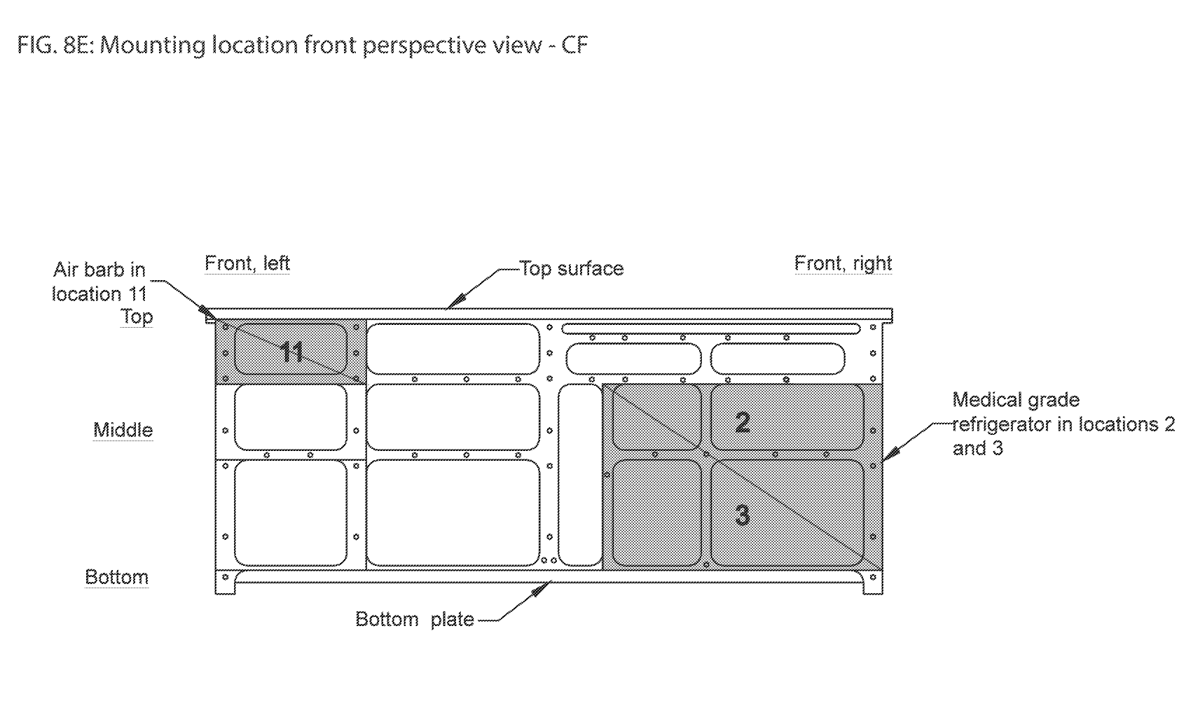

Referring to FIG. 8A, FIG. 8B, FIG. 8C, FIG. 8D, and FIG. 8E, medical devices may be equipped with sensors for the treatment of CF may include, without limitations, medical grade refrigerator (for example, temperature sensor in location 2 and 3); medical grade air compressor, associated air-lines, and air barb (for example, air pressure sensor in location 7 and 11, respectively); medical grade particulate and allergen filter (for example, air flow sensor in location 4); medical grade steam sterilizer (for example, pressure and temperature sensors in location 8-10); pulmonary percussion system (for example, frequency sensor in location 5); power hub (for example, power consumption sensors for individual equipment in location 6), spirometer (not shown).

In some embodiments, sensors may be attached to medical equipment in accordance with the following description. A temperature sensor is installed in the medical grade refrigerator to enable monitoring of the internal temperature (i.e., the temperature at which required medications are being stored). The temperature sensor can be any device which delivers relatively accurate (within ±5 degree Fahrenheit) temperature data for temperatures less than 100 degrees Fahrenheit. Examples of devices which may be used include, but are not limited to: thermocouples, resistive temperature devices (RTD), thermistors, infrared, laser, fiber optic, and semiconductors. The sensor is attached to a wire which transmits data readings from the sensor to a module on the exterior of the refrigerator and supplies power to the sensor as needed. The exterior module contains transmission equipment that communicates with the local gateway device. Signal filtering and processing, if necessary, can be performed within the module or via software in the local gateway device. During this electronic manipulation, the sensed temperature of the fridge can be checked against specified operating conditions in order to maintain the optimal performance of refrigerated medicine. If the temperature is outside the optimal operating band, a signal may be sent from the local gateway device to the remote storage location. From the remote storage location, a secure message or notification can be sent to inform the patient, payer, or physician via an automated communication method (i.e., email, text message, and telephone call).

To measure the flow velocity of air in the compressor system, in some embodiments, an air pressure sensor is mounted on either the inlet or discharge side of the air compressor. The sensor consists of a venturi constriction in the associated airline with a known discharge coefficient. The air pressure on each side of the constriction is measured in order to provide differential air pressure and enable computation of the air flow required to provide the measured differential. In some embodiments, a liquid filled sleeve (LFS) with a known internal fluid pressure is placed over the air delivery line. Connected to the LFS is a pressure transducer. When the air compressor is off, the pressure transducer reading from the LFS fluid pressure is calibrated to zero. During air compressor operation, pressure from the flowing air pushes against the inner walls of the airline and imposes a slight increase in fluid pressure on the LFS. This change is registered on the pressure transducer mounted to the LFS. This pressure change can be calibrated to provide the flow rate directly. In some embodiments, the pressure sensor consists of existing technology and can be any device that is able to deliver relatively accurate (within ±2 pounds per square inch (psi)) pressure data. Examples of devices that may be used include, but are not limited to: piezoelectric, capacitive, electromagnetic, optical, potentiometric, resonant, or thermal. In addition, oscillatory frequency, and/or generated sound volume from the compressor may be monitored. Integrated sensor embodiments feed into a powered external module, which contains wired or wireless equipment capable of communication with the local gateway device. Signal filtering and processing, if necessary, can be performed within the processing module or within the stored data at the remote location. During this electronic manipulation, the sensed air pressure, frequency, or volume can be checked against specified operating conditions in order to determine the current performance of air compressor against manufacturer specifications. If the pressure, frequency, or sound volume is outside the optimal operating band, a signal may be sent from the local gateway device to the remote storage location. From the remote storage location, a secure message or notification can be sent to inform the patient, payer, or physician via an automated communication method (i.e., email, text message, and telephone call).

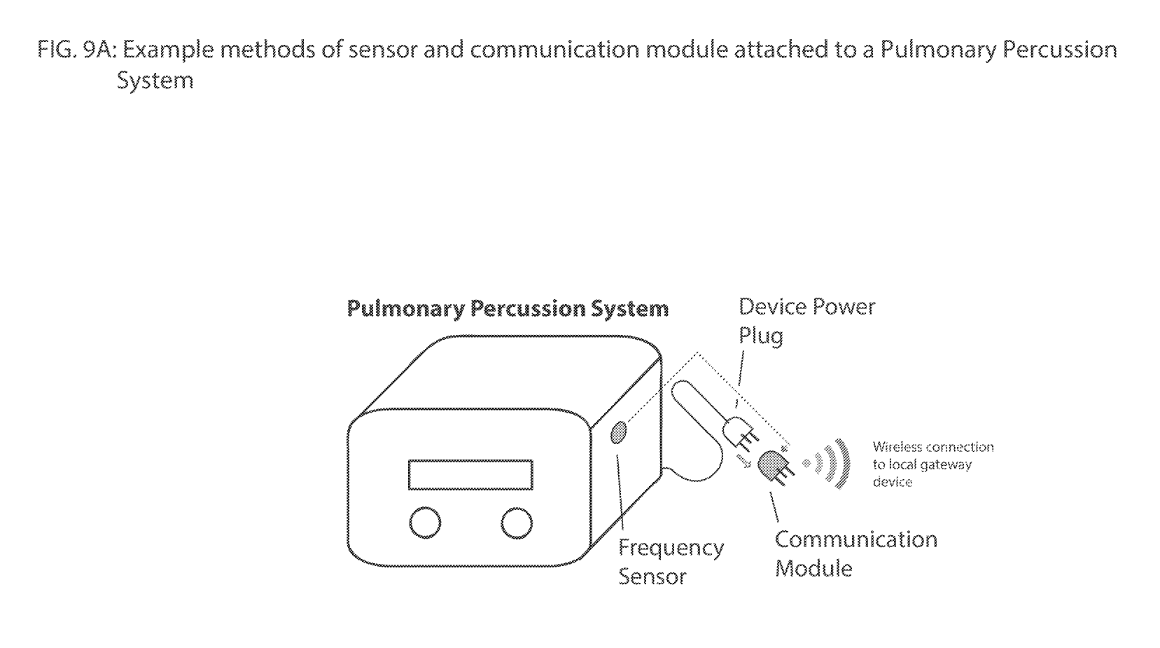

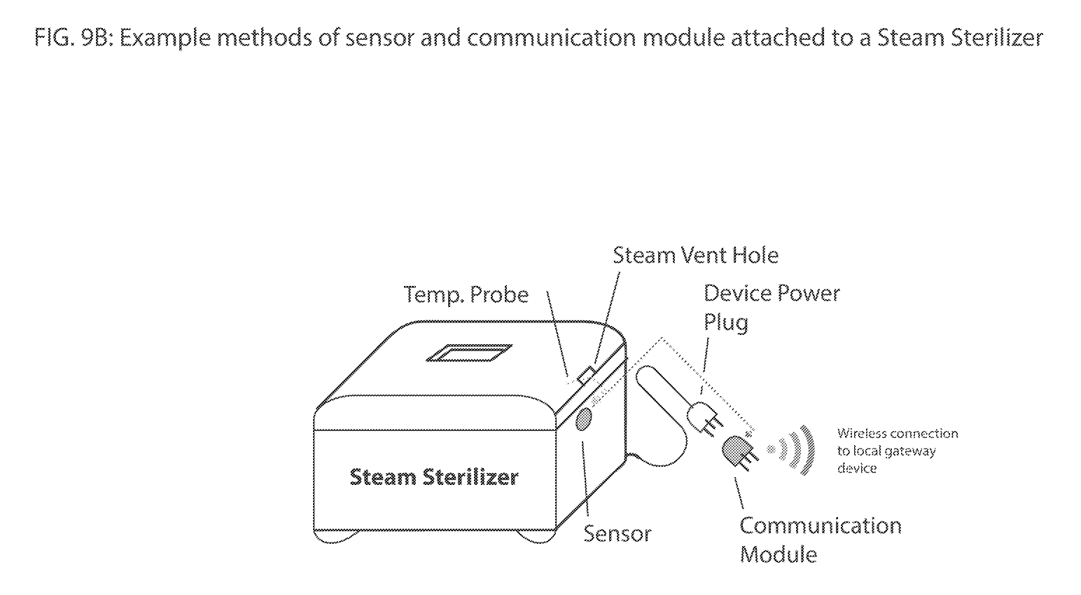

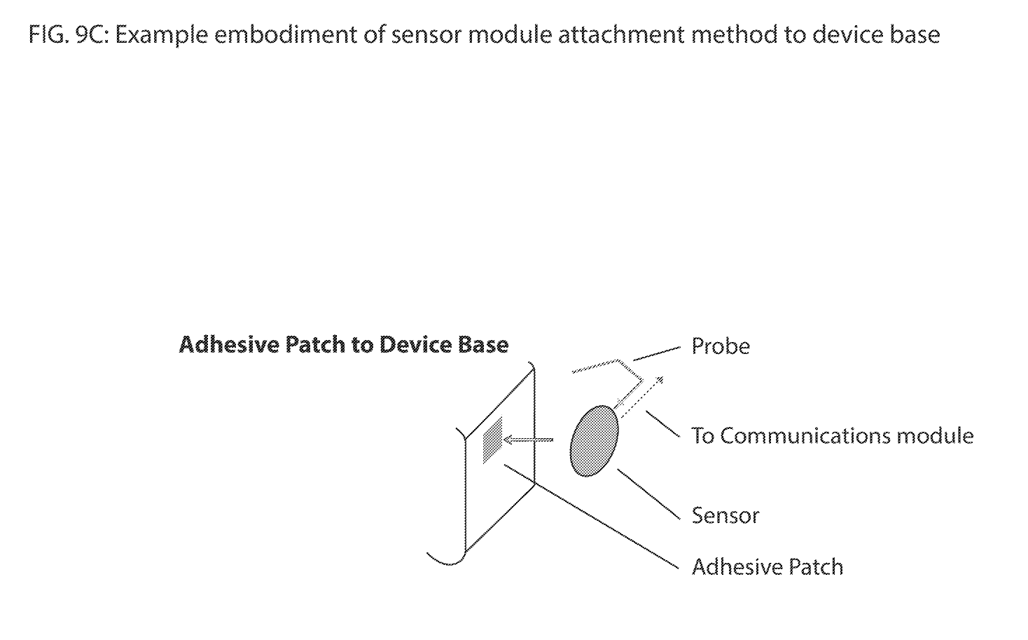

The sensor module and communication module may be attached to the IHP or medical device in a manner similar to that shown in FIG. 9A for the pulmonary percussion system and in FIG. 9B for the steam sterilizer. FIG. 9C shows a potential attachment method for the sensor. The sensor and probe are attached by adhesive patch to the medical device being monitored. The sensor is then attached to the communication module. Those versed in the art will recognize that other methods of attachment exist (e.g., hook and loop, nut and bolt, welding). FIG. 9A shows a frequency sensor attached to the pulmonary percussion system to monitor oscillatory frequency and/or mechanical vibrations. In the depicted embodiment, the communication module is configured to plug into a standard wall outlet. This provides a source of electrical power for the communication module. The communication module is configured such that the medical device power plug is able to plug into the communication module. Electrical power is transmitted from the wall outlet, through the communication module, and then to the medical device being monitored without disrupting the electrical power required by the medical device. In the depicted embodiment, the communication module is connected to the local gateway device by wireless communication protocols (e.g., bluetooth, wifi, infrared). Those versed in the art will recognize that other methods of linking the module and the local gateway device exist, including the potential for a wired connection. In the depicted embodiment, the sensor is separate from the communication module, but connected by a wired connection. This connection supplies power to the sensor and allows sensor output to reach the communication module for transmission to the local gateway device. In other embodiments, the sensor and communication module may be combined into to a single piece. The power supply may also be separated from the communication module and may be provided by alternate means such as a battery. FIG. 9B depicts a sensor and communication module arrangement similar to that shown in FIG. 9A. For the sensor in FIG. 9B, the sensor probe is separate from the body of the sensor. The probe is connected by a wire to the sensor body. To measure temperature within the steam sterilizer, the probe is depicted as inserted into the sterilization chamber through the steam vent hole. This mounting is completed in a manner that does not interfere with device operation. Communication between the sensor (including both the probe and sensor body) and the communication module is conducted in the same manner as discussed for FIG. 9A. The medical grade air filter can be monitored for air flow via non-invasive methods identical to those explained above for the air compressor. In the instance of the filter, the sensed air flow can be checked against specified operating conditions to ensure effective filtering is occurring and filter flow is not interrupted by clogging. Notifications related to filter status can be transmitted in a manner identical to that described above for the air compressor.

A temperature sensor capable of monitoring the internal conditions (i.e., the temperature at which equipment sterilization is occurring) of the device is mounted to the steam sterilizer as shown in FIG. 9B. The temperature sensor can be any device that can deliver relatively accurate (within ±5 degree Fahrenheit) temperature data for temperatures less than 400 degrees Fahrenheit. Examples of devices that may be used include, but are not limited to: thermocouples, resistive temperature devices (RTD), thermistors, infrared, laser, fiber optic, and semiconductors. FIG. 9B illustrates an example using a thermocouple sensor providing data to an externally mounted sensor module, but other devices may also be used. The thermocouple output wire is threaded through the steam vent port of the sterilizer. The external module is connected to a powered communication module containing equipment which communicates with the local gateway device. Signal filtering and processing, if necessary, can be performed within the module or via software in the local gateway device. During this electronic manipulation, the sensed temperature of the sterilizer can be checked against specified operating conditions in order to ensure optimal sterilization. If the temperature, or length of time the device remains at the specified temperature, is outside the optimal operating band, a signal may be sent from the local gateway device to the remote storage location. From the remote storage location, a secure message or notification can be sent to inform the patient, payer, or physician via an automated communication method (i.e., email, text message, and telephone call).

Oscillation frequency of the pulmonary percussion system may be non-invasively monitored using an acoustic sensor mounted directly to the pulmonary percussion housing. This allows the operating frequency of the system to be captured. The sensor non-invasively measures the oscillations of the air pressure reaching the system by monitoring the mechanical vibration of the compressor housing. The acoustic sensor may have a low-pass filter applied to reduce interference from high frequency signals associated with other technologies which may be in use at the same time. The sensor can be any device which delivers relatively accurate data on a short time scale (on periodicity of 0.1 seconds). Examples of devices which may be used include, but are not limited to: piezoelectric, capacitive, electromagnetic, optical, potentiometric, resonant, thermal, and acoustic. The sensor is attached to a wire which transmits data readings from the sensor to a module on the exterior of the regulator and supplies power to the sensor as needed. The exterior module contains transmission equipment which communicates with the local gateway device. Signal filtering and processing, if necessary, can be performed within the module or via software in the local gateway device. During this electronic manipulation, the sensed frequency of the system can be checked against specified operating conditions in order to ensure optimal performance. If the frequency is outside the optimal operating band, a signal may be sent from the local gateway device to the remote storage location. From the remote storage location, a secure message or notification can be sent to inform the patient, payer, or physician via an automated communication method (i.e., email, text message, and telephone call). Patients may also capture their individual mucus resonant frequencies via interface with the local gateway device.

By way of a non-limiting example, the power hub may contain a plurality of power consumption sensors able to monitor all devices connected to the power hub at the same time. The power consumption sensor can be any device that measures amperage in an electrical circuit (i.e., an ammeter). Power hub sensors are connected to an integral module containing transmission equipment that communicates with the local gateway device. Because the power hub is directly connected to a power supply (i.e., standard wall outlet), power to the sensors and communication module is supplied directly from the power circuitry (i.e., power is supplied from the power hub circuits). Medical devices are attached to the power hub via their standard circuits. In the IHP, the power hub is plugged directly into an existing wall socket via a standard electrical plug. Electrical power is provided through the power hub to the communication module and a variety of outlets suitable for use by existing electrical plugs on the installed medical devices. When a medical device is plugged into the power hub via its standard cord, electricity is supplied to the device as though it were plugged into a standard wall outlet or power strip (a device which can be plugged into a single outlet and contains allows multiple devices to be plugged in at the same time). Signal filtering and processing, if necessary, can be performed within the module or via software in the local gateway device. During this electronic manipulation, the sensed electrical usage (as measured by device amperage) of the devices can be checked against specified operating conditions in order to ensure equipment is functioning correctly. Electricity consumption outside of the specified band may indicate degradation in the equipment. In the event that operation is outside the optimal operating band, a signal may be sent from the local gateway device to the remote storage location. From the remote storage location, a secure message or notification can be sent to inform the patient, payer, or physician via an automated communication method (i.e., email, text message, and telephone call).

In some embodiments, a spirometer is mounted to the sensor array. This health factor monitor is not necessarily attached to a medical device, but may be a fully separate device. The spirometer is a connected to an integral module containing transmission equipment that communicates with the local gateway device. Signal filtering and processing, if necessary, can be performed within the module or via software in the local gateway device.

FIG. 5 and FIG. 6 provide a basic overview of the mounting of these components in a modular health platform, which can be in a form of desk. The modular health platform may have a chassis or a supporting structure to which medical equipment and sensors may be mounted. The flexibility of mounting medical devices or sensors to the chassis is further demonstrated by example. For example, the modular health platform may include various medical device components 901, 902, 904, 907, 911, 912, 913, 914 as shown FIG. 6. One component from FIG. 6 902 that may be a medical device occupies mounting positions 802, 803, 805, and 806 as shown in FIG. 5. Another component from FIG. 6 911 that may be a medical device occupies FIG. 5 mounting positions 811 and 808. Another component from FIG. 6 912 that may be a medical device occupies FIG. 5 mounting positions 812 and 809. Another component from FIG. 6 913 that may be a medical device occupies FIG. 5 mounting positions 813 and 810. Another component from FIG. 6 901 that may be a medical device occupies FIG. 5 mounting position 801. Another component from FIG. 6 904 that may be a medical device occupies FIG. 5 mounting position 804. In one embodiment, FIG. 6 component 907 is representative of a power module. The power module from FIG. 6 907 may be configured to engage a standard wall outlet and accept the plugs of the mounted medical devices, sensors, and communication equipment. The electrical connections from FIG. 6 914 may be routed through the chassis. The top surface of the chassis from FIG. 6 915 has no mounted medical devices or components to increase the functionality of the chassis to serve as a desk or workstation for the patient using the monitoring system. Medical devices and components are mounted to the chassis using a bolt and nut assembly.

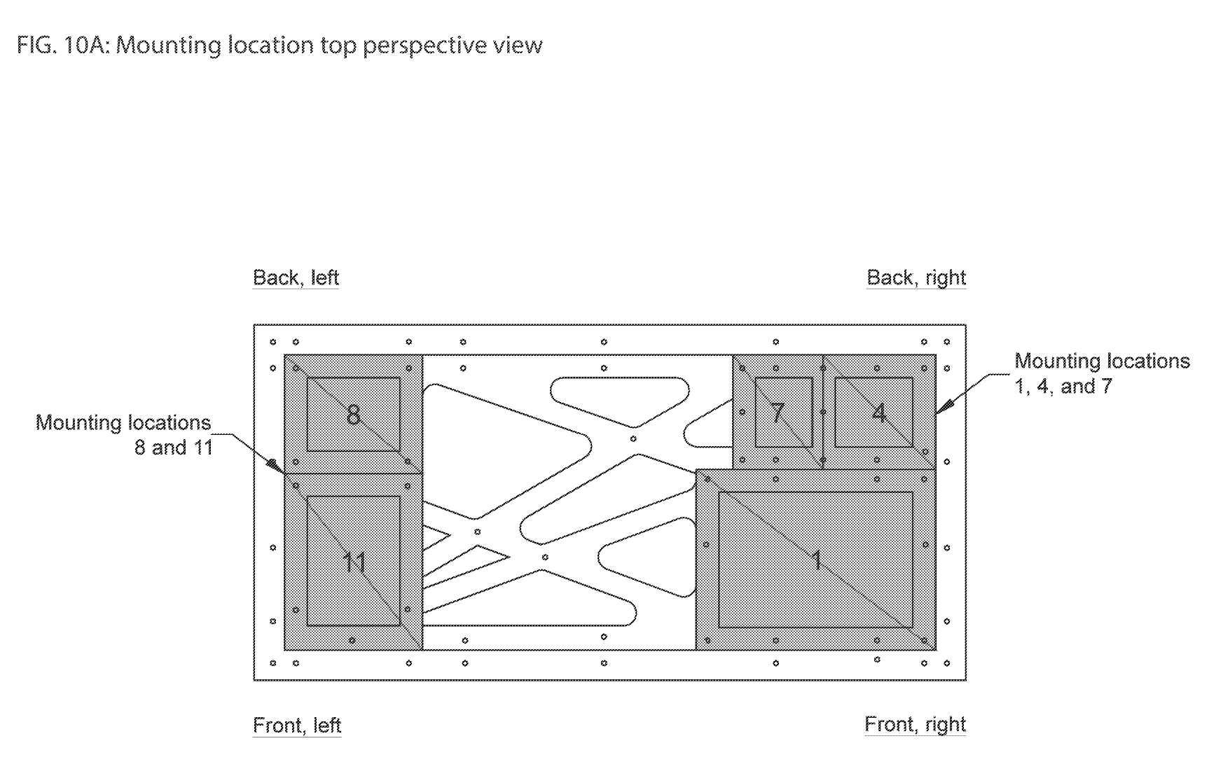

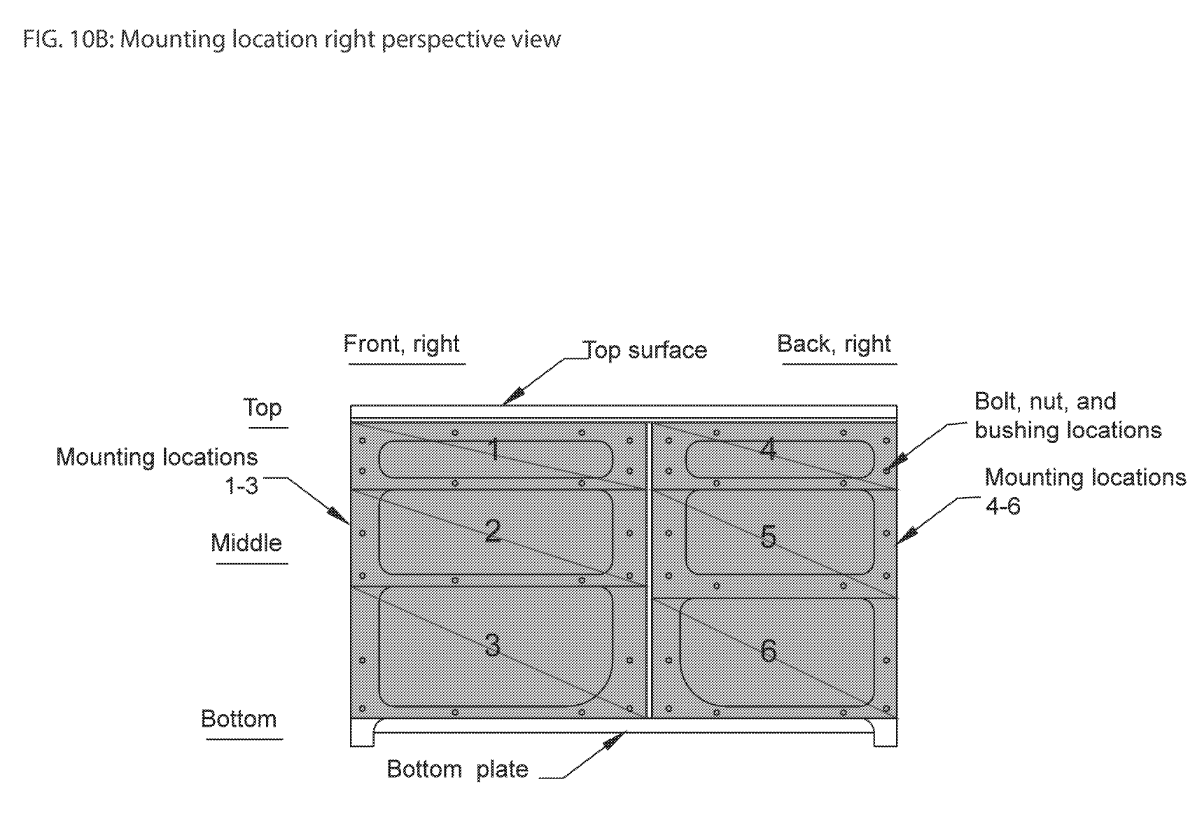

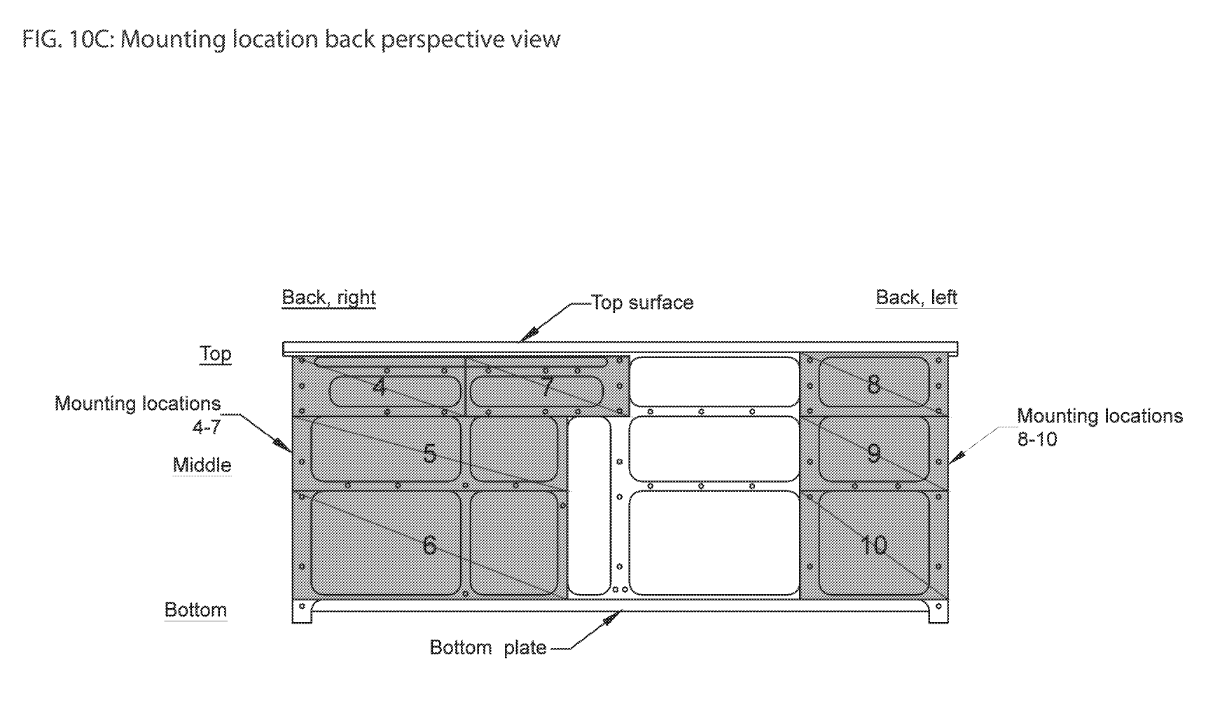

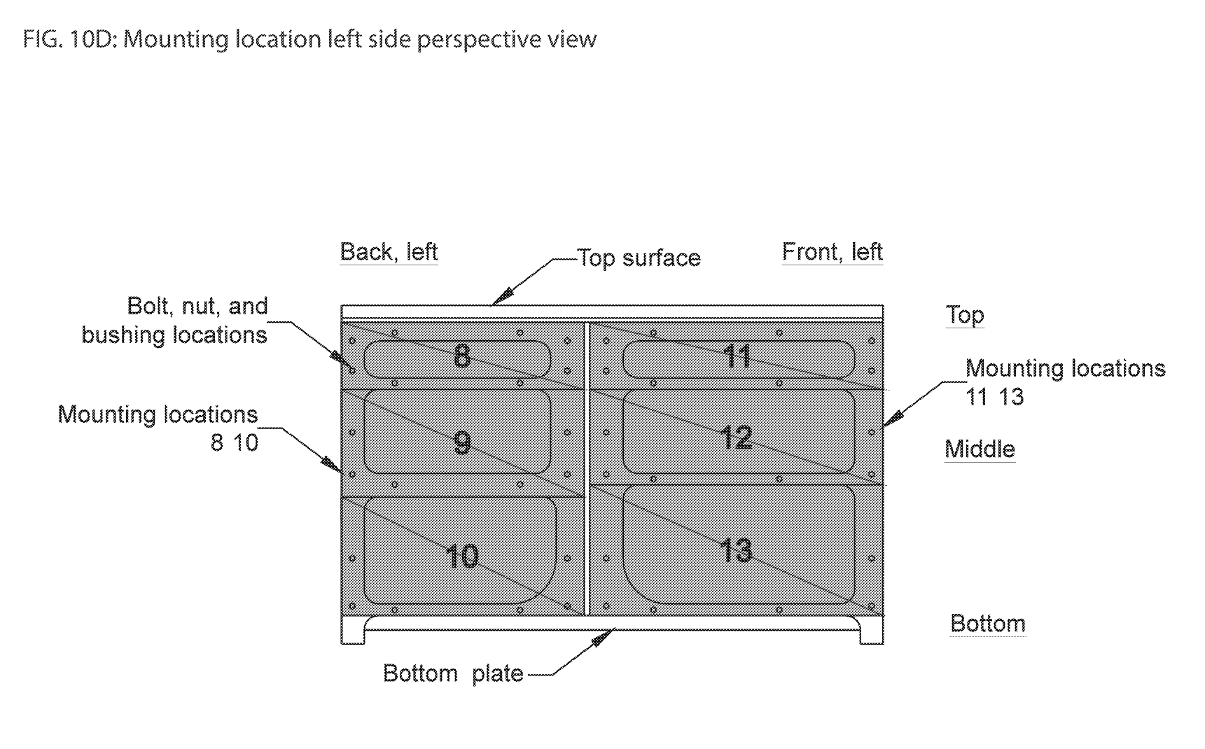

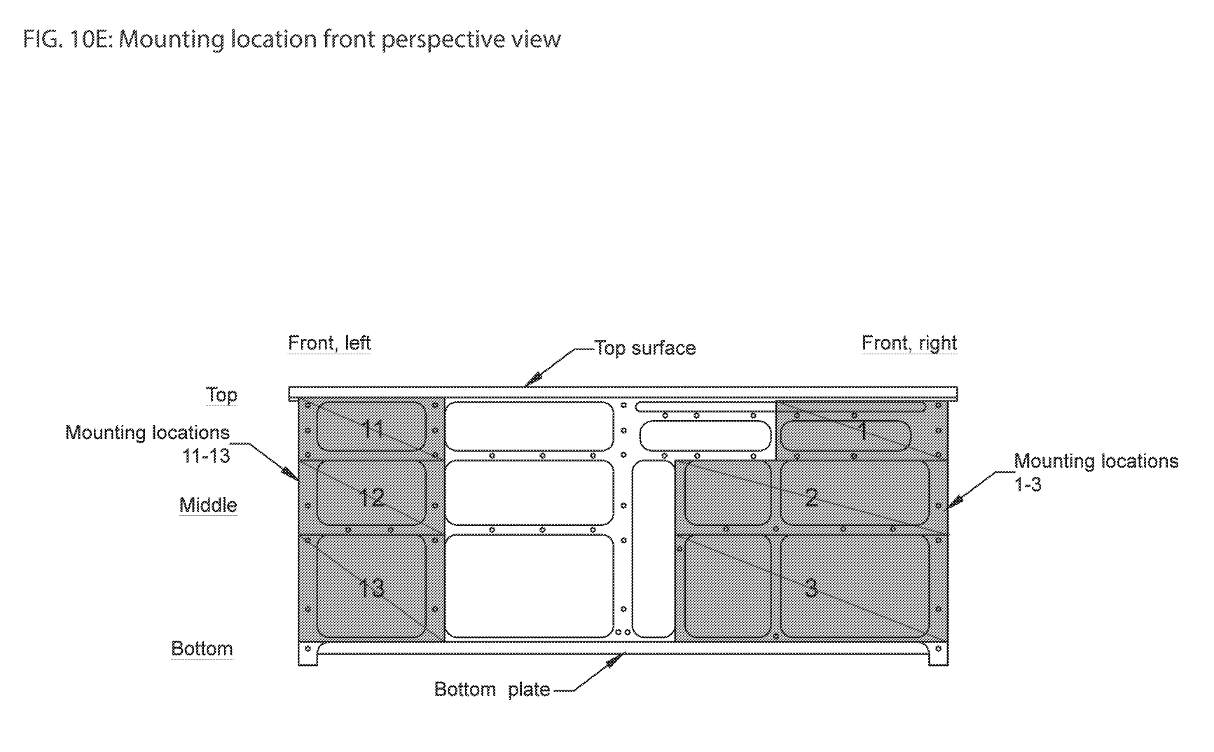

Referring to FIG. 10A, which shows a top perspective view of the integrated modular health platform, mounting locations 1, 4, 7, 8, and 11 are shown. The front and back refer to the front and back of the modular platform, respectively. The left and right refer to the left and right sides of the modular platform, respectively. Mounting location 1 is shown in the back left corner. Mounting location 4 and 7 are shown in the back right corner. Mounting location 11 is shown in the front left corner. Mounting location 8 is shown in the back left. Mounting location 11 may be reserved for an air barb, which if needed, may be connected through internally plumbed air lines to the other equipment mounted on the modular platform. Medical equipment in locations 1, 4, 7, 8, and 11 can be directly mounted to the top of the modular platform.

Still referring to FIG. 10A, medical equipment can be directly mounted to locations 1, 4, 7, 8, and 11 using, for example, a nut and bolt assembly. Bolting locations surrounding mounting locations are shown in approximate positions to provide sufficient support to the medical equipment, but may be modified to fit equipment as needed. The bolt spacing will vary between 4 and 12 inches lengthwise, and between 4 and 6 inches widthwise.

Still referring to FIG. 10A, the dimensions of the top of the modular platform may be sufficient to accommodate the medical equipment for the management of CF, provide for leg room, and provide a sufficient surface area at which to perform therapy and work. In some embodiments, the length of the top surface of modular platform is between 60 and 72 inches; the width of the top of the modular platform is between 36 and 48 inches. The top of the modular platform is kept level and at an elevated position above the floor by attachment to the left side, back, and right side of the modular platform.

FIG. 10B shows the right side perspective view of the integrated modular health platform where mounting locations 1-6 are shown. The front and back refer to the front and back of the modular platform, respectively. The right refers to the right side of the modular platform. The top, middle, and bottom refer to mounting position above the ground, with bottom being the closest to the ground and top being the farthest. Mounting location 1 is shown in the top front right. Mounting location 2 is shown directly below mounting location 1, in the middle front right. Mounting location 3 is shown directly below mounting location 2, in the bottom front right. Mounting location 4 is shown in the top back right. Mounting location 5 is shown directly below mounting location 4, in the middle back right. Mounting location 6 is shown directly below mounting location 5, in the bottom back right. Equipment in mounting location 1 and 4 can be attached to the right side or top of the modular platform. Equipment in location 2 can only be attached to the right side of the modular platform. Equipment in mounting location 3 can be attached to the right side of the modular platform and/or supported by the bottom plate, which may be welded or bolted to the left side, back, and right sides of the modular platform. For example, equipment in mounting location 4 can be mounted to the top, right side, and/or back of the modular platform. Equipment in mounting location 5 can be mounted to the right side and/or back of the modular platform. Equipment in mounting location 6 can be mounted to the right side and, or supported by the bottom plate.

Still referring to FIG. 10B, medical equipment can be directly mounted to locations 1-6 using a nut and bolt assembly. Bolting locations surrounding mounting locations are shown in approximate positions to sufficiently provide support to the medical equipment, but may be modified to fit equipment as needed. The bolt spacing will vary between 4 and 6 inches widthwise, and between 4 and 6 inches height wise.

Still referring to FIG. 10B, the dimensions of the right side of the modular platform may be sufficient to accommodate the medical equipment for the management of CF and provide for leg room. The width of the right side of the modular platform is between 36 and 48 inches; the height of the modular platform is between 30 and 42 inches. The right side of the modular platform is bolted or welded to the top of modular platform along the top edge of the right side. The right side of the modular platform is kept upright by attachment to the back and top of the modular platform.

Referring now to FIG. 10B, the back perspective view, mounting locations 4-10 are shown. The back refers to the back of the modular platform. The right and left refer to the right and left side of the modular platform, respectively. The top, middle, and bottom refer to mounting position above the ground, with bottom being the closest to the ground and top being the farthest. Mounting location 4 is shown in the top back right. Mounting location 5 is shown directly below mounting location 4, in the middle back right. Mounting location 6 is shown directly below mounting location 5, in the bottom back right. Mounting location 8 is shown in the top back left. Mounting location 9 is shown directly below mounting location 8, in the middle back left. Mounting location 10 is shown directly below mounting location 9, in the bottom back left. Mounting location 7 is located directly adjacent to mounting position 4, towards the center of the back. Equipment in mounting locations 4, 7, and 8 can be attached to the top or back of the modular platform. Equipment in location 8 can be mounted to the top, back or left side of the modular platform. Equipment mounted in mounting location 9 can be attached to the back and/or or left side of the modular platform. Equipment in mounting location 10 can be attached to the back, left side and/or supported by the bottom plate.

Still referring to FIG. 10C, medical equipment can be directly mounted to locations 4-10 using a nut and bolt assembly. Bolting locations surrounding mounting locations are shown in approximate positions to provide sufficient support to the medical equipment, but may be modified to fit equipment as needed. The bolt spacing will vary between 4 and 12 inches length, and between 4 and 6 inches height wise.

Still referring to FIG. 10C, the dimensions of the back of the modular platform may be sufficient to accommodate the medical equipment for the management of CF and join with the top, left side, and right side. The length of the back is matched to the top, which is between 60 and 72 inches; the height of the modular platform is matched with the left and right sides and is between 30 and 42 inches. The back of the modular platform is bolted or welded to the top, left side, and right side of modular platform along the top, left, and right edges, respectively. The back of the modular platform is kept upright by attachment to the left side, right side, and top of the modular platform.

Now referring to FIG. 10D, the left side perspective view, mounting locations 8-13 are shown. The front and back refer to the front and back of the modular platform, respectively. The left refers to the left side of the modular platform. The top, middle, and bottom refer to mounting position above the ground, with bottom being the closest to the ground and top being the farthest. Mounting location 8 is shown in the top back left. Mounting location 9 is shown directly below mounting location 8, in the middle back left. Mounting location 7 is shown directly below mounting location 8, in the bottom back left. Mounting location 11 is shown in the top front left. Mounting location 12 is shown directly below mounting location 11, in the middle front left. Mounting location 13 is shown directly below mounting location 12, in the bottom front left. Equipment in mounting location 8 and 11 can be attached to the left side or top of the modular platform. Equipment in location 12 can only be attached to the left side of the modular platform. Equipment in mounting location 10 and 13 can be attached to the left side of the modular platform and, or supported by the bottom plate, which is welded or bolted to the left side, back, and right side of the modular platform.

Still referring to FIG. 10D, bolting locations surrounding mounting locations are shown in approximate positions to provide sufficient support to the medical equipment, but may be modified to fit equipment as needed. The bolt spacing will vary between 4 and 6 inches widthwise, and between 4 and 6 inches height wise.

Still referring to FIG. 10D, the dimensions of the left side of the modular platform may be equal to that of the right side, which may be sufficient to accommodate the medical equipment for the management of CF and provide for leg room. The width of the left side of the modular platform is between 36 and 48 inches; the height of the modular platform is between 30 and 42 inches. The left side of the modular platform kept upright through a bolted or welded attachment to the top and back of the modular platform along the top and back edges, respectively.

Now referring to FIG. 10E, the front perspective view, mounting locations 1-3 and 11-13 are shown. The front refers to the front of the modular platform. The right and left refer to the right and left side of the modular platform, respectively. The top, middle, and bottom refer to mounting position above the ground, with bottom being the closest to the ground and top being the farthest. Mounting location 11 is shown in the top front left. Mounting location 12 is shown directly below mounting location 11, in the middle front left. Mounting location 13 is shown directly below mounting location 12, in the bottom front left. Mounting location 1 is shown in the top front right. Mounting location 2 is shown directly below mounting location 1, in the middle front right. Mounting location 3 is shown directly below mounting location 2, in the bottom front right. The bottom plate connects to left side, back, and right side of the modular platform along the bottom edge, just above the legs. The dimensions of the bottom plate are sufficient to connect to the left side, back, and right side of the modular platform along the bottom edge, but the shape is modified to allow for a person to sit on a chair and slide their legs underneath the modular platform's top surface.

In some embodiments, the present modular platform is in the form of a desk to increase discreteness and prevent disease related sensitivity issues. The left side, right side, and back mounting locations of the modular platform may be designed to mount medical equipment of size, shape, and weight onto the modular platform. In addition, the platform is designed to be modular, in that medical equipment can be mounted in a plurality of locations on the platform, and that medical equipment may be easily changed or moved.

The construction details of the modular platform as shown in FIG. 10A, FIG. 10B, FIG. 10C, FIG. 10D, and FIG. 10E may be made of aluminum, carbon fiber, wood, or of any other sufficiently rigid and strong material such as high-density plastic or metal. Further, various vibration dampening components may be made of rubber, plastic, noise and vibration insulating foam, or other sufficiently sound and vibration dampening material when used in a bolt and nut assembly.

Referring to FIG. 5, an example embodiment of a chassis 800 is presented wherein the medical devices, sensors, power module, and communication equipment may be mounted in a single platform. The positions 801, 802, 803, 804, 805, 806, 807, 808, 809, 810, 811, 812, and 813 in FIG. 5 are representative of the previously described unique mounting locations within the chassis 800 wherein medical devices or other components may be affixed as, for example, shown in FIG. 6.

As discussed above, in some embodiments, the configuration of the chassis is flexible in that the medical devices, sensors, a power module, and communication equipment may be mounted in a plurality of configurations of the chassis. Mounting locations 801, 802, 803, 804, 805, 806, 807, 808, 809, 810, 811, 812, and 813 may hold one or a portion of the medical devices, sensors, power module, and communication equipment required for adherence to a prescribed treatment regimen and monitoring thereof. In some embodiments, all mounting locations may be located below the top surface 815 to conceal the medical devices or sensors mounted to the chassis. The chassis may further passively conceal mounted medical devices and components and reduce operational noise and vibration. Concealment may be achieved by placing the medical devices in a closed container. Concealment is further achieved by the appearance of the container. As depicted in FIG. 6, the modular platform containing the mounted equipment appears, in form and function, to be similar to a desk or workstation. Operational noise and vibration may be reduced by encapsulation of the device in the closed container. Further reduction may be achieved by mounting the device with anti-vibration fasteners or bushings comprised of materials such as rubber or synthetic/natural polymer sufficient to satisfy the intention of inhibiting vibrations. Further reduction may be accomplished by incorporation of a noise reducing barrier around the medical device. This barrier may be comprised of various materials including, but not limited to: metals, foams, polymers, rubber compounds, and natural fibers (e.g., cotton). Concealment and reduction of operational noise and vibration may help to reduce barriers to compliance such as disease related embarrassment. By placing the prescribed medical devices out of direct sight and reducing the noise associated with operation, users may feel more comfortable performing treatments in the presence of other people. Balancing the demands of work, life, and treatment is another potential barrier to adherence that may be addressed by the concealment of the equipment. The desk-like appearance of health platform configuration shown in FIG. 6 is conducive to performing work or play tasks while simultaneously performing medical treatments in compliance with a prescribed regimen.

### Modular Platform Mountable Equipment List

In some embodiments, the modular mounting platform portion of the present disclosure is in the form of a desk to increase discreteness and prevent disease related sensitivity issues. The integrated modular health platform is designed to mount many different types medical equipment having varying sizes, shapes, and weight onto the platform in a plurality of configurations. By way of a non-limiting example, equipment that can be mounted on the modular platform includes, but is not limited to, medical grade refrigerator; medical grade air compressor and associated air-line plumbing; medical grade steam sterilizer, shown as a pop-up module; pulmonary percussion system; locking pill organizer; sharps disposal; blood glucose monitoring equipment; blood pressure monitoring equipment; blood oxygen concentration monitoring equipment; dialysis machine; iv fluid delivery system; oxygen tank holder/home oxygen generation equipment; electro cardiogram equipment; electric wheelchair charging station; sensor array power supply; local gateway device for storage of and interaction with data from sensors; hardware/software driven treatment reminder and compliance tracking system; spirometers, flow meters, and other pulmonary performance tracking equipment along with other medical equipment.

### Modular Platform Embodiments to Monitor the Treatment of Cystic Fibrosis (CF)

The modularity and flexibility in mounting positions as described above allows to easily configure the integrated health platform of the present disclosure for use by CF patients. By way of a non-limiting example, referring to FIG. 8A, FIG. 8B, FIG. 8C, FIG. 8D, and FIG. 8E, the following equipment may be mounted to the modular platform for the treatment of CF Medical grade refrigerator (for example, in location 2 and 3); Medical grade air compressor, associated air-lines, and air barb (for example, in location 7 and 11, respectively); Medical grade particulate and allergen filter (for example, in location 4); Medical grade steam sterilizer (for example, in location 8-10); Pulmonary percussion system (for example, in location 5); Power hub (for example, in location 6); and Spirometer (in various locations).

Still referring to FIG. 8A, FIG. 8B, FIG. 8C, FIG. 8D, and FIG. 8E, a medical grade refrigerator may be mounted in location 2 and 3 in a fashion that reduces noise and vibration. This can be performed by mounting the device to the mounting points in location 2 and 3 using rubber or other sufficient sound and vibration dampening material as bushings in a bolt and nut assembly. During operation, exhaust air is routed through the side of the modular platform in such fashion as to prevent processed air from entering the air filter in location 4. Power for the medical grade refrigerator can be delivered from the power hub mounted in location 6.

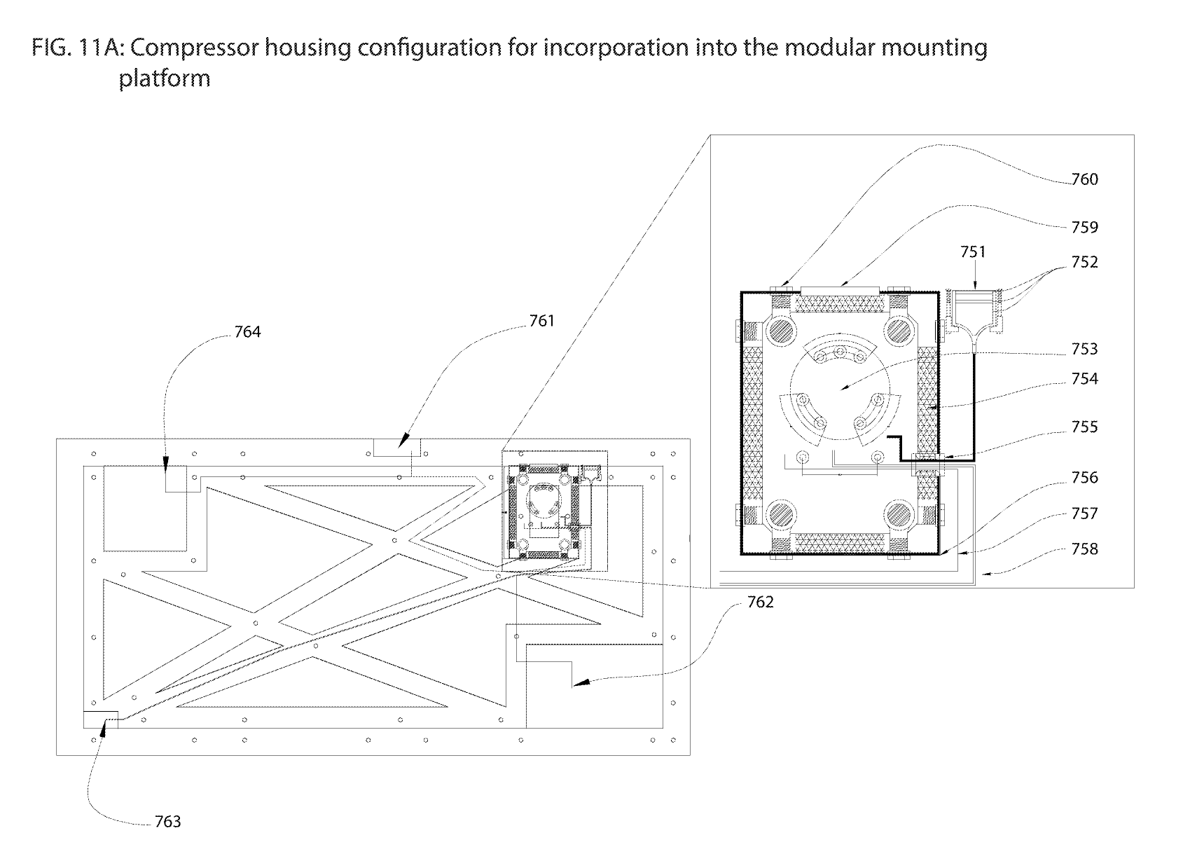

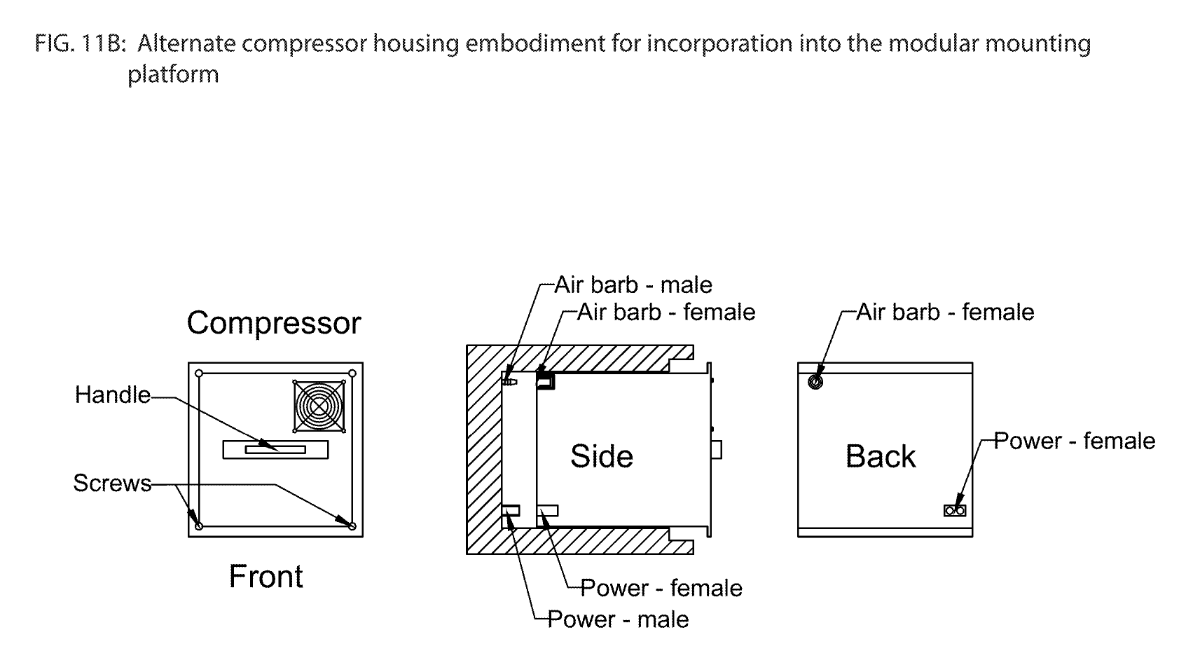

Still referring to FIG. 8A, FIG. 8B, FIG. 8C, FIG. 8D, and FIG. 8E, a medical grade air compressor can be mounted in position 7; a medical grade particulate and allergen filter can be mounted in position 4. The location of the air compressor and filter may allow for air to be drawn through the back of the desk, through the filter system and into the compressor. The medical grade air compressor's sound and vibration is dampened by mounting the equipment inside a compressor housing box. In order to more fully describe the mounting platform, potential designs for the compressor housing are included in FIG. 11A and FIG. 11B in various configurations. In some embodiments, the mounting method uses rubber or other sufficient vibration absorbing material to mount the compressor housing to the modular platform using a bolt and nut assembly. Within the compressor box, noise dampening of the compressor can be achieved through the use of energy absorbent foam on the interior walls. The compressor housing box can be mounted using a bolt and nut assembly. Compressed air is routed from the compressor, position 7, to the air barb, position 11. Power can be delivered to location 7 from a power hub mounted in location 6.

Still referring to FIG. 8A, FIG. 8B, FIG. 8C, FIG. 8D, and FIG. 8E, a medical grade steam sterilizer can be mounted in location 8-10. The assembly can be designed to be stored in location 8-10 while not in use, but ‘pop-up’ through the top of the modular platform to rest above the level of the top desk surface when in operation. In some embodiments, automation of the raising and lowering of the sterilizer could be performed using a linear actuator and 2-position control switch, or gas compressed cylinder and track system. As the method of raising and lowering the sterilizer is neither novel nor the focus of this application, details are not included. The medical grade steam sterilizer lift system can be mounted to the modular platform using a bolt and nut assembly.

Still referring to FIG. 8A, FIG. 8B, FIG. 8C, FIG. 8D, and FIG. 8E, a pulmonary percussion system can be mounted in location 5. To operate the percussive unit, tubing from the pulmonary percussion system can be connected to ports located on a nylon jacket, which is worn by the user. During operation, air is pumped in and out of the air chambers resting against the patient's abdomen quickly, compressing the chest wall in and out and mechanically loosening mucus in the user's lungs. The pulmonary percussion system is mounted to the modular platform in a fashion that reduces noise and vibration. This may be performed mounting the device to the mounting points in location 5 using rubber, or other sufficiently sound and vibration dampening material as bushings in a bolt and nut assembly. The tubing from the pulmonary percussion system can be internally routed from location 5 to the air barb in position 11. Power is delivered to location 11 from a power hub mounted in location 6.

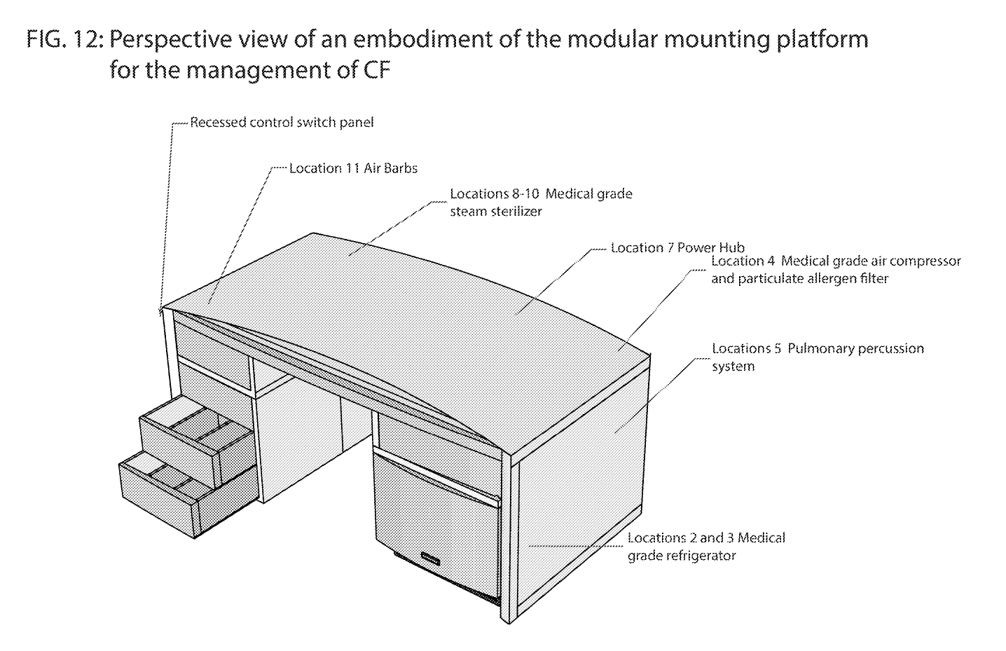

FIG. 12 shows a perspective view of an embodiment of the integrated modular health platform with multiple mounting locations filled with medical equipment for patients suffering from CF. A recessed control switch panel may be mounted to the top front left position (location 11) to access and operate the medical grade steam sterilizer (location 8-10), operate the medical grade air compressor (location 4), and operate the pulmonary compression system (location 5). In final form, the top, left side, back, and right side are covered with wood or plastic to match the user's aesthetic preference. For descriptive purposes, attachment and detachment of external coverings is assumed to take place before insertion, removal, and, or swapping of components.

Still referring to FIG. 12, a medical grade refrigerator is mounted in location 2 and 3. A medical grade steam sterilizer is mounted in location 8-10. A medical grade air compressor, and a medical grade particulate and allergen filter, is mounted in location 4. A pulmonary compression system is mounted in location 5. Finally, a power hub is mounted in location 7.

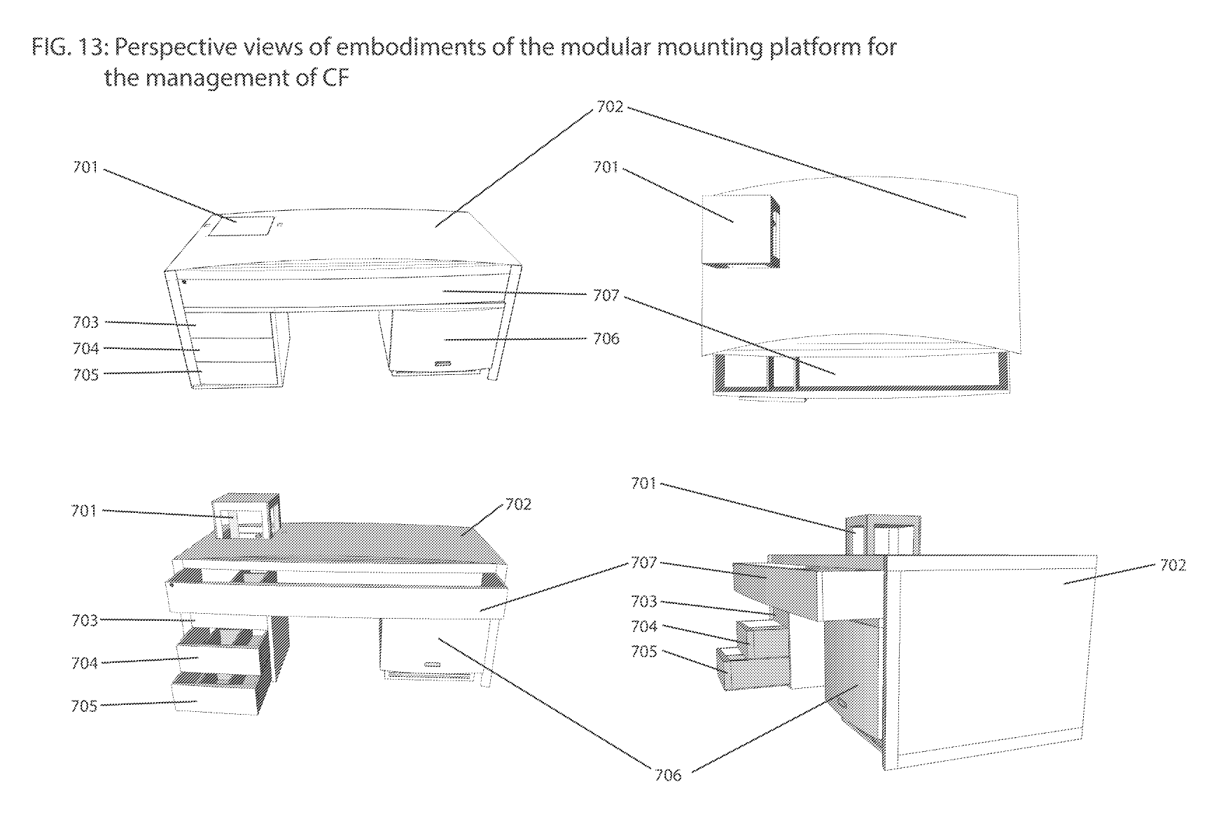

In some embodiments, as shown in FIG. 13, the integrated modular health platform for the management of CF may include a steam sterilizer in the back left position 701, with the ‘pop-up’ module partially lifted. A pill organization system is mounted onto the modular platform in a drawer system in the top front position 707. Medicine vials that must be refrigerated can be stored in the medical grade refrigerator mounted to the modular platform in the bottom front right position 706. A medical grade air compressor and filter system are strategically concealed by mounting in the back right position 702. Additional storage space is also provided for use 703, 704, and 705.

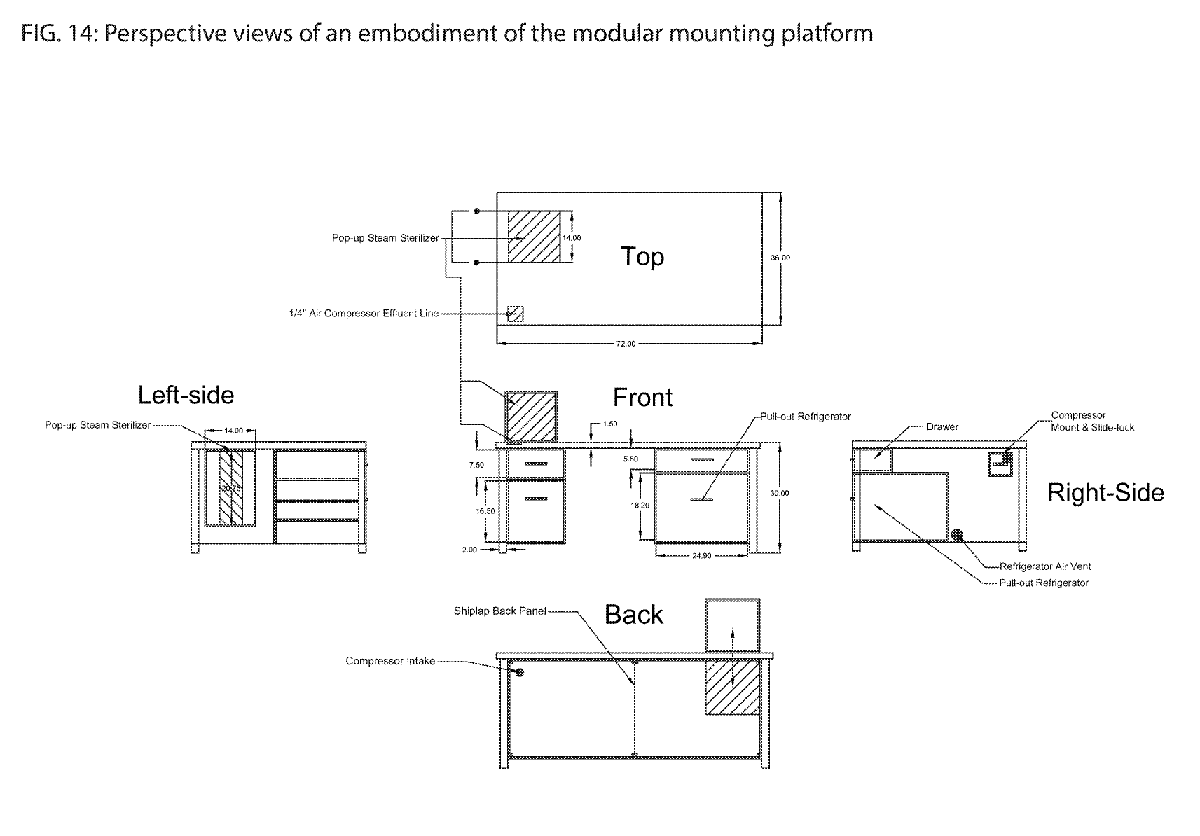

FIG. 14 shows the top, right side, left side, back and front perspective views of some embodiments of the modular platform. For the purposes of description, front and back refer to the front and back of the modular platform, respectively. Left and right refer to the left and right sides of the modular platform, as viewed from the users or front perspective. Top, middle, and bottom refer to the location of medical equipment above the ground, with top being the farthest from the ground and bottom being the closest. The top perspective view shows the location of the medical grade steam sterilizer, shown in the back left position, and the location of the air barb, located in the front left position. The front perspective view shows the location of the medical grade refrigerator, shown in the bottom front right position, and the outline of the medical grade steam sterilizer in operation in the back top left position. The back perspective view shows the location of the medical grade steam sterilizer in the back left position. The air filter intake, called out as the compressor intake, is shown in the back right position. The left side perspective view shows the position of the medial grade steam sterilizer recessed in the modular platform in the back left top, middle, and bottom position. The right side perspective view shows the location of the medical grade compressor in the top back right position. Refrigerator exhaust gasses are ducted through the right side of the modular platform in this configuration, through a refrigerator air vent located in the bottom right back position.

In addition, medical devices and components may be placed inside housings of any shape that may aid in the mounting of the medical device or component to the chassis. For example, FIG. 11A shows an example embodiment of a medical device mounted within a housing. Specifically, FIG. 11A shows a compressor housing configuration for incorporation into the modular mounting platform. Referring to FIG. 11A, the bounds of the compressor housing are shown in cross section 756. Influent air is drawn through a two-stage filter 751, into a tube that is threaded through a sound insulating rubber-bushing assembly 755, and into the influent air intake of a pump 753. Effluent air from the pump is delivered through a tube 758, and ducted to the air barb 763. Power wiring 757 is connected to the pump through a power cord threaded through the sound insulating rubber-bushing assembly 755 and to the pump 753. Sound insulating foam 754 is affixed to the inside of the compressor-housing 756 to reduce operational noise of the pump. Pumps 753 may need additional cooling in the form of a passive or fan exhausted vent 759 to prevent overheating during extended operation. In one embodiment, bolts 760 attach the compressor housing to the upper back right center mounting position corresponding to location 4, as, for example, described in reference to FIGS. 10A-10E. As shown in FIG. 11A, power is routed to two separate locations on the mounting platform 762 and 764, corresponding to medical equipment mounting in locations 1 and 8, as, for example, described in reference to FIGS. 10A-10E. In some embodiments, in reference to FIG. 11B, the compressor housing may be configured to be mounted to the housing by a sliding system that connects power, air influent, and air effluent lines in a male/female-docking configuration.

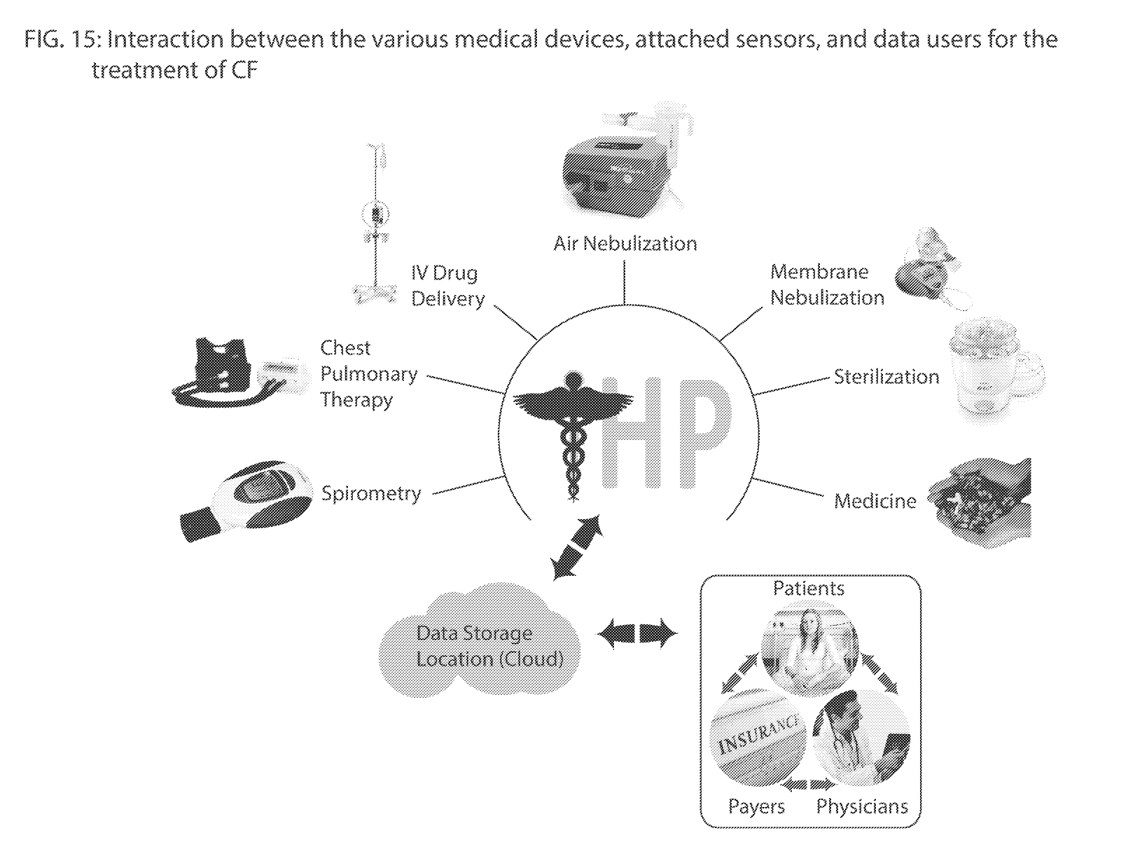

FIG. 15 displays an embodiment of the sensor array specific to Cystic Fibrosis treatment. A plurality of medical devices and sensors are shown which can exchange system and state data with the remote storage location via the local gateway communication device and, subsequently, allow data interaction on the part of stakeholders (i.e., patients, payers, and physicians). The sensor array includes at least seven sensors attached to at least seven medical devices. As depicted in FIG. 15, medical devices including a spirometer, a pulmonary percussion system, an intravenous (IV) drug delivery system, an air nebulization system, a membrane nebulization system, sterilization equipment, and prescribed medicine create data points that are monitored and logged by the integrated health platform. As described in the detailed description, the data from all of these systems is compared to a prescribed treatment regimen and manufacturer operational recommendations to ensure patient adherence and proper device functionality. The data that is monitored and logged by the IHP may be transmitted to a remote location, such as a cloud server. In some embodiments, a cloud server is a combination of software, hardware, and infrastructure that creates an accessible network server from a multitude of computers. Stakeholders including, but not limited to patient, physicians, and payers may access this data as part of a medical monitoring program. Stakeholders can interact with the data and the IHP to examine ongoing adherence or recommend treatment changes. The daily nature of the data accessible by the stakeholders is a paradigm shift compared to current treatment regimens that involve patient and physician interactions on a quarterly (i.e., four times per year) basis.

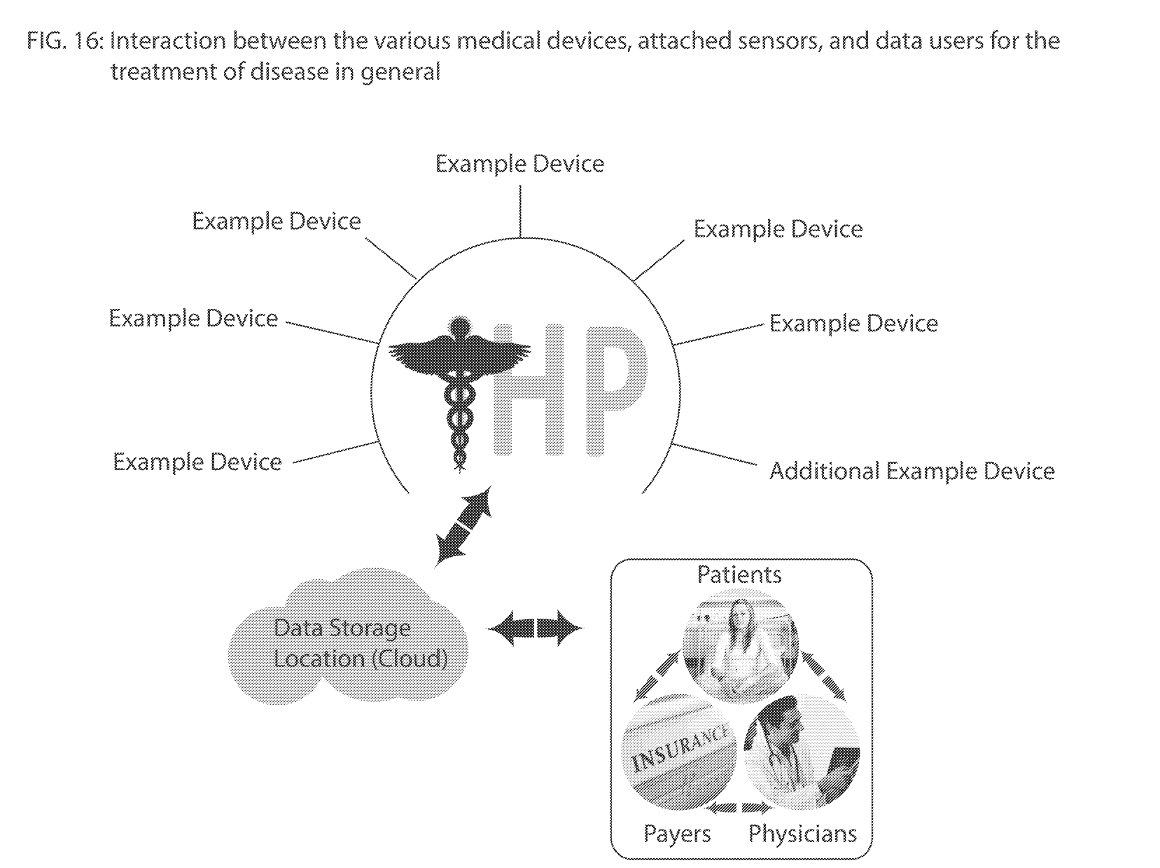

The IHPs of the present disclosure allows the user to easily select and exchange medical equipment so that the IHPs of the present disclosure may be used for by patient suffering from a variety of conditions. FIG. 16 shows a plurality of medical devices and sensors that can exchange system and state data with the remote storage location via the local gateway communication device and, subsequently, allow data interaction on the part of stakeholders (i.e., patients, payers, and physicians). The sensor array includes at least one sensor attached to at least one medical device. In some embodiments, as shown in FIG. 16, at least six sensors are involved in the array. Data from any prescribed medical device may be monitored and logged by the IHP. For example, patients suffering from diabetes may use the IHP to monitor and track their blood sugar levels. Physicians can then access this data as necessary to ensure patients are adhering to prescribed treatment methods and intervals. The embodiment of the IHP depicted in FIG. 16 is applicable to any disease being treated with prescribed medical devices outside of a hospital setting.

### Insertion, Removal, and Swapping of Components in the Modular Platform

The following refers to the layout shown in FIG. 8A, FIG. 8B, FIG. 8C, FIG. 8D, and FIG. 8E. In some embodiments, factory configuration of the modular platform reserves position 6 for the power hub and position 11 for the air barb.

By way of a non-limiting example, the air compressor can be mounted, for example, in location 7, according to the following mounting procedure. The compressor is mounted inside the compressor housing using a bolt and nut assembly. Bolts are threaded through the compressor footing; noise and vibration absorbent bushings are threaded on the bolts and locked tight using a nut and wrench. Depending on the compressor model, 3 to 6 bolts, bushings, and nuts are provided. The top of the compressor housing is mounted to the underneath surface of the top of the modular platform (location 7) using a bolt and nut assembly. Bolts are threaded through the mounting holes provided on the modular platform and into the mounting points on the compressor housing. Noise and vibration absorbent bushings are threaded on the bolts and locked tight using a nut and wrench. Power cables and air supply/delivery lines are threaded through a bushing in the side of the compressor housing. The compressor housing is then latched closed leaving only the cabling and air lines exposed. Power cables are attached to the power hub. Air supply or discharge lines are routed through the air pressure sensor described above.

The air filter can be mounted, for example, in location 4, according to the following mounting procedure. The air filter is attached to the modular platform using a bolt and nut assembly. Bolts are threaded through the mounting holes provided on the modular platform and into the mounting points on the power hub. Noise and vibration absorbent bushings are threaded on the bolts and locked tight using a nut and wrench. Air supply or discharge lines are routed through the air pressure sensor described above.

By way of a non-limiting example, the power hub can be mounted, for example in location 6, according to the following mounting procedure. The power hub and associated power consumption sensor array is attached to the modular platform using a bolt and nut assembly. Bolts are threaded through the mounting holes provided on the modular platform and into the mounting points on the power hub. Noise and vibration absorbent bushings are threaded on the bolts and locked tight using a nut and wrench. Internally, power cabling from each piece of equipment that requires power is routed through the modular platform and attached to the power hub. Externally, the power hub is connected to a standard 120 or 240V (US or EU standard) plug into a socket. As described above, power hub sensors are integrated directly into the hub.

By way of a non-limiting example, the air barb may be mounted, for example in location 11, according to the following mounting procedure. The air barb fittings, which include 1×⅛″ barbs for the medical grade air compressor, and 2×1″ fittings for the pulmonary compression system, are mounted to the modular platform using a bolt and nut assembly. Bolts are threaded through the mounting holes provided on the modular platform and into the mounting points on the air barb. Noise and vibration absorbent bushings are threaded on the bolts and locked tight using a nut and wrench. The interior air barb fittings are attached to the air compressor (location 7) via the internally routed air delivery lines and the pulmonary compression system (location 5) through internally routed air delivery lines.

By way of a non-limiting example, the pulmonary compression system may be mounted, for example, in location 5, according to the following mounting procedure. The pulmonary compression system is mounted to the modular platform using a bolt and nut assembly. Bolts are threaded through the pulmonary compression system housing and into the provided mounting locations near location 5. Noise and vibration absorbent bushings are threaded on the bolts and locked tight using a nut and wrench. Depending on the pulmonary compression system, 4 to 6 bolts, bushings, and nuts are provided. Internally, air delivery lines from the pulmonary compression system are routed through the modular platform and attached to the internal air barb fittings. Internally, power cabling is routed through the modular platform and attached to the power hub. The frequency sensor may be mounted directly to the pulmonary compression system as shown in FIG. 9A.

By way of a non-limiting example, the medical grade refrigerator may be mounted, for example, in location 2 and 3, according to the following mounting procedure. The medical grade refrigerator is attached to the modular platform using a bolt and nut assembly. Bolts are threaded through the mounting holes provided on the modular platform and into the mounting points on the medical grade refrigerator. Noise and vibration absorbent bushings are threaded on the bolts and locked tight using a nut and wrench. Internally, process air from the refrigerator is routed through the side of modular platform to prevent contamination of the compressor influent. Internally, power cabling is routed through the modular platform and attached to the power hub. The temperature sensor external communication module is mounted to the exterior of refrigerator and the sensor and attached transmission wire can be mounted to the interior of the refrigerator through the door seal. Electric power, if necessary, is supplied by the power cabling attached to the power hub.

By way of a non-limiting example, the medical steam sterilizer may be mounted, for example in location 8 and 10, according to the following mounting procedure. The medical steam sterilizer is attached to the modular platform using a bolt and nut assembly. Bolts are threaded through the mounting holes provided on the modular platform and into the mounting points on the medical grade steam sterilizer. Noise and vibration absorbent bushings are threaded on the bolts and locked tight using a nut and wrench. Internally, power cabling is routed through the modular platform and attached to the power hub. The temperature sensor external communication module is mounted to the exterior of steam sterilizer and the sensors and attached sensor wire are mounted through the steam vent to enable monitoring of the internal conditions (FIG. 9a). Electric power, if necessary, is supplied by the power cabling attached to the power hub.

The methodology for equipment removal and swapping follows the reverse and re-application of the steps described above. Removal of these components is possible in order to provide upgraded equipment or replacement parts according to changes in the user's medical regime. Upgraded or new components can be engineered to fit the same space requirements and attach to existing mounts in the modular platform.

### Attachment, Removal, and Swapping of Sensors in the Modular Platform

For descriptive purposes, the following refers to the layout shown in FIG. 8A, FIG. 8B, FIG. 8C, FIG. 8D, and FIG. 8E. Each sensor is designed to integrate with the modular platform, but can be operated in a discrete or ensemble manner, which would allow decentralized operation of the sensor array outside of integration with the IHP chassis.

By way of a non-limiting example, the following mounting procedure may be followed for attaching sensors to the air compressor. An air pressure sensor can be mounted on either the inlet or effluent side of the air compressor. Sensors are attached to the air lines within 5 inches of the air compressor. In some embodiments, a venturi air pressure sensor can be installed by cutting the air line at the aforementioned points and routing the cut ends of the air line through the actual pressure sensor device, or by installing a smaller bypass line onto the existing air line. The bypass line is then routed through the pressure sensing device. The venturi device is placed in the location where the air pressure reading (and, hence, ability to calculate air flow) is desired. In some embodiments, a LFS sensor may be installed by routing the air line through the sleeve of the LFS. The LFS sleeve is placed in the location where the air pressure reading (and, hence, ability to calculate air flow) is desired. In some embodiments, an oscillatory frequency sensor may be used. The operational frequency of the air compressor is monitored for comparison with manufacturer operational constraints. The mounting of the sensor can be accomplished by direct attachment to the air compressor or by attachment to the vibration dampening mounts which attach the air compressor to the modular platform (FIG. 9a).

The sensor is then mounted to the any of the following: the IHP chassis, the compressor housing, or the compressor itself. Mounting is accomplished through use of a bolt and nut assembly, adhesive or epoxy, a semi-permanent cabling system, a hook and ring system, or some combination of the described technologies. Bolts are installed with a nut and wrench system. Adhesive or epoxy is applied directly to both the sensor and mounting surface, compression is applied, and drying/hardening time is allowed. Semi-permanent cabling systems involve the threading of plastic ties through and around attachment points on the sensor device and through and around attachment points on the mounting surface. Hook and ring attachments can be applied with adhesive (by adhering the hook portion to either the sensor or the mount and the ring portion to the opposite) or used in a manner similar to the semi-permanent cabling with the hook and ring system used to maintain closure of a semi-permanent cable. Depending on the sensor type chosen, two to six bolts are used, less than an ounce of adhesive or epoxy is applied, one to six plastic ties are used, or approximately 1 square inch of both the hook and ring material is used.

The sensor may be directly connected to a communication module which has the ability to transmit the electronic output of the sensor to the local gateway communication device either through a wired or wireless connection. The connection is formed by an insulated wire capable of conducting electrical signals. The wire is attached at one end to the sensor and at the other end to the communication module. Insulation is removed from the wire at the attachment points. Attachments are made by soldering the connection points or by another means which ensures an electrical signal can be conducted through the wire (i.e., wire ties, conducting wire clamp system, etc.). The connecting wire is self-supported or bound with semi-permanent cabling systems to the modular platform, sensor, communication module, or air line.

If a wired connection between the communication module and local gateway communication device is desired, the connection can be formed by an insulated wire capable of conducting electrical signals. The wire is attached at one end to the communication module and at the other end to the local gateway communication device. Insulation is removed from the wire at the attachment points. Attachments are made by soldering the connection points or by another means which ensures an electrical signal can be conducted through the wire (i.e., wire ties, conducting wire clamp system, etc.). The connecting wire is self-supported or bound with semi-permanent cabling systems to the modular platform, sensor, communication module, or air line.

The communication module is mounted to the underneath surface of the top of the modular platform using a bolt and nut assembly. Bolts are threaded through the mounting holes provided on the modular platform and into the mounting points on the module and locked tight using a nut and wrench.

Power cables are threaded through a bushing in the side of both the sensor and module housing. The housings are then latched closed leaving only the insulated wire connections exposed. Power cables are attached to the power hub. It should be noted that this method is applicable to attaching air pressure sensors to other medical devices contained within the modular platform (i.e., air barb at location 11).

Referring to FIG. 4, specifically to the air compressor 420, an oscillatory frequency sensor 421 is attached to the body of the device. In one embodiment, generated signals indicate at what frequency the device is being operated. The oscillatory frequency sensor 421 is communicatively coupled to the communication module 422. The communication module 422 may be configured as a plug that can engage a standard outlet in order to provide power to the communication module 422, sensor 421, and medical device 420 via the device power plug 423. In an alternative embodiment, the communication module 422 and sensor 421 may be powered by a battery. The communication module 422 transmits the signals generated by the sensor 421 to the central hub and processing unit. In some embodiments, the signal is transmitted wirelessly.

By way of a non-limiting example, the air pressure sensor may be mounted, for example, in location 4, according to the following mounting procedure. An air pressure sensor can be mounted on either the inlet or effluent side of the air compressor. Sensors are attached to the air lines within 5 inches of the air compressor. In some embodiments, venturi air pressure sensor can be installed by cutting the air line at the aforementioned points and routing the cut ends of the air line through the actual pressure sensor device, or by installing a smaller bypass line onto the existing air line. The bypass line is then routed through the pressure sensing device. The venturi device is placed in the location where the air pressure reading (and, hence, ability to calculate air flow) is desired. In some embodiments, the LFS sensor may also be used. The airline is routed through the sleeve of the LFS. The LFS sleeve is placed in the location where the air pressure reading (and, hence, ability to calculate air flow) is desired. The sensor is then mounted to the any of the following: the IHP chassis, the filter housing, or the filter itself. Mounting is accomplished through use of a bolt and nut assembly, adhesive or epoxy, a semi-permanent cabling system, a hook and ring system, or some combination of the described technologies. Bolts are installed with a nut and wrench system. Adhesive or epoxy is applied directly to both the sensor and mounting surface, compression is applied, and drying/hardening time is allowed. Semi-permanent cabling systems involve the threading of plastic ties through and around attachment points on the sensor device and through and around attachment points on the mounting surface. Hook and ring attachments can be applied with adhesive (by adhering the hook portion to either the sensor or the mount and the ring portion to the opposite) or used in a manner similar to the semi-permanent cabling with the hook and ring system used to maintain closure of a semi-permanent cable. Depending on the sensor type chosen, two to six bolts are used, less than an ounce of adhesive or epoxy is applied, one to six plastic ties are used, or approximately 1 square inch of both the hook and ring material is used.

The sensor is directly connected to a communication module which has the ability to transmit the electronic output of the sensor to the local gateway communication device either through a wired or wireless connection. The connection is formed by an insulated wire capable of conducting electrical signals. The wire is attached at one end to the sensor and at the other end to the communication module. Insulation is removed from the wire at the attachment points. Attachments are made by soldering the connection points or by another means which ensures an electrical signal can be conducted through the wire (i.e., wire ties, conducting wire clamp system, etc.). The connecting wire is self-supported or bound with semi-permanent cabling systems to the modular platform, sensor, communication module, or air line.

If a wired connection between the communication module and local gateway communication device is desired, the connection is formed by an insulated wire capable of conducting electrical signals. The wire is attached at one end to the communication module and at the other end to the local gateway communication device. Insulation is removed from the wire at the attachment points. Attachments are made by soldering the connection points or by another means which ensures an electrical signal can be conducted through the wire (i.e., wire ties, conducting wire clamp system, etc.). The connecting wire is self-supported or bound with semi-permanent cabling systems to the modular platform, sensor, communication module, or air line.

The communication module is mounted to the underneath surface of the top of the modular platform using a bolt and nut assembly. Bolts are threaded through the mounting holes provided on the modular platform and into the mounting points on the module and locked tight using a nut and wrench. Power cables are threaded through a bushing in the side of both the sensor and module housing. The housings are then latched closed leaving only the insulated wire connections exposed. Power cables are attached to the power hub.

This method is applicable to attaching air flow sensors to other medical devices contained within the modular platform (i.e., air barb at location 11).

By way of a non-limiting example, for the power hub, the following procedure may be followed for attaching power sensors. Power consumption sensors are mounted internal to the power hub. Each power connection point for a medical device is connected to an internal power consumption sensor. The sensor is attached to the electrical circuit at each power attachment point through soldering or by another means which ensures an electrical signal can be monitored (i.e., wire ties, conducting wire clamp system, etc.). Each sensor is directly connected to a communication module which has the ability to transmit the electronic output of the sensor to the local gateway communication device either through a wired or wireless connection. The connection is formed by an insulated wire capable of conducting electrical signals. The wire is attached at one end to the sensor and at the other end to the communication module. Insulation is removed from the wire at the attachment points.

Attachments are made by soldering the connection points or by another means which ensures an electrical signal can be conducted through the wire (i.e., wire ties, conducting wire clamp system, etc.). The connecting wire is self-supported or bound with semi-permanent cabling systems to the power hub or wiring internal to the power hub. If a wired connection between the communication module and local gateway communication device is desired, the connection is formed by an insulated wire capable of conducting electrical signals. The wire is attached at one end to the communication module and at the other end to the local gateway communication device. Insulation is removed from the wire at the attachment points. Attachments are made by soldering the connection points or by another means which ensures an electrical signal can be conducted through the wire (i.e., wire ties, conducting wire clamp system, etc.). The connecting wire is self-supported or bound with semi-permanent cabling systems to the modular platform, sensor, communication module, or air line. The communication module is internal to the power hub and does not require a separate mounting system. Power is provided to the sensors and communication module, as necessary, via wiring internal to the power hub.

By way of a non-limiting example, for the pulmonary compression system, the following mounting procedure may be followed for attaching a frequency sensor. A frequency sensor can be mounted directly to the air compression system that forms part of the pulmonary compression system. Depending on the type of frequency sensor chosen, mounting of the sensor can be accomplished by direct attachment to the air compression module comprising an integral part of the pulmonary compression system or by attachment to the vibration dampening mounts, which attach the air compression system to the modular platform (FIG. 11A). Mounting is accomplished through use of a bolt and nut assembly, adhesive or epoxy, a semi-permanent cabling system, or some combination of the described technologies. Bolts are installed with a nut and wrench system. Adhesive or epoxy is applied directly to both the sensor and mounting surface, compression is applied, and drying/hardening time is allowed. Semi-permanent cabling systems involve the threading of plastic ties through and around attachment points on the sensor device and through and around attachment points on the mounting surface. Depending on the sensor type chosen, two to six bolts are used, less than an ounce of adhesive or epoxy is applied, or one to six plastic ties are used. Note that the bolt and nut assembly system would only be applicable for mounting the sensor to the modular platform and use of this system for mounting a sensor directly to the pulmonary compression system would entail modification of the medical device, an undesired effect.

The sensor is directly connected to a communication module that has the ability to transmit the electronic output of the sensor to the local gateway communication device either through a wired or wireless connection. The connection is formed by an insulated wire capable of conducting electrical signals. The wire is attached at one end to the sensor and at the other end to the communication module. Insulation is removed from the wire at the attachment points. Attachments are made by soldering the connection points or by another means which ensures an electrical signal can be conducted through the wire (i.e., wire ties, conducting wire clamp system, etc.).

The connecting wire is self-supported or bound with semi-permanent cabling systems to the modular platform, sensor, or communication module. If a wired connection between the communication module and local gateway communication device is desired, the connection is formed by an insulated wire capable of conducting electrical signals. The wire is attached at one end to the communication module and at the other end to the local gateway communication device. Insulation is removed from the wire at the attachment points. Attachments are made by soldering the connection points or by another means which ensures an electrical signal can be conducted through the wire (i.e., wire ties, conducting wire clamp system, etc.). The connecting wire is self-supported or bound with semi-permanent cabling systems to the modular platform, sensor, or communication module. The communication module is mounted to the modular platform using a bolt and nut assembly. Bolts are threaded through the mounting holes provided on the modular platform and into the mounting points on the module and locked tight using a nut and wrench. Power cables are threaded through a bushing in the side of both the sensor and module housing. The housings are then latched closed leaving only the insulated wire connections exposed. Power cables are attached to the power hub.

Referring specifically to pulmonary percussion system 400 shown in FIG. 4, an oscillatory frequency sensor 401 is attached to the body of the device. Examples of sensors that may be used include, but are not limited to: piezoelectric, capacitive, electromagnetic, optical, potentiometric, resonant, thermal, and acoustic. In one embodiment, generated signals indicate the frequency at which the device oscillates. The frequency sensor 401 is communicatively coupled to the communication module 402. The communication module 402 may be configured as a plug that can engage a standard outlet in order to provide power to the communication module 402, sensor 401, and medical device 400 via the device power plug 403. In an alternative embodiment, the communication module 402 and sensor 401 may be powered by a battery. The communication module 402 transmits the signals generated by the sensor 401 to the central hub and processing unit. In one embodiment, the signal is transmitted wirelessly.

By way of a non-limiting example, for the medical grade refrigerator the following mounting procedure may be followed for attaching temperature sensors. A temperature sensor is affixed to either: an interior surface of the refrigerated space, or the refrigeration lines external to the refrigeration space with the application of a correlation relating line temperature to internal temperature. Sensor mounting is accomplished through use of adhesive or epoxy, a semi-permanent cabling system, a hook and ring system, or some combination of the described technologies. Adhesive or epoxy is applied directly to both the sensor and mounting surface, compression is applied, and drying/hardening time is allowed. Semi-permanent cabling systems involve the threading of plastic ties through and around attachment points on the sensor device and through and around attachment points on the mounting surface. Hook and ring attachments can be applied with adhesive (by adhering the hook portion to either the sensor or the mount and the ring portion to the opposite) or used in a manner similar to the semi-permanent cabling with the hook and ring system used to maintain closure of a semi-permanent cable.

Depending on the sensor type chosen, less than an ounce of adhesive or epoxy is applied, one to six plastic ties are used, or approximately 1 square inch of both the hook and ring material is used. The sensor is directly connected to a communication module which has the ability to transmit the electronic output of the sensor to the local gateway communication device either through a wired or wireless connection. The connection is formed by an insulated wire capable of conducting electrical signals. The wire is attached at one end to the sensor and at the other end to the communication module. Insulation is removed from the wire at the attachment points. Attachments are made by soldering the connection points or by another means which ensures an electrical signal can be conducted through the wire (i.e., wire ties, conducting wire clamp system, etc.). The connecting wire is self-supported or bound with semi-permanent cabling systems to the modular platform, sensor, communication module, or refrigerator. Adhesive or epoxy may also be used to bind the insulated wire to any of these surfaces.

If the sensor is mounted to an internal surface of the refrigerated space, the connecting wire will exit through the existing door area. In order to avoid creating a gap in the door/body seal, small gage wire must be used for this application. If a wired connection between the communication module and local gateway communication device is desired, the connection is formed by an insulated wire capable of conducting electrical signals. The wire is attached at one end to the communication module and at the other end to the local gateway communication device. Insulation is removed from the wire at the attachment points. Attachments are made by soldering the connection points or by another means which ensures an electrical signal can be conducted through the wire (i.e., wire ties, conducting wire clamp system, etc.). The connecting wire is self-supported or bound with semi-permanent cabling systems to the modular platform, sensor, communication module, or refrigerator. Adhesive or epoxy may also be used to bind the insulated wire to any of these surfaces. The communication module is mounted to the modular platform using a bolt and nut assembly. Bolts are threaded through the mounting holes provided on the modular platform and into the mounting points on the module and locked tight using a nut and wrench. Power cables are threaded through a bushing in the side of both the sensor and module housing. The housings are then latched closed leaving only the insulated wire connections exposed. Power cables are attached to the power hub.

By way of a non-limiting example, for the medical grade steam sterilizer the following mounting procedure may be followed for attaching a temperature sensor. A temperature sensor is routed through the steam vent so the actual sensor resides inside the sterilizer. The sensor is connected to a module external to the sterilizer, as shown in FIG. 9B. The sensor module is mounted through use of adhesive or epoxy, a semi-permanent cabling system, a hook and ring system, or some combination of the described technologies, as shown FIG. 9C. Adhesive or epoxy is applied directly to both the sensor and mounting surface, compression is applied, and drying/hardening time is allowed. Semi-permanent cabling systems involve the threading of plastic ties through and around attachment points on the sensor device and through and around attachment points on the mounting surface. Hook and ring attachments can be applied with adhesive (by adhering the hook portion to either the sensor or the mount and the ring portion to the opposite) or used in a manner similar to the semi-permanent cabling with the hook and ring system used to maintain closure of a semi-permanent cable. Depending on the sensor module type chosen, less than an ounce of adhesive or epoxy is applied, one to six plastic ties are used, or approximately 1 square inch of both the hook and ring material is used

The sensor is directly connected to a communication module, which has the ability to transmit the electronic output of the sensor to the local gateway communication device either through a wired or wireless connection. The connection is formed by an insulated wire capable of conducting electrical signals. The wire is attached at one end to the sensor and at the other end to the communication module. Insulation is removed from the wire at the attachment points. Attachments are made by soldering the connection points or by another means which ensures an electrical signal can be conducted through the wire (i.e., wire ties, conducting wire clamp system, etc.). The connecting wire is self-supported or bound with semi-permanent cabling systems to the modular platform, sensor, communication module, or sterilizer. Adhesive or epoxy may also be used to bind the insulated wire to any of these surfaces.

If a wired connection between the communication module and local gateway communication device is desired, the connection is formed by an insulated wire capable of conducting electrical signals. The wire is attached at one end to the communication module and at the other end to the local gateway communication device. Insulation is removed from the wire at the attachment points. Attachments are made by soldering the connection points or by another means which ensures an electrical signal can be conducted through the wire (i.e., wire ties, conducting wire clamp system, etc.). The connecting wire is self-supported or bound with semi-permanent cabling systems to the modular platform, sensor, communication module, or sterilizer. Adhesive or epoxy may also be used to bind the insulated wire to any of these surfaces.

The communication module is mounted to the modular platform using a bolt and nut assembly. Bolts are threaded through the mounting holes provided on the modular platform and into the mounting points on the module and locked tight using a nut and wrench. Power cables are threaded through a bushing in the side of both the sensor and module housing. The housings are then latched closed leaving only the insulated wire connections exposed. Power cables are attached to the power hub.

FIG. 4 further displays the ability to obtain data from biometric data gathering devices, specifically to the spirometer 430, which itself acts as a sensor that generates signals indicative of the forced expiratory volume in one second (FEV1) of the patient operating the spirometer. The spirometer is communicatively coupled to the communication module 431. The communication module 431 may be configured as a plug that can engage a standard outlet in order to provide power to the communication module 431 and medical device 430 via the device power plug 432. In an alternative embodiment, the communication module 431 and device 430 may be powered by a battery. The communication module 431 transmits the signals generated by the device 430 to the central hub and processing unit. In one embodiment, the signal is transmitted wirelessly.

Those skilled in the art will recognize that various methods of attachment may be used to affix the sensor(s) to the devices. Attachment may be accomplished by use of a bolt and nut assembly, adhesive or epoxy, a semi-permanent cabling system, a hook and ring system, some combination of the described technologies, or other method. In addition, those skilled in the art will recognize that various methods of communicatively coupling the sensor to the communication module and the communication module to the central hub exist. This coupling may be done wirelessly using WiFi, Bluetooth, or other technologies. The coupling may also consist of a wired connection.

### Using the Integrated Modular Health Platform

FIG. 12 depicts the modular platform with desk paneling on the outside of the present disclosure, with drawers added in the available space, and configured with recessed switches to control the compressor, the sterilizer, and the pulmonary compression system. In operation, once the user is sitting at or standing near the health platform, access to the pulmonary percussion system location 5, steam sterilizer location 8-10, and air barbs location 11 are controlled through the recessed control switch panel. Operation of the sterilizer, air compressor, and pulmonary compression system are also controlled through the recessed control switch panel. The location of the recessed control switch panel is depicted in the front top-left corner of FIG. 12, although those skilled in the art will recognize that various locations of the switch panel exist. Medical equipment to be sterilized (i.e., nebulizer and associated tubing) is placed into the steam sterilizer location 8-10 and the device is operated in accordance with manufacturer directions. Sterilizer ‘on/off’ operation is controlled through the recessed control switch panel. The associated sterilizer sensor array, wherein one or more sensors are attached to the sterilizer, records operating pressures, temperatures, and tracks device operation to ensure equipment is being sterilized in accordance with the prescribed medical regimen and device manufacturer specifications. After the sterilization cycle is complete, the user removes the cleaned equipment from the sterilizer. The sterilized nebulizer is assembled and associated tubing is attached to the assembled nebulizer and associated air barb location 11. Medicine to be placed into the nebulizer is removed from the built-in-refrigerator locations 2-3 and placed into the assembled nebulizer. The user then dons a pulmonary percussion nylon vest system and attaches the associated tubing to the associated air barbs location 11. The air compressor and pulmonary percussion system are then ‘turned on’ using the recessed control switch panel. The associated pulmonary percussion system and air compressor sensor arrays, wherein one or more sensors are attached to the pulmonary percussion system location 5 and air compressor location 4, record the operational frequency of sound generated by the operation of the devices and the duration of device use and track device operation to ensure equipment is being operated in accordance with the prescribed medical regimen and device manufacturer specifications. During treatment, the user is able to work or study by employing the top surface of the integrated modular health platform as a desktop. After nebulized medicine and pulmonary percussion treatments are complete, the air compressor and pulmonary percussion system are ‘turned off’ using the recessed control switch panel. Tubing attached to the air barb, pulmonary percussion nylon vest system, and nebulizer are detached and discretely stored for later use. The user then rescinds access to the pulmonary percussion system location 5, the sterilizer location 8-10, and the air barbs location 11 using the recessed control switch panel. Note that the operation of the sensor array takes place without user input and, as such, is not depicted in FIG. 12. However, the user, if desired, can check health factors recorded through the use of built in sensor arrays (e.g., equipment performance, device adherence statistics, device use trends) using a web app, request a consult with physician and/or payer through the local gateway device or remote storage location to determine improvements to medical treatment regimen. While the operating procedure is described in reference to the embodiment of FIG. 12, it should be understood that the operation of the integrated health platform may vary depending on the set up of the platform as well as the needs and desires of the user.

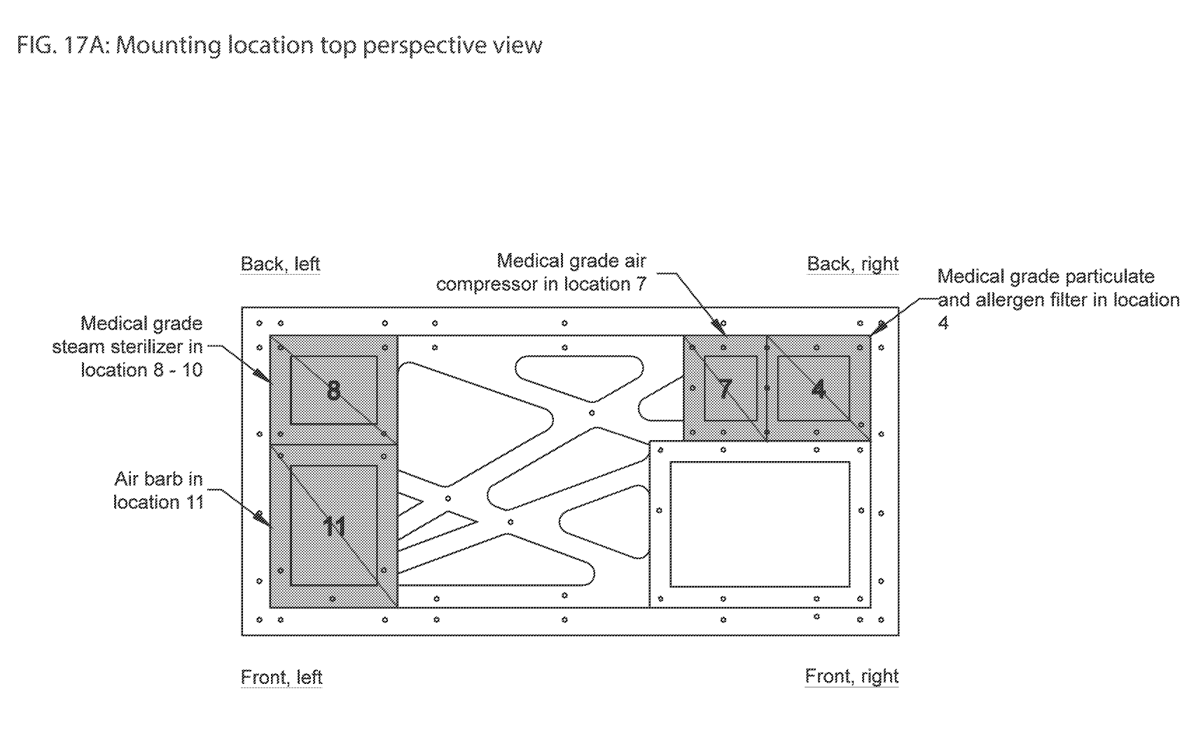

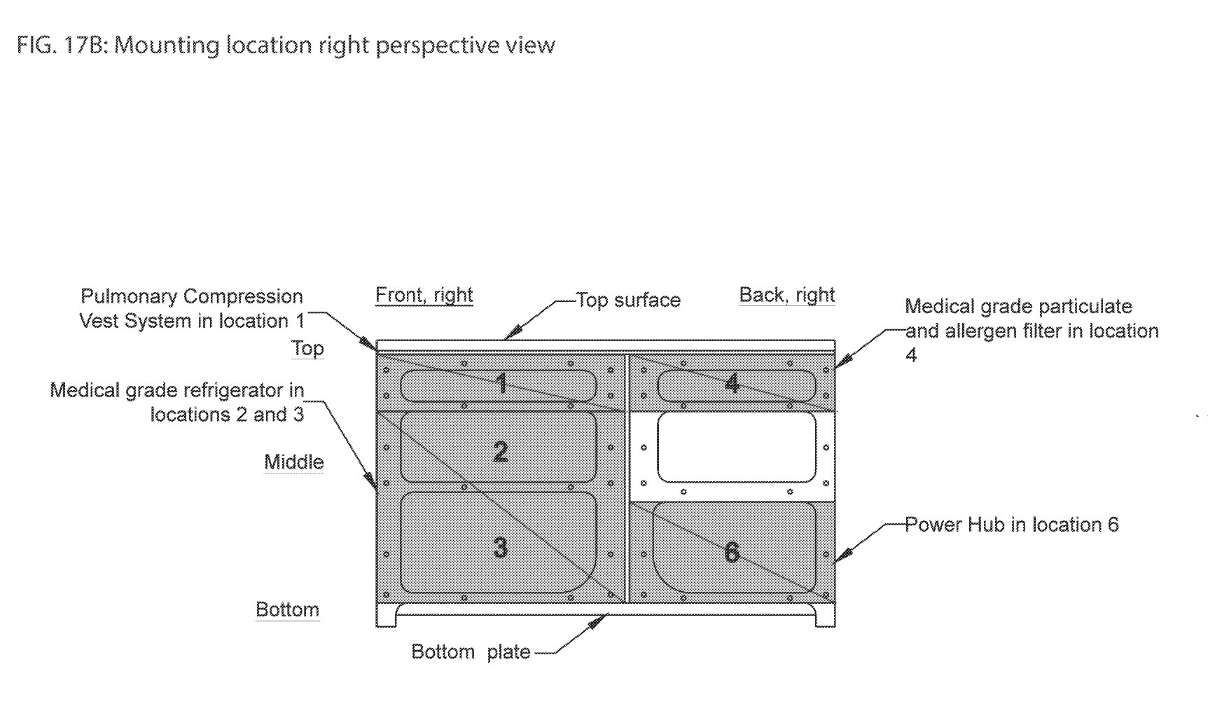

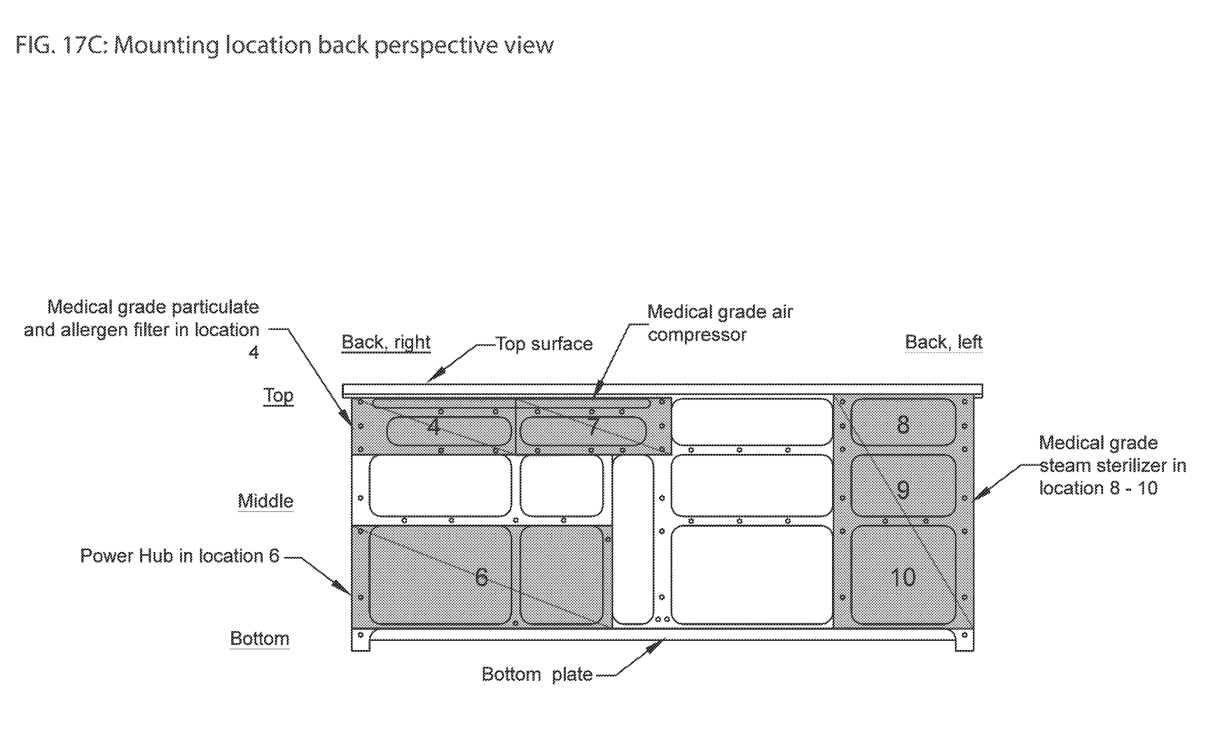

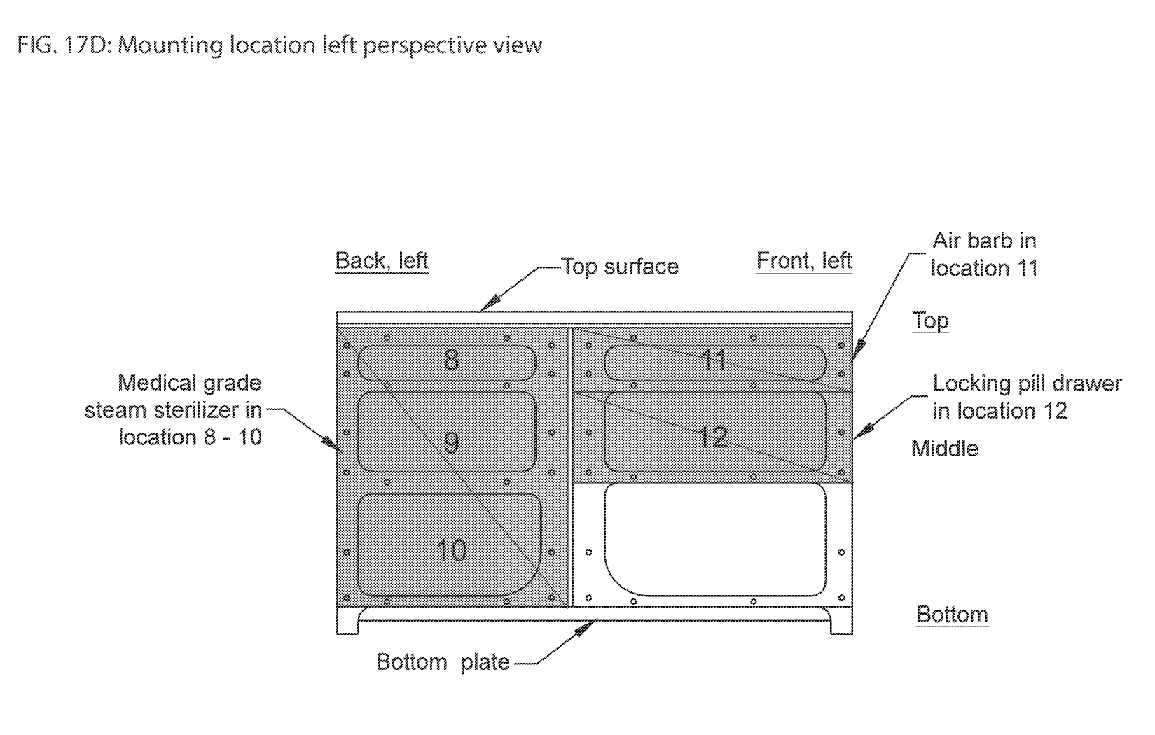

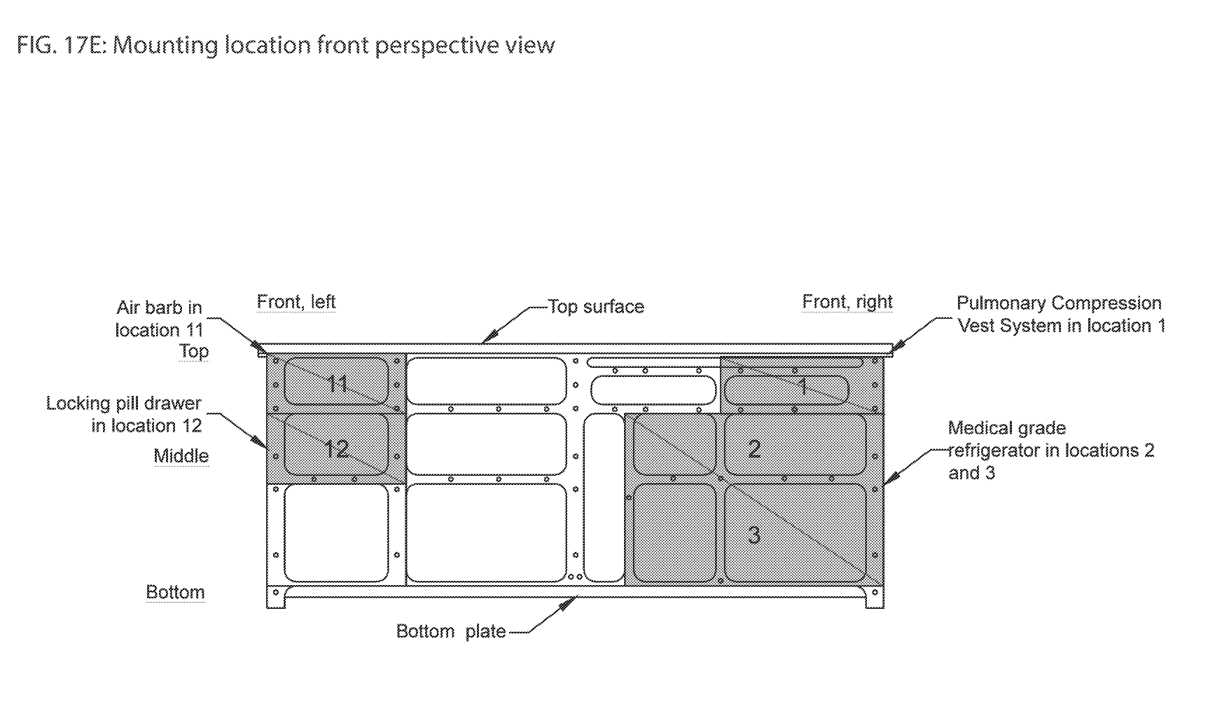

In reference to FIGS. 17A, 17B, 17C, 17D, and 17E, in some embodiments, the integrated health platform for the treatment of CF may include medical grade refrigerator, for example, in location 2 and 3, Medical grade air compressor, associated air-lines, and air barb, for example, in location 7 and 11, respectively, Medical grade particulate and allergen filter, for example in location 4, Medical grade steam sterilizer, for example, in location 8-10, pulmonary percussion system, in location 1, Locking pill drawer, for example, in location 12, and Power hub (location 6).

A medical grade refrigerator is mounted in location 2 and 3 in a fashion that reduces noise and vibration. This may be performed by mounting the device to the mounting points in location 2 and 3 using rubber or other sufficiently sound and vibration dampening material as bushings in a bolt and nut assembly. During operation, exhaust air is routed through the side of the modular platform in such fashion as to prevent processed air from entering the air filter in location 4. Power for the medical grade refrigerator will be delivered from the power hub mounted in location 6. Sensor array is connected as described in the original embodiment for CF.

A medical grade air compressor may be mounted in position 7 and the medical grade particulate and allergen filter in position 4. The location of the air compressor and filter allows for air to be drawn through the back of the desk, through the filter system, and into the compressor. The medical grade air compressor's sound and vibration will be dampened by mounting the equipment inside a compressor housing box. Within the compressor box, noise dampening of the compressor is achieved through the use of energy absorbent foam on the interior walls. The compressor is mounted using a bolt and nut assembly. Compressed air is routed from the compressor, position 7, to the air barb, position 11. Power is delivered to location 7 from a power hub mounted in location 6. Sensor array is connected as described in the original embodiment for CF.

A medical grade steam sterilizer may be mounted in location 8-10. The assembly is designed to be stored in location 8-10 while not in use, but will ‘pop-up’ through the top of the modular platform to rest above the level of the top when in operation. The details for this are not provided, however automation of the raising and lowering of the sterilizer could be performed using a linear actuator and 2-position control switch, or gas compressed cylinder and track system. As the method of raising and lowering the sterilizer is neither novel nor the focus of this application, details are not included. The medical grade steam sterilizer lift system is mounted to the modular platform using a bolt and nut assembly. Sensor array is connected as described in the original embodiment for CF.

A locking pill drawer may be mounted in location 12. In some embodiments, the modular platform resembles a desk, in which drawers with specific functions may be mounted to the modular platform. A drawer assembly is mounted to the modular platform in location 12. The drawer itself will lock to safely store pills and other valuables. The method of locking will be a lock and key or combination, depending on user preference. As the method drawer action or locking methods are neither novel nor the focus of this application, details are not included. However, the integration of a locking drawer on the medical equipment mounting platform present disclosure is novel. It should be noted that the locking pill drawer is mounted in similar fashion to other medical equipment, using a bolt and nut assembly.

To operate the percussive system, tubing from the pulmonary percussion system is connected to ports located on a nylon jacket, which is worn by the user. During operation, air is pumped in and out of the air chambers quickly, compressing the chest wall in and out and mechanically loosening mucus in the user's lungs. The pulmonary percussion system is mounted to the modular platform in a fashion that reduces noise and vibration. This is performed by mounting the device to the mounting points in location 1 using rubber, or other sufficiently sound and vibration dampening material as bushings in a bolt and nut assembly. The tubing from the pulmonary percussion system is internally routed from location 1 to the air barb in position 11. Power is delivered to location 11 from a power hub mounted in location 6. The sensor array is connected as described in the original embodiment for CF (See FIG. 15).

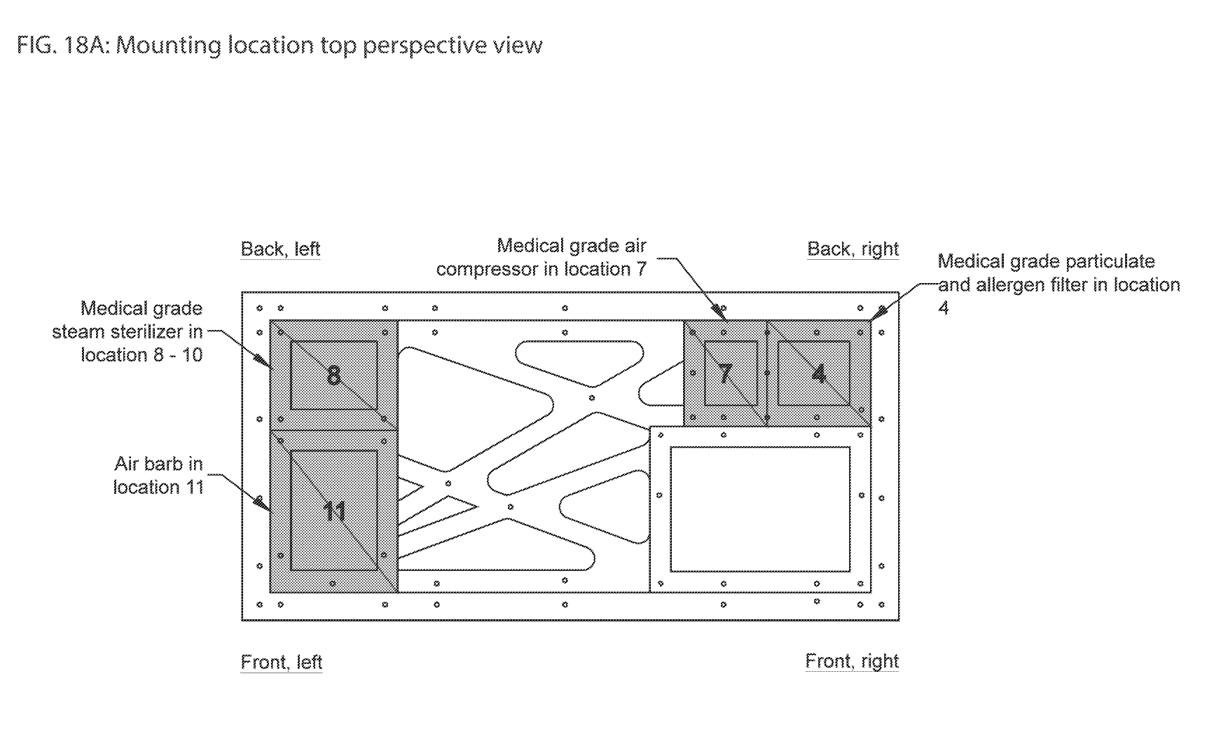

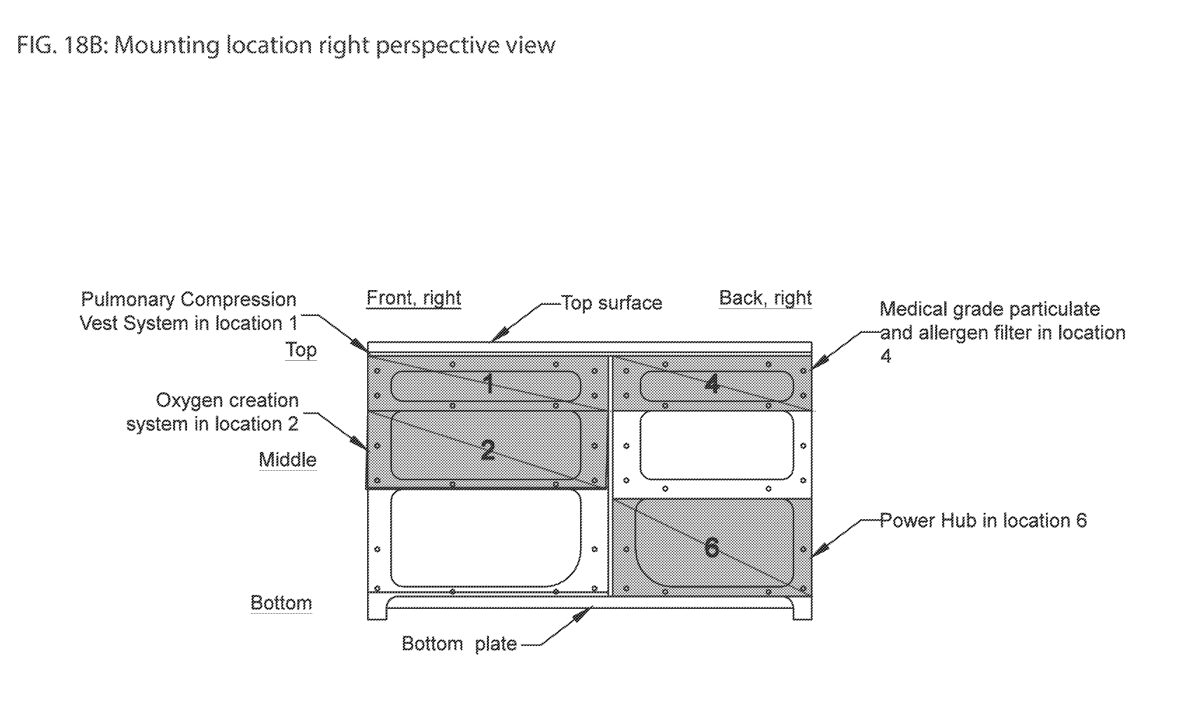

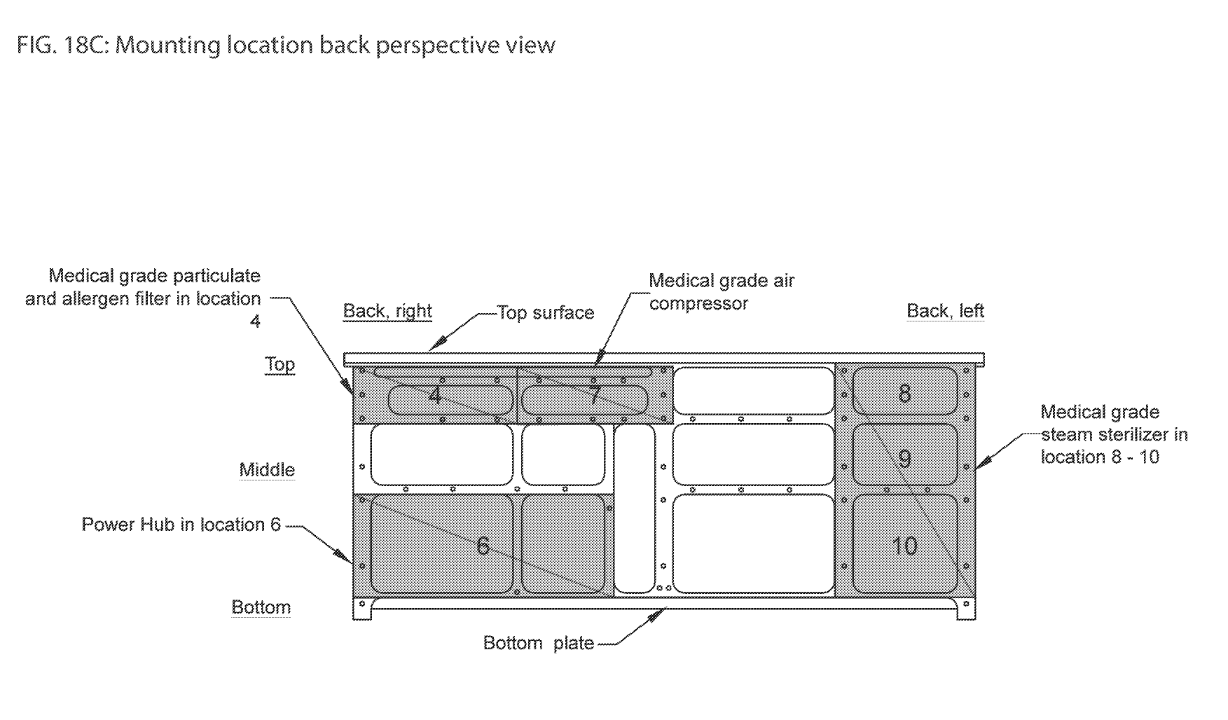

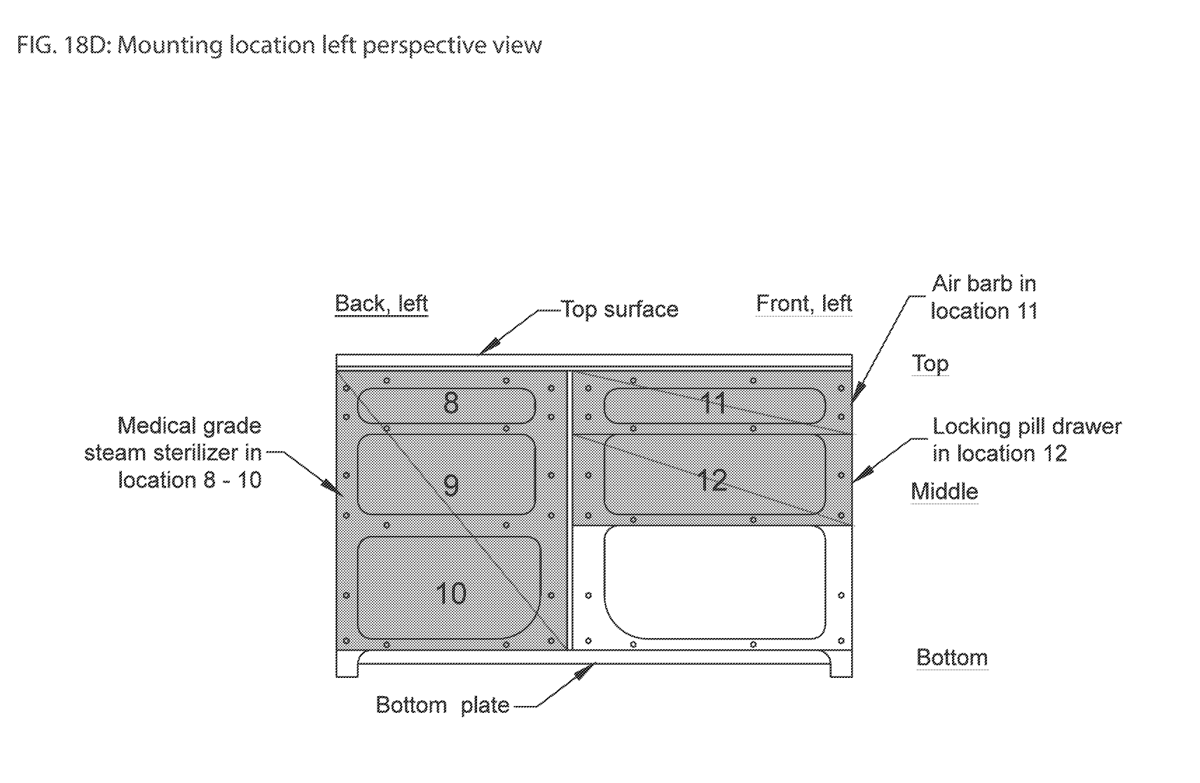

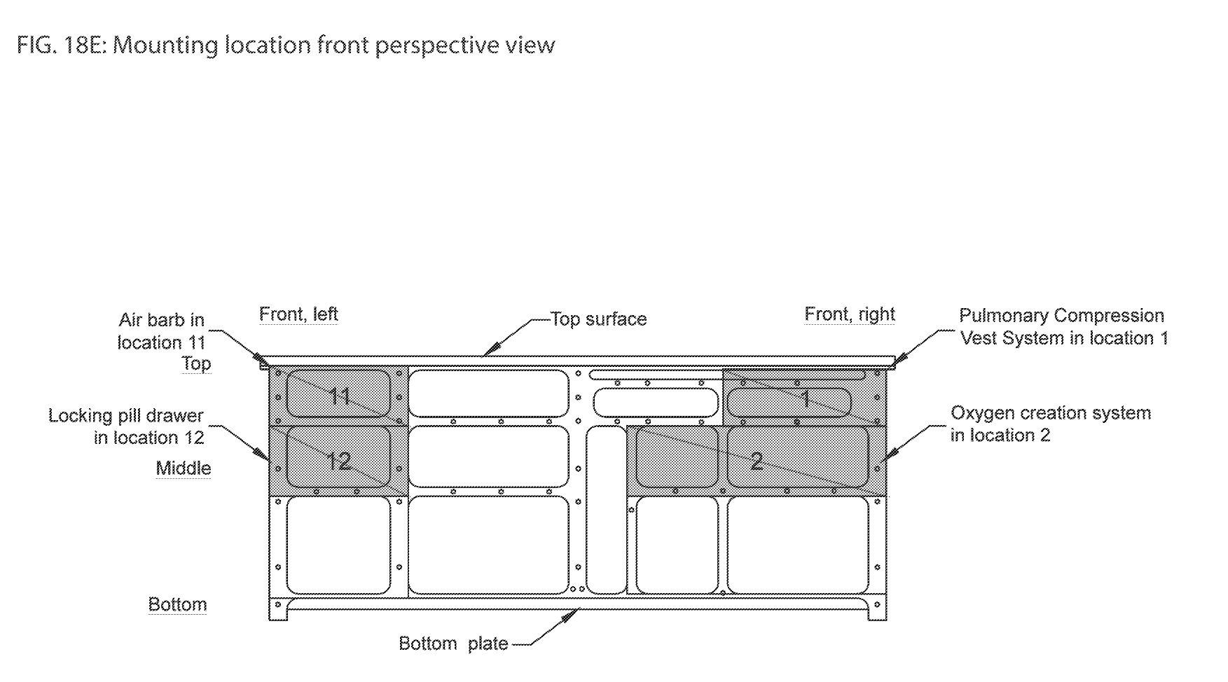

Referring to FIGS. 18A, 18B, 18C, 18D, and 18E, in some embodiments, the modular platform for the treatment of cf may include a medical grade air compressor, associated air-lines, and air barb, for example, in location 7 and 11, respectively; medical grade particulate and allergen filter, for example, in location 4; medical grade steam sterilizer, for example, in location 8-10, pulmonary percussion system, for example, in location 1, oxygen creation system, for example, in location 2, and power hub, for example, in location 6.

A medical grade air compressor may be mounted in position 7; a medical grade particulate and allergen filter may be mounted in position 4. The location of the air compressor and filter allows for air to be drawn through the back of the desk, through the filter system, and into the compressor. The medical grade air compressor's sound and vibration are dampened by mounting the equipment inside a compressor housing box. Within the compressor box, noise dampening of the compressor is achieved through the use of energy absorbent foam on the interior walls. The compressor is mounted using a bolt and nut assembly. Compressed air is routed from the compressor, position 7, to the air barb, position 11. Power is delivered to location 7 from a power hub mounted in location 6.

A medical grade steam sterilizer may be mounted in location 8-10. The assembly is designed to be stored in location 8-10 while not in use, but will ‘pop-up’ through the top of the modular platform to rest above the level of the top desk surface when in operation. The details for this are not provided, however automation of the raising and lowering of the sterilizer could be performed using a linear actuator and 2-position control switch, or gas compressed cylinder and track system. As the method of raising and lowering the sterilizer is neither novel nor the focus of this application, details are not included. The medical grade steam sterilizer lift system is mounted to the modular platform using a bolt and nut assembly.

An oxygen creation system may be mounted in location 2. Pure oxygen is routed from the oxygen creation system, position 2, to the air barb, position 11. It should be noted that oxygen creation system is mounted in similar fashion to other medical equipment, using a bolt and nut assembly. Power is delivered to location 7 from a power hub mounted in location 6. This embodiment of the present disclosure incorporates an oxygen monitor in the oxygen discharge of the oxygen creation system as well as an air flow sensor. Both devices are attached to a wire which transmits data readings from the sensors to a module on the exterior of the oxygen creation system and supplies power to the sensors as needed. The exterior module contains transmission equipment which communicates with the local gateway device. Signal filtering and processing, if necessary, can be performed within the module or via software in the local gateway device. To operate the percussive, tubing from the pulmonary percussion system is connected to ports located on a nylon jacket, which is worn by the user. During operation, air is pumped in and out of the air chambers quickly, compressing the chest wall in and out and mechanically loosening mucus in the user's lungs. The pulmonary percussion system will be mounted to the modular platform in a fashion that reduces noise and vibration. This is performed mounting the device to the mounting points in location 1 using rubber, or other sufficiently sound and vibration dampening material as bushings in a bolt and nut assembly. The tubing from the pulmonary percussion system is internally routed from location 1 to the air barb in position 11. Power is delivered to location 11 from a power hub mounted in location 6.

As noted above, the integrated modular health platforms of the present disclosure can be easily customized depending on the needs and desires of the patient. Accordingly, it should be understood other possibilities exist for the location and type of medical devices in the integrated modular health platforms of the present disclosure.

In some embodiments, a method for monitoring one or more medical devices to ensure patient adherence to a prescribed therapy comprises, monitoring of one or more parameters associated with the operation of the medical devices; generating signals that are indicative of how the medical devices are being used by the patient comprising: whether medical devices are being used by the patient; whether monitored parameters conform to manufacturer operational constraints; assessment of patient device usage against physician prescribed therapeutic regimens; and generating signals indicative of the assessment of medical device usage for stakeholder notifications comprised of: text messages; email; other common digital communication methods. In some embodiments, the monitored parameters include: amperage; device generated sound volume; device generated sound frequency; temperature; an on/off state; time in the device on state at each use and accumulated total time in the device on state; frequency of device use as measured by changes in the parameters defined above; and user defined inputs related to device usage or prescribed treatment. In some embodiments, manufacturer operational constraints include: a range of acceptable device amperage readings; a range of acceptable device generated sound volumes; a range of acceptable device generated sound frequency; and/or a range of acceptable device temperature readings. In some embodiments, physician prescribed therapy regimens include: device time in the on state for each use by the patient and accumulated total time in an on state; temperature of medication storage; temperature at which device sterilization is performed; duration of equipment sterilization; and/or frequency(ies) generated by device operation. In some embodiments, the monitored medical devices include, but are not limited to: air compressor; refrigeration unit; steam sterilizer; pulmonary percussion system; electrically powered blood glucose monitoring equipment; electrically powered blood pressure monitor; electrically powered blood oxygen concentration monitor; home oxygen generation equipment; IV fluid delivery; spirometers, flowmeters, and other pulmonary performance monitors; and/or 9owdered, compressed, sprayed, and/or nebulized medicine delivery systems. In some embodiments, the assessment of patient device usage against physician prescribed therapeutic regimens is comprised of: computer algorithms which compute a weighted moving average of daily adherence to a physician prescribed therapy regimen at weekly, monthly, quarterly, and annual time intervals; comparison of the computed moving weight average to a physician recommended adherence schedule; and use of a non-linear auto-regressive exogenous model to predict future values of patient adherence based on generated signals and physician recommended adherence schedule. In some embodiments, daily adherence is measured by: the ratio of the computed weighted moving average to the prescribed therapeutic regimen; or an adherence score calculated as the difference between perfect performance (i.e., 100% adherence to the prescribed therapeutic regimen) and actual performance. In some embodiments, stakeholders may be comprised of: patients; physicians; individuals granted access to medical records in accordance with HIPAA regulations; insurance companies; medical device manufacturers; research institutions; and/or other entities granted access to medical records in accordance with HIPAA regulations. In some embodiments, the signals generated by monitoring the state of the medical devices are further communicated to a remote location in a secure fashion compliant with HIPAA protocols. In some embodiments, monitoring the parameters and generating the signals is performed at a power device that provides power to the medical devices, device sensors, and signal communication equipment, or is performed at a battery powered device that provides power to only the device sensors and signal communication equipment and does not interfere with device operation. In some embodiments, the power device is separated from the medical devices.

In some embodiments, a medical device monitor comprises sensors gathering monitored parameter data; monitored parameters collected from each medical device by one or more sensors located in proximity to the medical device being sensed; a communication module that receives signals from one or more sensors and transmits the received signals to a central hub; a central hub, wherein collected data received from one or more sensors may be converted from a first format to a second format and aggregated into a single file for application of processing unit tasks; a digital file with data for each prescribed device containing medical device operational constraints from the manufacturer; a digital file with data for each prescribed device containing patient-specific, physician-prescribed medical device usage; and a processing unit, wherein the processing unit is coupled to all sensing devices by the associated communication modules and all digital files and is configured to: compare the monitored parameters with the manufacturer operational constraints stored in the digital file(s) for the monitored medical devices; generate a signal indicative of whether the medical device being used by a patient conforms to the manufacturer operational constraints; use computer algorithms to compute a weighted moving average of daily adherence to a physician prescribed therapy regimen at weekly, monthly, quarterly, and annual time intervals for each prescribed device; compare the computed moving averages with the physician prescribed therapy regimen stored in the digital files(s) for the monitored medical devices; use a non-linear auto-regressive exogenous model to predict future values of patient adherence based on generated signals and physician recommended adherence schedule; generate a signal indicative of the patient's assessed device usage against a physician prescribed therapy regimen; and generate a signal indicative of the patient's assessed future device usage against a physician prescribed therapy regimen in the future. In some embodiments, the medical device monitor may further comprise a communication module that is configured to communicate the signals indicative of device usage within manufacturer operational constraints, the patient's assessed device usage against a physician prescribed therapy regimen, and the patient's predicted future device adherence against a physician prescribed therapy regimen to a remote location and accept communications from a remote location for the purpose of updating the prescribed therapy regimen and/or manufacturer operational constraints. In some embodiments, the parameters that are monitored by the monitoring modules include: amperage; device generated sound volume; device generated sound frequency; temperature; an on/off state; time in the device on state at each use and accumulated total time in the device on state; and frequency of device use as measured by changes in the parameters defined above user defined inputs related to device usage or prescribed treatment.

In some embodiments, manufacturer operational constraints include: a range of acceptable device amperage readings; a range of acceptable device generated sound volumes; a range of acceptable device generated sound frequency; and/or a range of acceptable device temperature readings. In some embodiments, physician prescribed therapy regimens include: device time in the on state for each use by the patient and accumulated total time in an on state; temperature of medication storage; temperature at which device sterilization is performed; duration of equipment sterilization; and/or frequency(ies) generated by device operation. In some embodiments, the processing unit is further configured to maintain a log of information related to the monitoring of the parameters. In some embodiments, the medical devices are: air compressor, refrigeration unit; steam sterilizer; pulmonary percussion system; electrically powered blood glucose monitoring equipment; electrically powered blood pressure monitor; electrically powered blood oxygen concentration monitor; home oxygen generation equipment; IV fluid delivery; spirometers, flowmeters, and other pulmonary performance monitors; and powdered, compressed, sprayed, and/or nebulized medicine delivery systems. In some embodiments, a plug is provided that is configured to couple to a power outlet to permit the medical device monitor to provide power to the medical device, or is a battery powered device that provides power to only the device sensors and signal communication equipment and does not interfere with device operation.

In some embodiments, there is provided a medical device monitor to ensure adherence with a prescribed therapy assigned to the patient that comprises sensors configured to monitor one or more parameters associated with the operation of a medical device for each prescribed medical device, wherein the medical device forms part of a prescribed therapy, wherein the one or more parameters correspond to the prescribed therapy, manufacturer operational constraints, or user defined inputs; a processing unit that is communicatively coupled to all sensors, wherein the processing unit is configured to generate signals indicative of: whether the medical device(s) are operating within the medical device manufacturer operational constraints, the patient's assessed device usage against a prescribed therapy regimen, and the patient's estimated future device usage against a prescribed therapy regimen; and a power module that is configured to provide power to the medical devices, device sensors, and signal communication equipment, or is configured to provide battery power to only the device sensors and signal communication equipment and does not interfere with device operation. In some embodiments, the medical device monitor is a component that is separate from the medical device. In some embodiments, the medical device is a legacy device and the medical device monitor is a retrofitted component that increases the functionality of the legacy medical device.

In some embodiments, there is provided a medical device monitoring system for ensuring adherence with a prescribed therapy assigned to a patient and medical device operation within the operational constraints of the manufacturer, comprising: one or more medical devices that form part of the prescribed therapy; and a medical device monitor that provides power to the medical device(s) or includes battery powered sensing and communication devices that do not interfere with device operation, wherein the medical device monitor comprises: sensing devices configured to monitor one or more parameters associated with the operation of each medical device; monitored parameters collected from each medical device by one or more sensors located in proximity to the medical device being sensed; a communication module that receives signals from one or more sensors and transmits the received signals to a central hub; a central hub, wherein collected data received from one or more sensors may be converted from a first format to a second format and is aggregated into a single file for application of processing unit tasks; a digital file for each prescribed device containing medical device operational constraints from the manufacturer; a digital file for each device containing patient-specific, physician-prescribed medical device usage; and a processing unit, wherein the processing unit is communicatively coupled to all sensing devices and digital files and is configured to: compare the monitored parameters with the manufacturer operational constraints stored in the digital file(s) for the monitored medical devices; generate a signal indicative of whether the medical device conforms to the manufacturer operational constraints; use computer algorithms to compute a weighted moving average of daily adherence to a physician prescribed therapy regimen at weekly, monthly, quarterly, and annual time intervals for each prescribed device; compare the computed moving averages with the physician prescribed therapy regimen stored in the digital files(s) for the monitored medical devices; use a non-linear auto-regressive exogenous model to predict future values of patient adherence based on generated signals and physician recommended adherence schedule; generate a signal indicative of the patient's assessed medical device usage against a physician prescribed therapy regimen; and generate a signal indicative of the patient's assessed future device usage against a physician prescribed therapy regimen. In some embodiments, the medical devices are: air compressor; refrigeration unit; steam sterilizer; pulmonary percussion system; electrically powered blood glucose monitoring equipment; electrically powered blood pressure monitor; electrically powered blood oxygen concentration monitor; home oxygen generation equipment; IV fluid delivery; spirometers, flowmeters, and other pulmonary performance monitors; powdered, compressed, sprayed, and/or nebulized medicine delivery systems.

In some embodiments, there provided a medical device monitoring system that forms part of a prescribed therapy for a patient, comprising: prescribed medical equipment configured to treat a specific ailment; separate sensing devices for each medical device configured to monitor operating parameters associated with the specific device; and a processing unit that is configured to generate a signal that is indicative of whether the device conforms to the manufacturer operational constraints, generate a signal indicative of the assessment of a patient's device usage against a physician prescribed therapy regimen, and generate a signal indicative of the patient's assessed future device usages against a physician prescribed therapy regimen. In some embodiments, a communications module that is operable to transmit the generated signals to a remote location.

In some embodiments, the present disclosure provides a method for determining whether a prescribed medical device conforms to manufacturer operational constraints, comprising: measuring device amperages, generated sound volumes, generated sound frequencies, and/or temperatures; comparing the measured device amperages, generated sound volumes, generated sound frequencies, and/or temperatures to values set by the manufacturer; and generating a signal indicative of whether the device conforms to manufacturer operational constraints.

In some embodiments, there is provided a method for assessing a patient's device usage against a prescribed therapy assigned to that patient, comprising: measuring generated sound frequencies, temperatures, on/off states, usage time at each transition to an on state, total accumulated usage time, and/or user generated input; comparing the measured generated sound frequencies, temperatures, on/off states, usage time at each transition to an on state, total accumulated usage time, and/or user generated input to values set by the physician indicative of a prescribed therapy regimen; generating a signal indicative of the patient's assessed device usage against physician prescribed therapies; and generating a signal indicative of the patient's assessed future device usage against physician prescribed therapies. In some embodiments, the medical devices, sensors, power module, and communication equipment may be mounted into a single platform wherein the platform passively conceals the medical devices and medical device monitoring system and further passively reduces the operational noise and vibration associated with the mounted medical devices and components.

In some embodiments, a method for monitoring a medical device comprises receiving a first communication indicative of one or more parameters associated with a patient usage of a medical device; comparing the patient usage of the medical device with an expected usage of the medical device; and generating a second communication indicative of a difference between the patient usage and the expected usage.

In some embodiments, a system for monitoring a medical device comprises one or more sensors configured to monitor a patient usage of a medical device; a communication unit communicatively coupled to the one or more sensors; and a processing unit configured to receive a first communication from the communication unit, the communication being indicative of the patient usage of the medical device, to compare the patient usage of the medical device with an expected usage of the medical device; and to generate a second communication indicative of a difference between the patient usage and the prescribed usage.

In some embodiments, an integrated health platform comprises a chassis; one or more medical devices supported by the chassis; one or more sensors coupled to the one or more medical devices to monitor patient usage of the one or more medical devices; and a communication unit communicatively coupled to the one or more sensors to receive the patient usage information from the one sensors and to transmit the patient usage information to a processing unit

All patents, patent applications, and published references cited herein are hereby incorporated by reference in their entirety. While the devices and methods of the present disclosure have been described in connection with the specific embodiments thereof, it will be understood that they are capable of further modification. Furthermore, this application is intended to cover any variations, uses, or adaptations of the devices and methods of the present disclosure, including such departures from the present disclosure as come within known or customary practice in the art to which the devices and methods of the present disclosure pertain.

1. A method for monitoring a medical device comprising:
receiving a first communication indicative of one or more parameters associated with a patient usage of a medical device;
comparing the patient usage of the medical device with an expected usage of the medical device; and
generating a second communication indicative of a difference between the patient usage and the expected usage.

2. The method of claim 1 wherein the first communication is indicative of whether medical devices are being used by the patient; whether monitored parameters conform to manufacturer operational constraints; assessment of patient device usage against physician prescribed therapeutic regimens; or a combination thereof.

3. The method of claim 1 wherein the one or more parameters are selected from the group consisting of amperage; device generated sound volume; device generated sound frequency; temperature; an on/off state; time in the device on state at each use and accumulated total time in the device on state; frequency of device use; and combinations thereof.

4. The method of claim 1 wherein the expected usage comprises a range of acceptable device amperage readings; a range of acceptable device generated sound volumes; a range of acceptable device generated sound frequency; a range of acceptable device temperature readings or combinations thereof.

5. The method of claim 1 wherein the expected usage is a physician prescribed therapy regimen comprising a device time in the on state for each use by the patient and accumulated total time in an on state; temperature of medication storage; temperature at which device sterilization is performed; duration of equipment sterilization; one or more frequencies generated by device operation or combinations thereof.

6. The method of claim 1 wherein the medical device may be selected from the group consisting of an air compressor; a refrigeration unit; a steam sterilizer; a pulmonary percussion system; a blood glucose monitor; a blood pressure monitor; a blood oxygen concentration monitor; oxygen generation equipment; IV fluid delivery; spirometers, flowmeters, medicine delivery systems.

7. The method of claim 1 further comprising transmitting the first communication, the second communication, or both to a stakeholder for review.

8. The method of claim 1 further comprising monitoring with one or more sensors the one or more parameters associated with a patient usage of a medical device.

9. The method of claim 1 comprising reporting a patient adherence to the expected usage using a moving average of sensed device usage.

10. The method of claim 1 further comprising predicting future patient adherence to the expected usage using the moving average or a neural network NARX model.

11. A system for monitoring a medical device comprising:
one or more sensors configured to monitor a patient usage of a medical device;
a communication unit communicatively coupled to the one or more sensors; and
a processing unit configured to receive a first communication from the communication unit, the communication being indicative of the patient usage of the medical device, to compare the patient usage of the medical device with an expected usage of the medical device; and to generate a second communication indicative of a difference between the patient usage and the prescribed usage.

12. The system of claim 11 wherein the first communication is indicative of whether medical devices are being used by the patient; whether monitored parameters conform to manufacturer operational constraints; assessment of patient device usage against physician prescribed therapeutic regimens; or a combination thereof.

13. The system of claim 11 wherein the one or more sensors monitor amperage; device generated sound volume; device generated sound frequency; temperature; an on/off state; time in the device on state at each use and accumulated total time in the device on state; frequency of device use; or combinations thereof.

14. The system of claim 11 wherein the expected usage comprises a range of acceptable device amperage readings; a range of acceptable device generated sound volumes; a range of acceptable device generated sound frequency; a range of acceptable device temperature readings or combinations thereof.

15. The system of claim 11 wherein the expected usage is a physician prescribed therapy regimens comprising a device time in the on state for each use by the patient and accumulated total time in an on state; temperature of medication storage; temperature at which device sterilization is performed; duration of equipment sterilization; a frequency generated by device operation or combinations thereof.

16. The system of claim 11 wherein the medical device may be selected from the group consisting of an air compressor; a refrigeration unit; a steam sterilizer; a pulmonary percussion system; a blood glucose monitor; a blood pressure monitor; a blood oxygen concentration monitor; oxygen generation equipment; IV fluid delivery; spirometers, flowmeters, medicine delivery systems.

17. The system of claim 11 wherein the processing unit is further configured to report a patient adherence to the expected usage using a moving average of sensed device usage and to predict future patient adherence to the expected usage using the moving average or a neural network narx model.

18. An integrated health platform comprising:
a chassis;
one or more medical devices supported by the chassis;
one or more sensors coupled to the one or more medical devices to monitor patient usage of the one or more medical devices; and
a communication unit communicatively coupled to the one or more sensors to receive the patient usage information from the one sensors and to transmit the patient usage information to a processing unit.

19. The integrated health platform of claim 18 wherein the medical devices comprise a refrigerator; an air compressor, associated air-lines, and air barb; a particulate and allergen filter; a steam sterilizer; a pulmonary percussion system; a power hub; and a spirometer.

20. The integrated health platform of claim 18 wherein the one or more sensors are configured to measure device amperage, device generated sound volume, device generated sound frequency, device temperature or combinations thereof for the one or more medical devices.
